(19) United States
(12) Patent Application Publication
(10) Pub. No.: US 2015/0264404 A1
(43) Pub. Date: Sep. 17, 2015

(54) METHOD AND APPARATUS FOR VIDEO CODING AND DECODING

(71) Applicant: Nokia Technologies Oy, Espoo (FI)

(72) Inventor: Miska Matias Hannuksela, Tampere (FI)

(21) Appl. No.: 14/618,271

(22) Filed: Feb. 10, 2015

Related U.S. Application Data
(60) Provisional application No. 61/954,270, filed on Mar. 17, 2014.

(51) Int. Cl. H04N 19/70; H04N 19/463; H04N 19/52; H04N 19/513

(52) U.S. Cl. CPC H04N 19/70; H04N 19/513; H04N 19/463; H04N 19/52

(57) ABSTRACT

Various methods, apparatuses and computer program products for video encoding and decoding. In some embodiments a data structure is encoded that is associated with a base-layer picture and an enhancement-layer picture in a file or a stream comprising a base layer of a first video bitstream and/or an enhancement layer of a second video bitstream, wherein the enhancement layer may be predicted from the base layer; and into the data structure information that is indicative of whether the base-layer picture is regarded as an intra random access point picture for enhancement layer decoding is also encoded. If the base-layer picture is regarded as an intra random access point picture for enhancement layer decoding; the data structure information is further indicative of the type of the intra random access point IRAP picture for the decoded base-layer picture to be used in the enhancement layer decoding.

### TECHNICAL FIELD

The present application relates generally to an apparatus, a method and a computer program for video coding and decoding. More particularly, various embodiments relate to coding and decoding of interlaced source content.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A video coding system may comprise an encoder that transforms an input video into a compressed representation suited for storage/transmission and a decoder that can uncompress the compressed video representation back into a viewable form. The encoder may discard some information in the original video sequence in order to represent the video in a more compact form, for example, to enable the storage/transmission of the video information at a lower bitrate than otherwise might be needed.

Scalable video coding refers to a coding structure where one bitstream can contain multiple representations of the content at different bitrates, resolutions, frame rates and/or other types of scalability. A scalable bitstream may consist of a base layer providing the lowest quality video available and one or more enhancement layers that enhance the video quality when received and decoded together with the lower layers. In order to improve coding efficiency for the enhancement layers, the coded representation of that layer may depend on the lower layers. Each layer together with all its dependent layers is one representation of the video signal at a certain spatial resolution, temporal resolution, quality level, and/or operation point of other types of scalability.

Various technologies for providing three-dimensional (3D) video content are currently investigated and developed. Especially, intense studies have been focused on various multiview applications wherein a viewer is able to see only one pair of stereo video from a specific viewpoint and another pair of stereo video from a different viewpoint. One of the most feasible approaches for such multiview applications has turned out to be such wherein only a limited number of input views, e.g. a mono or a stereo video plus some supplementary data, is provided to a decoder side and all required views are then rendered (i.e. synthesized) locally by the decoder to be displayed on a display.

In the encoding of 3D video content, video compression systems, such as Advanced Video Coding standard (H.264/AVC), the Multiview Video Coding (MVC) extension of H.264/AVC or scalable extensions of HEVC can be used.

### SUMMARY

Some embodiments provide a method for encoding and decoding video information. In some embodiments an aim is to enable adaptive resolution change using a scalable video coding extension, such as SHVC. This may be done by indicating in the scalable video coding bitstream that only certain type of pictures (e.g. RAP pictures, or a different type of pictures indicated with a different NAL unit type) in the enhancement layer utilize inter-layer prediction. In addition, the adaptive resolution change operation may be indicated in the bitstream so that, except for switching pictures, each AU in the sequence contains a single picture from a single layer (which may or may not be a base-layer picture); and access units where switching happens include pictures from two layers and inter-layer scalability tools may be used.

The aforementioned coding configuration may provide some advances. For example, using this indication, adaptive resolution change may be used in a video-conferencing environment with the scalable extension framework; and a middle box may have more flexibility to trim the bitstream and adapt for end-points with different capabilities.

Various aspects of examples of the invention are provided in the detailed description.

According to a first aspect, there is provided a method comprising:

receiving one or more indications to determine if a switching point from decoding coded fields to decoding coded frames or from decoding coded frames to decoding coded fields exists in a bit stream, wherein if the switching point exists, the method further comprises:

as a response to determining a switching point from decoding coded fields to decoding coded frames, performing the following:

receiving a first coded frame of a first scalability layer and a second coded field of a second scalability layer;

reconstructing the first coded frame into a first reconstructed frame;

resampling the first reconstructed frame into a first reference picture; and

decoding the second coded field to a second reconstructed field, wherein the decoding comprises using the first reference picture as a reference for prediction of the second coded field;

as a response to determining a switching point from decoding coded frames to decoding coded fields, performing the following:

decoding a first pair of coded fields of a third scalability layer to a first reconstructed complementary field pair or decoding a first coded field of a third scalability layer to a first reconstructed field;

resampling one or both fields of the first reconstructed complementary field pair or the first reconstructed field into a second reference picture;

decoding a second coded frame of a fourth scalability layer to a second reconstructed frame, wherein the decoding comprises using the second reference picture as a reference for prediction of the second coded frame.

According to a second aspect of the present invention, there is provided an apparatus comprising at least one processor and at least one memory including computer program code, the at least one memory and the computer program code configured to, with the at least one processor, cause the apparatus to:

receive one or more indications to determine if a switching point from decoding coded fields to decoding coded frames or from decoding coded frames to decoding coded fields exists in a bit stream, wherein if the switching point exists, the method further comprises:

as a response to determining a switching point from decoding coded fields to decoding coded frames, to perform the following:

receive a first coded frame of a first scalability layer and a second coded field of a second scalability layer;

reconstruct the first coded frame into a first reconstructed frame;

resample the first reconstructed frame into a first reference picture; and

decode the second coded field to a second reconstructed field, wherein the decoding comprises using the first reference picture as a reference for prediction of the second coded field;

as a response to determining a switching point from decoding coded frames to decoding coded fields, to perform the following:

decode a first pair of coded fields of a third scalability layer to a first reconstructed complementary field pair or decoding a first coded field of a third scalability layer to a first reconstructed field;

resample one or both fields of the first reconstructed complementary field pair or the first reconstructed field into a second reference picture;

decode a second coded frame of a fourth scalability layer to a second reconstructed frame, wherein the decoding comprises using the second reference picture as a reference for prediction of the second coded frame.

According to a third aspect of the present invention, there is provided a computer program product embodied on a non-transitory computer readable medium, comprising computer program code configured to, when executed on at least one processor, cause an apparatus or a system to:

receive one or more indications to determine if a switching point from decoding coded fields to decoding coded frames or from decoding coded frames to decoding coded fields exists in a bit stream, wherein if the switching point exists, the method further comprises:

as a response to determining a switching point from decoding coded fields to decoding coded frames, to perform the following:

receive a first coded frame of a first scalability layer and a second pair of coded fields of a second scalability layer;

reconstruct the first coded frame into a first reconstructed frame;

resample the first reconstructed frame into a first reference picture; and

decode the second coded field to a second reconstructed field, wherein the decoding comprises using the first reference picture as a reference for prediction of the second coded field;

as a response to determining a switching point from decoding coded frames to decoding coded fields, to perform the following:

decode a first pair of coded fields of a third scalability layer to a first reconstructed complementary field pair or decoding a first coded field of a third scalability layer to a first reconstructed field;

resample one or both fields of the first reconstructed complementary field pair or the first reconstructed field into a second reference picture;

decode a second coded frame of a fourth scalability layer to a second reconstructed frame, wherein the decoding comprises using the second reference picture as a reference for prediction of the second coded frame.

According to a fourth aspect of the present invention, there is provided a method comprising:

receiving a first uncompressed complementary field pair and a second uncompressed complementary field pair;

determining whether to encode the first complementary field pair as a first coded frame or a first pair of coded fields and the second uncompressed complementary field pair as a second coded frame or a second pair of coded fields;

as a response to determining the first complementary field pair to be encoded as the first coded frame and the second uncompressed complementary field pair to be encoded as the second pair of coded fields, performing the following:

encoding the first complementary field pair as the first coded frame of a first scalability layer;

reconstructing the first coded frame into a first reconstructed frame;

resampling the first reconstructed frame into a first reference picture; and

encoding the second complementary field pair as the second pair of coded fields of a second scalability layer, wherein the encoding comprises using the first reference picture as a reference for prediction of at least one field of the second pair of coded fields;

as a response to determining the first complementary field pair to be encoded as the first pair of coded fields and the second uncompressed complementary field pair to be encoded as the second coded frame, performing the following:

encoding the first complementary field pair as the first pair of coded fields of a third scalability layer;

reconstructing at least one of the first pair of coded fields into at least one of a first reconstructed field and a second reconstructed field;

resampling one or both of the first reconstructed field and the second reconstructed field into a second reference picture; and

encoding the second complementary field pair as the second coded frame of a fourth scalability layer, wherein the encoding comprises using the second reference picture as a reference for prediction of the second coded frame.

According to a fifth aspect of the present invention, there is provided an apparatus comprising at least one processor and at least one memory including computer program code, the at least one memory and the computer program code configured to, with the at least one processor, cause the apparatus to:

receive a first uncompressed complementary field pair and a second uncompressed complementary field pair;

determine whether to encode the first complementary field pair as a first coded frame or a first pair of coded fields and the second uncompressed complementary field pair as a second coded frame or a second pair of coded fields;

as a response to determining the first complementary field pair to be encoded as the first coded frame and the second uncompressed complementary field pair to be encoded as the second pair of coded fields, to perform the following:

encode the first complementary field pair as the first coded frame of a first scalability layer; reconstruct the first coded frame into a first reconstructed frame;

resample the first reconstructed frame into a first reference picture; and

encode the second complementary field pair as the second pair of coded fields of a second scalability layer by using the first reference picture as a reference for prediction of at least one field of the second pair of coded fields;

as a response to determining the first complementary field pair to be encoded as the first pair of coded fields and the second uncompressed complementary field pair to be encoded as the second coded frame, to perform the following:

encode the first complementary field pair as the first pair of coded fields of a third scalability layer;

reconstruct at least one of the first pair of coded fields into at least one of a first reconstructed field and a second reconstructed field;

resample one or both of the first reconstructed field and the second reconstructed field into a second reference picture; and

encode the second complementary field pair as the second coded frame of a fourth scalability layer by using the second reference picture as a reference for prediction of the second coded frame.

According to a sixth aspect of the present invention, there is provided a computer program product embodied on a non-transitory computer readable medium, comprising computer program code configured to, when executed on at least one processor, cause an apparatus or a system to:

receive a first uncompressed complementary field pair and a second uncompressed complementary field pair;

determine whether to encode the first complementary field pair as a first coded frame or a first pair of coded fields and the second uncompressed complementary field pair as a second coded frame or a second pair of coded fields;

as a response to determining the first complementary field pair to be encoded as the first coded frame and the second uncompressed complementary field pair to be encoded as the second pair of coded fields, to perform the following:

encode the first complementary field pair as the first coded frame of a first scalability layer;

reconstruct the first coded frame into a first reconstructed frame;

resample the first reconstructed frame into a first reference picture; and

encode the second complementary field pair as the second pair of coded fields of a second scalability layer by using the first reference picture as a reference for prediction of at least one field of the second pair of coded fields;

as a response to determining the first complementary field pair to be encoded as the first pair of coded fields and the second uncompressed complementary field pair to be encoded as the second coded frame, to perform the following:

encode the first complementary field pair as the first pair of coded fields of a third scalability layer;

reconstruct at least one of the first pair of coded fields into at least one of a first reconstructed field and a second reconstructed field;

resample one or both of the first reconstructed field and the second reconstructed field into a second reference picture;

encode the second complementary field pair as the second coded frame of a fourth scalability layer by using the second reference picture as a reference for prediction of the second coded frame.

According to a seventh aspect of the present invention, there is provided a video decoder configured for decoding a bitstream of picture data units, wherein said video decoder is further configured for:

receiving one or more indications to determine if a switching point from decoding coded fields to decoding coded frames or from decoding coded frames to decoding coded fields exists in a bit stream, wherein if the switching point exists, the method further comprises:

as a response to determining a switching point from decoding coded fields to decoding coded frames, performing the following:

receiving a first coded frame of a first scalability layer and a second coded field of a second scalability layer;

reconstructing the first coded frame into a first reconstructed frame;

resampling the first reconstructed frame into a first reference picture; and

decoding the second coded field to a second reconstructed field, wherein the decoding comprises using the first reference picture as a reference for prediction of the second coded field;

as a response to determining a switching point from decoding coded frames to decoding coded fields, performing the following:

decoding a first pair of coded fields of a third scalability layer to a first reconstructed complementary field pair or decoding a first coded field of a third scalability layer to a first reconstructed field;

resampling one or both fields of the first reconstructed complementary field pair or the first reconstructed field into a second reference picture;

decoding a second coded frame of a fourth scalability layer to a second reconstructed frame, wherein the decoding comprises using the second reference picture as a reference for prediction of the second coded frame.

According to an eighth aspect of the present invention, there is provided a video encoder configured for encoding a bitstream of picture data units, wherein said video encoder is further configured for:

receiving a first uncompressed complementary field pair and a second uncompressed complementary field pair;

determining whether to encode the first complementary field pair as a first coded frame or a first pair of coded fields and the second uncompressed complementary field pair as a second coded frame or a second pair of coded fields;

as a response to determining the first complementary field pair to be encoded as the first coded frame and the second uncompressed complementary field pair to be encoded as the second pair of coded fields, performing the following:

encoding the first complementary field pair as the first coded frame of a first scalability layer;

reconstructing the first coded frame into a first reconstructed frame;

resampling the first reconstructed frame into a first reference picture; and

encoding the second complementary field pair as the second pair of coded fields of a second scalability layer, wherein the encoding comprises using the first reference picture as a reference for prediction of at least one field of the second pair of coded fields;

as a response to determining the first complementary field pair to be encoded as the first pair of coded fields and the second uncompressed complementary field pair to be encoded as the second coded frame, performing the following:

encoding the first complementary field pair as the first pair of coded fields of a third scalability layer;

reconstructing at least one of the first pair of coded fields into at least one of a first reconstructed field and a second reconstructed field;

resampling one or both of the first reconstructed field and the second reconstructed field into a second reference picture; and

encoding the second complementary field pair as the second coded frame of a fourth scalability layer, wherein the encoding comprises using the second reference picture as a reference for prediction of the second coded frame.

### BRIEF DESCRIPTION OF THE DRAWINGS

For a more complete understanding of example embodiments of the present invention, reference is now made to the following descriptions taken in connection with the accompanying drawings in which:

FIG. 1 shows schematically an electronic device employing some embodiments of the invention;

FIG. 2 shows schematically a user equipment suitable for employing some embodiments of the invention;

FIG. 3 further shows schematically electronic devices employing embodiments of the invention connected using wireless and/or wired network connections;

FIG. 4a shows schematically an embodiment of an encoder;

FIG. 4b shows schematically an embodiment of a spatial scalability encoding apparatus according to some embodiments;

FIG. 5a shows schematically an embodiment of a decoder;

FIG. 5b shows schematically an embodiment of a spatial scalability decoding apparatus according to some embodiments of the invention;

FIGS. 6a and 6b show an example of usage of the offset values in extended spatial scalability;

FIG. 7 shows an example of a picture consisting of two tiles;

FIG. 8 is a graphical representation of a generic multimedia communication system;

FIG. 9 illustrates an example where coded fields reside in a base layer and coded frames containing complementary field pairs of interlaced source content reside in an enhancement layer;

FIG. 10 illustrates an example where coded frames containing complementary field pairs of interlaced source content reside in the base layer BL and coded fields reside in the enhancement layer;

FIG. 11 illustrates an example where coded fields reside in a base layer and coded frames containing complementary field pairs of interlaced source content reside in an enhancement layer and diagonal prediction is used;

FIG. 12 illustrates an example where coded frames containing complementary field pairs of interlaced source content reside in the base layer and coded fields reside in the enhancement layer and diagonal prediction is used;

FIG. 13 depicts an example of a staircase of frame- and field-coded layers;

FIG. 14 depicts an example embodiment of locating coded fields and coded frames into layers as a coupled pair of layers with two-way diagonal inter-layer prediction;

FIG. 15 depicts an example where diagonal inter-layer prediction is used with external base layer pictures;

FIG. 16 depicts an example where skip pictures are used with external base layer pictures;

FIG. 17 illustrates an example where coded fields reside in a base layer and coded frames containing complementary field pairs of interlaced source content reside in an enhancement layer and using an enhancement layer picture coinciding with a base layer frame or field pair to enhance the quality of one or both fields of the base layer frame or field pair;

FIG. 18 illustrates an example where coded frames containing complementary field pairs of interlaced source content reside in the base layer BL and coded fields reside in the enhancement layer and using an enhancement layer picture coinciding with a base layer frame or field pair to enhance the quality of one or both fields of the base layer frame or field pair;

FIG. 19 depicts an example of top and bottom fields in different layers;

FIG. 20a depicts an example of definitions of layer trees; and

FIG. 20b depicts an example of a layer tree with two independent layers.

### DETAILED DESCRIPTION OF SOME EXAMPLE EMBODIMENTS

In the following, several embodiments of the invention will be described in the context of one video coding arrangement. It is to be noted, however, that the invention is not limited to this particular arrangement. In fact, the different embodiments have applications widely in any environment where improvement of coding when switching between coded fields and frames is desired. For example, the invention may be applicable to video coding systems like streaming systems, DVD players, digital television receivers, personal video recorders, systems and computer programs on personal computers, handheld computers and communication devices, as well as network elements such as transcoders and cloud computing arrangements where video data is handled.

In the following, several embodiments are described using the convention of referring to (de)coding, which indicates that the embodiments may apply to decoding and/or encoding.

The Advanced Video Coding standard (which may be abbreviated AVC or H.264/AVC) was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

The High Efficiency Video Coding standard (which may be abbreviated HEVC or H.265/HEVC) was developed by the Joint Collaborative Team-Video Coding (JCT-VC) of VCEG and MPEG. The standard is published by both parent standardization organizations, and it is referred to as ITU-T Recommendation H.265 and ISO/IEC International Standard 23008-2, also known as MPEG-H Part 2 High Efficiency Video Coding (HEVC). There are currently ongoing standardization projects to develop extensions to H.265/HEVC, including scalable, multiview, three-dimensional, and fidelity range extensions, which may be referred to as SHVC, MV-HEVC, 3D-HEVC, and REXT, respectively. The references in this description to H.265/HEVC, SHVC, MV-HEVC, 3D-HEVC and REXT that have been made for the purpose of understanding definitions, structures or concepts of these standard specifications are to be understood to be references to the latest versions of these standards that were available before the date of this application, unless otherwise indicated.

When describing H.264/AVC and HEVC as well as in example embodiments, common notation for arithmetic operators, logical operators, relational operators, bit-wise operators, assignment operators, and range notation e.g. as specified in H.264/AVC or HEVC may be used. Furthermore, common mathematical functions e.g. as specified in H.264/AVC or HEVC may be used and a common order of precedence and execution order (from left to right or from right to left) of operators e.g. as specified in H.264/AVC or HEVC may be used.

When describing H.264/AVC and HEVC as well as in example embodiments, the following descriptors may be used to specify the parsing process of each syntax element.
b(8): byte having any pattern of bit string (8 bits).
se(v): signed integer Exp-Golomb-coded syntax element with the left bit first.
u(n): unsigned integer using n bits. When n is “v” in the syntax table, the number of bits varies in a manner dependent on the value of other syntax elements. The parsing process for this descriptor is specified by n next bits from the bitstream interpreted as a binary representation of an unsigned integer with the most significant bit written first.
ue(v): unsigned integer Exp-Golomb-coded syntax element with the left bit first.

An Exp-Golomb bit string may be converted to a code number (codeNum) for example using the following table:

| Bit string | codeNum |
|---|---|
| 1 | 0 |
| 0 1 0 | 1 |
| 0 1 1 | 2 |
| 0 0 1 0 0 | 3 |
| 0 0 1 0 1 | 4 |
| 0 0 1 1 0 | 5 |
| 0 0 1 1 1 | 6 |
| 0 0 0 1 0 0 0 | 7 |
| 0 0 0 1 0 0 1 | 8 |
| 0 0 0 1 0 1 0 | 9 |
| . . . | . . . |

A code number corresponding to an Exp-Golomb bit string may be converted to se(v) for example using the following table:

| codeNum | syntax element value |
|---|---|
| 0 | 0 |
| 1 | 1 |
| 2 | −1 |
| 3 | 2 |
| 4 | −2 |
| 5 | 3 |
| 6 | −3 |
| . . . | . . . |

When describing H.264/AVC and HEVC as well as in example embodiments, syntax structures, semantics of syntax elements, and decoding process may be specified as follows. Syntax elements in the bitstream are represented in bold type. Each syntax element is described by its name (all lower case letters with underscore characters), optionally its one or two syntax categories, and one or two descriptors for its method of coded representation. The decoding process behaves according to the value of the syntax element and to the values of previously decoded syntax elements. When a value of a syntax element is used in the syntax tables or the text, it appears in regular (i.e., not bold) type. In some cases the syntax tables may use the values of other variables derived from syntax elements values. Such variables appear in the syntax tables, or text, named by a mixture of lower case and upper case letter and without any underscore characters. Variables starting with an upper case letter are derived for the decoding of the current syntax structure and all depending syntax structures. Variables starting with an upper case letter may be used in the decoding process for later syntax structures without mentioning the originating syntax structure of the variable. Variables starting with a lower case letter are only used within the context in which they are derived. In some cases, “mnemonic” names for syntax element values or variable values are used interchangeably with their numerical values. Sometimes “mnemonic” names are used without any associated numerical values. The association of values and names is specified in the text. The names are constructed from one or more groups of letters separated by an underscore character. Each group starts with an upper case letter and may contain more upper case letters.

When describing H.264/AVC and HEVC as well as in example embodiments, a syntax structure may be specified using the following. A group of statements enclosed in curly brackets is a compound statement and is treated functionally as a single statement. A “while” structure specifies a test of whether a condition is true, and if true, specifies evaluation of a statement (or compound statement) repeatedly until the condition is no longer true. A “do . . . while” structure specifies evaluation of a statement once, followed by a test of whether a condition is true, and if true, specifies repeated evaluation of the statement until the condition is no longer true. An “if . . . else” structure specifies a test of whether a condition is true, and if the condition is true, specifies evaluation of a primary statement, otherwise, specifies evaluation of an alternative statement. The “else” part of the structure and the associated alternative statement is omitted if no alternative statement evaluation is needed. A “for” structure specifies evaluation of an initial statement, followed by a test of a condition, and if the condition is true, specifies repeated evaluation of a primary statement followed by a subsequent statement until the condition is no longer true.

Some key definitions, bitstream and coding structures, and concepts of H.264/AVC and HEVC and some of their extensions are described in this section as an example of a video encoder, decoder, encoding method, decoding method, and a bitstream structure, wherein the embodiments may be implemented. Some of the key definitions, bitstream and coding structures, and concepts of H.264/AVC are the same as in a draft HEVC standard—hence, they are described below jointly. The aspects of the invention are not limited to H.264/AVC or HEVC or their extensions, but rather the description is given for one possible basis on top of which the invention may be partly or fully realized.

Similarly to many earlier video coding standards, the bitstream syntax and semantics as well as the decoding process for error-free bitstreams are specified in H.264/AVC and HEVC. The encoding process is not specified, but encoders must generate conforming bitstreams. Bitstream and decoder conformance can be verified with the Hypothetical Reference Decoder (HRD). The standards contain coding tools that help in coping with transmission errors and losses, but the use of the tools in encoding is optional and no decoding process has been specified for erroneous bitstreams.

The elementary unit for the input to an H.264/AVC or HEVC encoder and the output of an H.264/AVC or HEVC decoder, respectively, is a picture. A picture given as an input to an encoder may also be referred to as a source picture, and a picture decoded by a decoder may be referred to as a decoded picture.

The source and decoded pictures may each be comprised of one or more sample arrays, such as one of the following sets of sample arrays:
Luma (Y) only (monochrome).
Luma and two chroma (YCbCr or YCgCo).
Green, Blue and Red (GBR, also known as RGB).
Arrays representing other unspecified monochrome or tri-stimulus color samplings (for example, YZX, also known as XYZ).

In the following, these arrays may be referred to as luma (or L or Y) and chroma, where the two chroma arrays may be referred to as Cb and Cr; regardless of the actual color representation method in use. The actual color representation method in use may be indicated e.g. in a coded bitstream e.g. using the Video Usability Information (VUI) syntax of H.264/AVC and/or HEVC. A component may be defined as an array or a single sample from one of the three sample arrays (luma and two chroma) or the array or a single sample of the array that compose a picture in monochrome format.

In H.264/AVC and HEVC, a picture may either be a frame or a field. A frame comprises a matrix of luma samples and possibly the corresponding chroma samples. A field is a set of alternate sample rows of a frame. Fields may be used as encoder input for example when the source signal is interlaced. Chroma sample arrays may be absent (and hence monochrome sampling may be in use) or may be subsampled when compared to luma sample arrays. Some chroma formats may be summarized as follows:
In monochrome sampling there is only one sample array, which may be nominally considered the luma array.
In 4:2:0 sampling, each of the two chroma arrays has half the height and half the width of the luma array.
In 4:2:2 sampling, each of the two chroma arrays has the same height and half the width of the luma array.
In 4:4:4 sampling when no separate color planes are in use, each of the two chroma arrays has the same height and width as the luma array.

In H.264/AVC and HEVC, it is possible to code sample arrays as separate color planes into the bitstream and respectively decode separately coded color planes from the bitstream. When separate color planes are in use, each one of them is separately processed (by the encoder and/or the decoder) as a picture with monochrome sampling.

When chroma subsampling is in use (e.g. 4:2:0 or 4:2:2 chroma sampling), the location of chroma samples with respect to luma samples may be determined in the encoder side (e.g. as pre-processing step or as part of encoding). The chroma sample positions with respect to luma sample positions may be pre-defined for example in a coding standard, such as H.264/AVC or HEVC, or may be indicated in the bitstream for example as part of VUI of H.264/AVC or HEVC.

Generally, the source video sequence(s) provided as input for encoding may either represent interlaced source content or progressive source content. Fields of opposite parity have been captured at different times for interlaced source content. Progressive source content contains captured frames. An encoder may encode fields of interlaced source content in two ways: a pair of interlaced fields may be coded into a coded frame or a field may be coded as a coded field. Likewise, an encoder may encode frames of progressive source content in two ways: a frame of progressive source content may be coded into a coded frame or a pair of coded fields. A field pair or a complementary field pair may be defined as two fields next to each other in decoding and/or output order, having opposite parity (i.e. one being a top field and another being a bottom field) and neither belonging to any other complementary field pair. Some video coding standards or schemes allow mixing of coded frames and coded fields in the same coded video sequence. Moreover, predicting a coded field from a field in a coded frame and/or predicting a coded frame for a complementary field pair (coded as fields) may be enabled in encoding and/or decoding.

A partitioning may be defined as a division of a set into subsets such that each element of the set is in exactly one of the subsets. A picture partitioning may be defined as a division of a picture into smaller non-overlapping units. A block partitioning may be defined as a division of a block into smaller non-overlapping units, such as sub-blocks. In some cases term block partitioning may be considered to cover multiple levels of partitioning, for example partitioning of a picture into slices, and partitioning of each slice into smaller units, such as macroblocks of H.264/AVC. It is noted that the same unit, such as a picture, may have more than one partitioning. For example, a coding unit of a draft HEVC standard may be partitioned into prediction units and separately by another quadtree into transform units.

In H.264/AVC, a macroblock is a 16×16 block of luma samples and the corresponding blocks of chroma samples. For example, in the 4:2:0 sampling pattern, a macroblock contains one 8×8 block of chroma samples per each chroma component. In H.264/AVC, a picture is partitioned to one or more slice groups, and a slice group contains one or more slices. In H.264/AVC, a slice consists of an integer number of macroblocks ordered consecutively in the raster scan within a particular slice group.

During the course of HEVC standardization the terminology for example on picture partitioning units has evolved. In the next paragraphs, some non-limiting examples of HEVC terminology are provided.

In one draft version of the HEVC standard, pictures are divided into coding units (CU) covering the area of the picture. A CU consists of one or more prediction units (PU) defining the prediction process for the samples within the CU and one or more transform units (TU) defining the prediction error coding process for the samples in the CU. Typically, a CU consists of a square block of samples with a size selectable from a predefined set of possible CU sizes. A CU with the maximum allowed size is typically named as LCU (largest coding unit) and the video picture is divided into non-overlapping LCUs. An LCU can be further split into a combination of smaller CUs, e.g. by recursively splitting the LCU and resultant CUs. Each resulting CU typically has at least one PU and at least one TU associated with it. Each PU and TU can further be split into smaller PUs and TUs in order to increase granularity of the prediction and prediction error coding processes, respectively. The PU splitting can be realized by splitting the CU into four equal size square PUs or splitting the CU into two rectangle PUs vertically or horizontally in a symmetric or asymmetric way. The division of the image into CUs, and division of CUs into PUs and TUs is typically signalled in the bitstream allowing the decoder to reproduce the intended structure of these units.

In a draft HEVC standard, a picture can be partitioned in tiles, which are rectangular and contain an integer number of LCUs. In a draft of HEVC, the partitioning to tiles forms a regular grid, where heights and widths of tiles differ from each other by one LCU at the maximum. In a draft HEVC, a slice consists of an integer number of CUs. The CUs are scanned in the raster scan order of LCUs within tiles or within a picture, if tiles are not in use. Within an LCU, the CUs have a specific scan order.

In a Working Draft (WD) 5 of HEVC, some key definitions and concepts for picture partitioning are defined as follows. A partitioning is defined as the division of a set into subsets such that each element of the set is in exactly one of the subsets.

A basic coding unit in a draft HEVC is a treeblock. A treeblock is an N×N block of luma samples and two corresponding blocks of chroma samples of a picture that has three sample arrays, or an N×N block of samples of a monochrome picture or a picture that is coded using three separate colour planes. A treeblock may be partitioned for different coding and decoding processes. A treeblock partition is a block of luma samples and two corresponding blocks of chroma samples resulting from a partitioning of a treeblock for a picture that has three sample arrays or a block of luma samples resulting from a partitioning of a treeblock for a monochrome picture or a picture that is coded using three separate colour planes. Each treeblock is assigned a partition signalling to identify the block sizes for intra or inter prediction and for transform coding. The partitioning is a recursive quadtree partitioning. The root of the quadtree is associated with the treeblock. The quadtree is split until a leaf is reached, which is referred to as the coding node. The coding node is the root node of two trees, the prediction tree and the transform tree. The prediction tree specifies the position and size of prediction blocks. The prediction tree and associated prediction data are referred to as a prediction unit. The transform tree specifies the position and size of transform blocks. The transform tree and associated transform data are referred to as a transform unit. The splitting information for luma and chroma is identical for the prediction tree and may or may not be identical for the transform tree. The coding node and the associated prediction and transform units form together a coding unit.

In a draft HEVC, pictures are divided into slices and tiles. A slice may be a sequence of treeblocks but (when referring to a so-called fine granular slice) may also have its boundary within a treeblock at a location where a transform unit and prediction unit coincide. The fine granular slice feature was included in some drafts of HEVC but is not included in the finalized HEVC standard. Treeblocks within a slice are coded and decoded in a raster scan order. The division of a picture into slices is a partitioning.

In a draft HEVC, a tile is defined as an integer number of treeblocks co-occurring in one column and one row, ordered consecutively in the raster scan within the tile. The division of a picture into tiles is a partitioning. Tiles are ordered consecutively in the raster scan within the picture. Although a slice contains treeblocks that are consecutive in the raster scan within a tile, these treeblocks are not necessarily consecutive in the raster scan within the picture. Slices and tiles need not contain the same sequence of treeblocks. A tile may comprise treeblocks contained in more than one slice. Similarly, a slice may comprise treeblocks contained in several tiles.

A distinction between coding units and coding treeblocks may be defined for example as follows. A slice may be defined as a sequence of one or more coding tree units (CTU) in raster-scan order within a tile or within a picture if tiles are not in use. Each CTU may comprise one luma coding treeblock (CTB) and possibly (depending on the chroma format being used) two chroma CTBs. A CTU may be defined as a coding tree block of luma samples, two corresponding coding tree blocks of chroma samples of a picture that has three sample arrays, or a coding tree block of samples of a monochrome picture or a picture that is coded using three separate colour planes and syntax structures used to code the samples. The division of a slice into coding tree units may be regarded as a partitioning. A CTB may be defined as an N×N block of samples for some value of N. The division of one of the arrays that compose a picture that has three sample arrays or of the array that compose a picture in monochrome format or a picture that is coded using three separate colour planes into coding tree blocks may be regarded as a partitioning. A coding block may be defined as an N×N block of samples for some value of N. The division of a coding tree block into coding blocks may be regarded as a partitioning.

In HEVC, a slice may be defined as an integer number of coding tree units contained in one independent slice segment and all subsequent dependent slice segments (if any) that precede the next independent slice segment (if any) within the same access unit. An independent slice segment may be defined as a slice segment for which the values of the syntax elements of the slice segment header are not inferred from the values for a preceding slice segment. A dependent slice segment may be defined as a slice segment for which the values of some syntax elements of the slice segment header are inferred from the values for the preceding independent slice segment in decoding order. In other words, only the independent slice segment may have a “full” slice header. An independent slice segment may be conveyed in one NAL unit (without other slice segments in the same NAL unit) and likewise a dependent slice segment may be conveyed in one NAL unit (without other slice segments in the same NAL unit).

In HEVC, a coded slice segment may be considered to comprise a slice segment header and slice segment data. A slice segment header may be defined as part of a coded slice segment containing the data elements pertaining to the first or all coding tree units represented in the slice segment. A slice header may be defined as the slice segment header of the independent slice segment that is a current slice segment or the most recent independent slice segment that precedes a current dependent slice segment in decoding order. Slice segment data may comprise an integer number of coding tree unit syntax structures.

In H.264/AVC and HEVC, in-picture prediction may be disabled across slice boundaries. Thus, slices can be regarded as a way to split a coded picture into independently decodable pieces, and slices are therefore often regarded as elementary units for transmission. In many cases, encoders may indicate in the bitstream which types of in-picture prediction are turned off across slice boundaries, and the decoder operation takes this information into account for example when concluding which prediction sources are available. For example, samples from a neighboring macroblock or CU may be regarded as unavailable for intra prediction, if the neighboring macroblock or CU resides in a different slice.

A syntax element may be defined as an element of data represented in the bitstream. A syntax structure may be defined as zero or more syntax elements present together in the bitstream in a specified order.

The elementary unit for the output of an H.264/AVC or HEVC encoder and the input of an H.264/AVC or HEVC decoder, respectively, is a Network Abstraction Layer (NAL) unit. For transport over packet-oriented networks or storage into structured files, NAL units may be encapsulated into packets or similar structures. A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed regardless of whether the bytestream format is in use or not.

A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

NAL units consist of a header and payload. In H.264/AVC, the NAL unit header indicates the type of the NAL unit and whether a coded slice contained in the NAL unit is a part of a reference picture or a non-reference picture. H.264/AVC includes a 2-bit nal_ref_idc syntax element, which when equal to 0 indicates that a coded slice contained in the NAL unit is a part of a non-reference picture and when greater than 0 indicates that a coded slice contained in the NAL unit is a part of a reference picture. The NAL unit header for SVC and MVC NAL units may additionally contain various indications related to the scalability and multiview hierarchy.

In HEVC, a two-byte NAL unit header is used for all specified NAL unit types. The NAL unit header contains one reserved bit, a six-bit NAL unit type indication (called nal_unit_type), a six-bit reserved field (called nuh_layer_id) and a three-bit temporal_id_plus1 indication for temporal level. The temporal_id_plus1 syntax element may be regarded as a temporal identifier for the NAL unit, and a zero-based TemporalId variable may be derived as follows: TemporalId=temporal_id_plus1-1. TemporalId equal to 0 corresponds to the lowest temporal level. The value of temporal_id_plus1 is required to be non-zero in order to avoid start code emulation involving the two NAL unit header bytes. The bitstream created by excluding all VCL NAL units having a TemporalId greater than or equal to a selected value and including all other VCL NAL units remains conforming. Consequently, a picture having TemporalId equal to TID does not use any picture having a TemporalId greater than TID as inter prediction reference. A sub-layer or a temporal sub-layer may be defined to be a temporal scalable layer of a temporal scalable bitstream, consisting of VCL NAL units with a particular value of the TemporalId variable and the associated non-VCL NAL units. Without loss of generality, in some example embodiments a variable LayerId is derived from the value of nuh_layer_id for example as follows: LayerId=nuh_layer_id. In the following, layer identifier, LayerId, nuh_layer_id and layer_id are used interchangeably unless otherwise indicated.

In HEVC extensions nuh_layer_id and/or similar syntax elements in NAL unit header carries scalability layer information. For example, the LayerId value nuh_layer_id and/or similar syntax elements may be mapped to values of variables or syntax elements describing different scalability dimensions.

NAL units can be categorized into Video Coding Layer (VCL) NAL units and non-VCL NAL units. VCL NAL units are typically coded slice NAL units. In H.264/AVC, coded slice NAL units contain syntax elements representing one or more coded macroblocks, each of which corresponds to a block of samples in the uncompressed picture. In HEVC, coded slice NAL units contain syntax elements representing one or more CU.

In H.264/AVC a coded slice NAL unit can be indicated to be a coded slice in an Instantaneous Decoding Refresh (IDR) picture or coded slice in a non-IDR picture.

In HEVC, a VCL NAL unit can be indicated to be one of the following types.

| | Name of | Content of NAL unit and | NAL unit |
|---|---|---|---|
| nal_unit_type | nal_unit_type | RBSP syntax structure | type class |
| 0 | TRAIL_N | Coded slice segment of a non-TSA, | VCL |
| 1 | TRAIL_R | non-STSA trailing picture | |
| | | slice_segment_layer_rbsp( ) | |
| 2 | TSA_N | Coded slice segment of a TSA picture | VCL |
| 3 | TSA_R | slice_segment_layer_rbsp( ) | |
| 4 | STSA_N | Coded slice segment of an STSA picture | VCL |
| 5 | STSA_R | slice_segment_layer_rbsp( ) | |
| 6 | RADL_N | Coded slice segment of a RADL picture | VCL |
| 7 | RADL_R | slice_segment_layer_rbsp( ) | |
| 8 | RASL_N | Coded slice segment of a RASL picture | VCL |
| 9 | RASL_R | slice_segment_layer_rbsp( ) | |
| 10 | RSV_VCL_N10 | Reserved non-IRAP sub-layer | VCL |
| 12 | RSV_VCL_N12 | non-reference VCL NAL unit types | |
| 14 | RSV_VCL_N14 | | |
| 11 | RSV_VCL_R11 | Reserved non-IRAP sub-layer reference | VCL |
| 13 | RSV_VCL_R13 | VCL NAL unit types | |
| 15 | RSV_VCL_R15 | | |
| 16 | BLA_W_LP | Coded slice segment of a BLA picture | VCL |
| 17 | BLA_W_RADL | slice_segment_layer_rbsp( ) | |
| 18 | BLA_N_LP | | |
| 19 | IDR_W_RADL | Coded slice segment of an IDR picture | VCL |
| 20 | IDR_N_LP | slice_segment_layer_rbsp( ) | |
| 21 | CRA_NUT | Coded slice segment of a CRA picture | VCL |
| | | slice_segment_layer_rbsp( ) | |
| 22 | RSV_IRAP_VCL22 | Reserved IRAP VCL NAL unit types | VCL |
| 23 | RSV_IRAP_VCL23 | | |

Abbreviations for picture types may be defined as follows: trailing (TRAIL) picture, Temporal Sub-layer Access (TSA), Step-wise Temporal Sub-layer Access (STSA), Random Access Decodable Leading (RADL) picture, Random Access Skipped Leading (RASL) picture, Broken Link Access (BLA) picture, Instantaneous Decoding Refresh (IDR) picture, Clean Random Access (CRA) picture.

A Random Access Point (RAP) picture, which may also or alternatively be referred to as intra random access point (IRAP) picture, is a picture where each slice or slice segment has nal_unit_type in the range of 16 to 23, inclusive. A RAP picture contains only intra-coded slices (in an independently coded layer), and may be a BLA picture, a CRA picture or an IDR picture. The first picture in the bitstream is a RAP picture. Provided the necessary parameter sets are available when they need to be activated, the RAP picture and all subsequent non-RASL pictures in decoding order can be correctly decoded without performing the decoding process of any pictures that precede the RAP picture in decoding order. There may be pictures in a bitstream that contain only intra-coded slices that are not RAP pictures.

In HEVC, a CRA picture may be the first picture in the bitstream in decoding order, or may appear later in the bitstream. CRA pictures in HEVC allow so-called leading pictures that follow the CRA picture in decoding order but precede it in output order. Some of the leading pictures, so-called RASL pictures, may use pictures decoded before the CRA picture as a reference. Pictures that follow a CRA picture in both decoding and output order are decodable if random access is performed at the CRA picture, and hence clean random access is achieved similarly to the clean random access functionality of an IDR picture.

A CRA picture may have associated RADL or RASL pictures. When a CRA picture is the first picture in the bitstream in decoding order, the CRA picture is the first picture of a coded video sequence in decoding order, and any associated RASL pictures are not output by the decoder and may not be decodable, as they may contain references to pictures that are not present in the bitstream.

A leading picture is a picture that precedes the associated RAP picture in output order. The associated RAP picture is the previous RAP picture in decoding order (if present). A leading picture may either be a RADL picture or a RASL picture.

All RASL pictures are leading pictures of an associated BLA or CRA picture. When the associated RAP picture is a BLA picture or is the first coded picture in the bitstream, the RASL picture is not output and may not be correctly decodable, as the RASL picture may contain references to pictures that are not present in the bitstream. However, a RASL picture can be correctly decoded if the decoding had started from a RAP picture before the associated RAP picture of the RASL picture. RASL pictures are not used as reference pictures for the decoding process of non-RASL pictures. When present, all RASL pictures precede, in decoding order, all trailing pictures of the same associated RAP picture. In some drafts of the HEVC standard, a RASL picture was referred to a Tagged for Discard (TFD) picture.

All RADL pictures are leading pictures. RADL pictures are not used as reference pictures for the decoding process of trailing pictures of the same associated RAP picture. When present, all RADL pictures precede, in decoding order, all trailing pictures of the same associated RAP picture. RADL pictures do not refer to any picture preceding the associated RAP picture in decoding order and can therefore be correctly decoded when the decoding starts from the associated RAP picture. In some earlier drafts of the HEVC standard, a RADL picture was referred to a Decodable Leading Picture (DLP).

Decodable leading pictures may be such that can be correctly decoded when the decoding is started from the CRA picture. In other words, decodable leading pictures use only the initial CRA picture or subsequent pictures in decoding order as reference in inter prediction. Non-decodable leading pictures are such that cannot be correctly decoded when the decoding is started from the initial CRA picture. In other words, non-decodable leading pictures use pictures prior, in decoding order, to the initial CRA picture as references in inter prediction.

When a part of a bitstream starting from a CRA picture is included in another bitstream, the RASL pictures associated with the CRA picture might not be correctly decodable, because some of their reference pictures might not be present in the combined bitstream. To make such a splicing operation straightforward, the NAL unit type of the CRA picture can be changed to indicate that it is a BLA picture. The RASL pictures associated with a BLA picture may not be correctly decodable hence are not be output/displayed. Furthermore, the RASL pictures associated with a BLA picture may be omitted from decoding.

A BLA picture may be the first picture in the bitstream in decoding order, or may appear later in the bitstream. Each BLA picture begins a new coded video sequence, and has similar effect on the decoding process as an IDR picture. However, a BLA picture contains syntax elements that specify a non-empty reference picture set. When a BLA picture has nal_unit_type equal to BLA_W_LP, it may have associated RASL pictures, which are not output by the decoder and may not be decodable, as they may contain references to pictures that are not present in the bitstream. When a BLA picture has nal_unit_type equal to BLA_W_LP, it may also have associated RADL pictures, which are specified to be decoded. When a BLA picture has nal_unit_type equal to BLA_W_RADL (which was referred to as BLA_W_DLP in some HEVC drafts), it does not have associated RASL pictures but may have associated RADL pictures, which are specified to be decoded. BLA_W_RADL may also be referred to as BLA_W_DLP. When a BLA picture has nal_unit_type equal to BLA_N_LP, it does not have any associated leading pictures.

An IDR picture having nal_unit_type equal to IDR_N_LP does not have associated leading pictures present in the bitstream. An IDR picture having nal_unit_type equal to IDR_W_RADL does not have associated RASL pictures present in the bitstream, but may have associated RADL pictures in the bitstream. IDR_W_RADL may also be referred to as IDR_W_DLP.

In HEVC, there are two NAL unit types for many picture types (e.g. TRAIL_R, TRAIL_N), differentiated whether the picture may be used as reference for inter prediction in subsequent pictures in decoding order in the same sub-layer. Sub-layer non-reference picture (often denoted by _N in the picture type acronyms) may be defined as picture that contains samples that cannot be used for inter prediction in the decoding process of subsequent pictures of the same sub-layer in decoding order. Sub-layer non-reference pictures may be used as reference for pictures with a greater TemporalId value. Sub-layer reference picture (often denoted by _R in the picture type acronyms) may be defined as picture that may be used as reference for inter prediction in the decoding process of subsequent pictures of the same sub-layer in decoding order.

When the value of nal_unit_type is equal to TRAIL_N, TSA_N, STSA_N, RADL_N, RASL_N, RSV_VCL_N10, RSV_VCL_N12, or RSV_VCL_N14, the decoded picture is not used as a reference for any other picture of the same nuh_layer_id and temporal sub-layer. That is, in the HEVC standard, when the value of nal_unit_type is equal to TRAIL_N, TSA_N, STSA_N, RADL_N, RASL_N, RSV_VCL_N10, RSV_VCL_N12, or RSV_VCL_N14, the decoded picture is not included in any of RefPicSetStCurrBefore, RefPicSetStCurrAfter and RefPicSetLtCurr of any picture with the same value of TemporalId. A coded picture with nal_unit_type equal to TRAIL_N, TSA_N, STSA_N, RADL_N, RASL_N, RSV_VCL_N10, RSV_VCL_N12, or RSV_VCL_N14 may be discarded without affecting the decodability of other pictures with the same value of nuh_layer_id and TemporalId.

Pictures of any coding type (I, P, B) can be reference pictures or non-reference pictures in H.264/AVC and HEVC. Slices within a picture may have different coding types.

A trailing picture may be defined as a picture that follows the associated RAP picture in output order. Any picture that is a trailing picture does not have nal_unit_type equal to RADL_N, RADL_R, RASL_N or RASL_R. Any picture that is a leading picture may be constrained to precede, in decoding order, all trailing pictures that are associated with the same RAP picture. No RASL pictures are present in the bitstream that are associated with a BLA picture having nal_unit_type equal to BLA_W_RADL or BLA_N_LP. No RADL pictures are present in the bitstream that are associated with a BLA picture having nal_unit_type equal to BLA_N_LP or that are associated with an IDR picture having nal_unit_type equal to IDR_N_LP. Any RASL picture associated with a CRA or BLA picture may be constrained to precede any RADL picture associated with the CRA or BLA picture in output order. Any RASL picture associated with a CRA picture may be constrained to follow, in output order, any other RAP picture that precedes the CRA picture in decoding order.

In HEVC there are two picture types, the TSA and STSA picture types, that can be used to indicate temporal sub-layer switching points. If temporal sub-layers with TemporalId up to N had been decoded until the TSA or STSA picture (exclusive) and the TSA or STSA picture has TemporalId equal to N+1, the TSA or STSA picture enables decoding of all subsequent pictures (in decoding order) having TemporalId equal to N+1. The TSA picture type may impose restrictions on the TSA picture itself and all pictures in the same sub-layer that follow the TSA picture in decoding order. None of these pictures is allowed to use inter prediction from any picture in the same sub-layer that precedes the TSA picture in decoding order. The TSA definition may further impose restrictions on the pictures in higher sub-layers that follow the TSA picture in decoding order. None of these pictures is allowed to refer a picture that precedes the TSA picture in decoding order if that picture belongs to the same or higher sub-layer as the TSA picture. TSA pictures have TemporalId greater than 0. The STSA is similar to the TSA picture but does not impose restrictions on the pictures in higher sub-layers that follow the STSA picture in decoding order and hence enable up-switching only onto the sub-layer where the STSA picture resides.

A non-VCL NAL unit may be for example one of the following types: a sequence parameter set, a picture parameter set, a supplemental enhancement information (SEI) NAL unit, an access unit delimiter, an end of sequence NAL unit, an end of stream NAL unit, or a filler data NAL unit. Parameter sets may be needed for the reconstruction of decoded pictures, whereas many of the other non-VCL NAL units are not necessary for the reconstruction of decoded sample values.

In HEVC, the following non-VCL NAL unit types have been specified.

| | Name of | Content of NAL unit and | NAL unit |
|---|---|---|---|
| nal_unit_type | nal_unit_type | RBSP syntax structure | type class |
| 32 | VPS_NUT | Video parameter set | non-VCL |
| | | video_parameter_set_rbsp( ) | |
| 33 | SPS_NUT | Sequence parameter set | non-VCL |
| | | seq_parameter_set_rbsp( ) | |
| 34 | PPS_NUT | Picture parameter set | non-VCL |
| | | pic_parameter_set_rbsp( ) | |
| 35 | AUD_NUT | Access unit delimiter | non-VCL |
| | | access_unit_delimiter_rbsp( ) | |
| 36 | EOS_NUT | End of sequence | non-VCL |
| | | end_of_seq_rbsp( ) | |
| 37 | EOB_NUT | End of bitstream | non-VCL |
| | | end_of_bitstream_rbsp( ) | |
| 38 | FD_NUT | Filler data | non-VCL |
| | | filler_data_rbsp( ) | |
| 39 | PREFIX_SEI_NUT | Supplemental enhancement | non-VCL |
| 40 | SUFFIX_SEI_NUT | information | |
| | | sei_rbsp( ) | |
| 41 . . . 47 | RSV_NVCL41 . . . | Reserved | non-VCL |
| | RSV_NVCL47 | | |

Parameters that remain unchanged through a coded video sequence may be included in a sequence parameter set. In addition to the parameters that may be needed by the decoding process, the sequence parameter set may optionally contain video usability information (VUI), which includes parameters that may be important for buffering, picture output timing, rendering, and resource reservation. There are three NAL units specified in H.264/AVC to carry sequence parameter sets: the sequence parameter set NAL unit (having NAL unit type equal to 7) containing all the data for H.264/AVC VCL NAL units in the sequence, the sequence parameter set extension NAL unit containing the data for auxiliary coded pictures, and the subset sequence parameter set for MVC and SVC VCL NAL units. The syntax structure included in the sequence parameter set NAL unit of H.264/AVC (having NAL unit type equal to 7) may be referred to as sequence parameter set data, seq_parameter_set_data, or base SPS (Sequence Parameter Set) data. For example, profile, level, the picture size and the chroma sampling format may be included in the base SPS data. A picture parameter set contains such parameters that are likely to be unchanged in several coded pictures.

In a draft HEVC, there was also another type of a parameter set, here referred to as an Adaptation Parameter Set (APS), which includes parameters that are likely to be unchanged in several coded slices but may change for example for each picture or each few pictures. In a draft HEVC, the APS syntax structure includes parameters or syntax elements related to quantization matrices (QM), sample adaptive offset (SAO), adaptive loop filtering (ALF), and deblocking filtering. In a draft HEVC, an APS is a NAL unit and coded without reference or prediction from any other NAL unit. An identifier, referred to as aps_id syntax element, is included in APS NAL unit, and included and used in the slice header to refer to a particular APS. However, APS was not included in the final H.265/HEVC standard.

H.265/HEVC also includes another type of a parameter set, called a video parameter set (VPS). A video parameter set RBSP may include parameters that can be referred to by one or more sequence parameter set RBSPs.

The relationship and hierarchy between VPS, SPS, and PPS may be described as follows. VPS resides one level above SPS in the parameter set hierarchy and in the context of scalability and/or 3DV. VPS may include parameters that are common for all slices across all (scalability or view) layers in the entire coded video sequence. SPS includes the parameters that are common for all slices in a particular (scalability or view) layer in the entire coded video sequence, and may be shared by multiple (scalability or view) layers. PPS includes the parameters that are common for all slices in a particular layer representation (the representation of one scalability or view layer in one access unit) and are likely to be shared by all slices in multiple layer representations.

VPS may provide information about the dependency relationships of the layers in a bitstream, as well as many other information that are applicable to all slices across all (scalability or view) layers in the entire coded video sequence.

H.264/AVC and HEVC syntax allows many instances of parameter sets, and each instance is identified with a unique identifier. In order to limit the memory usage needed for parameter sets, the value range for parameter set identifiers has been limited. In H.264/AVC and a draft HEVC standard, each slice header includes the identifier of the picture parameter set that is active for the decoding of the picture that contains the slice, and each picture parameter set contains the identifier of the active sequence parameter set. In a draft HEVC standard, a slice header additionally contains an APS identifier. Consequently, the transmission of picture and sequence parameter sets does not have to be accurately synchronized with the transmission of slices. Instead, it is sufficient that the active sequence and picture parameter sets are received at any moment before they are referenced, which allows transmission of parameter sets “out-of-band” using a more reliable transmission mechanism compared to the protocols used for the slice data. For example, parameter sets can be included as a parameter in the session description for Real-time Transport Protocol (RTP) sessions. If parameter sets are transmitted in-band, they can be repeated to improve error robustness.

A parameter set may be activated by a reference from a slice or from another active parameter set or in some cases from another syntax structure such as a buffering period SEI message.

A SEI NAL unit may contain one or more SEI messages, which are not required for the decoding of output pictures but may assist in related processes, such as picture output timing, rendering, error detection, error concealment, and resource reservation. Several SEI messages are specified in H.264/AVC and HEVC, and the user data SEI messages enable organizations and companies to specify SEI messages for their own use. H.264/AVC and HEVC contain the syntax and semantics for the specified SEI messages but no process for handling the messages in the recipient is defined. Consequently, encoders are required to follow the H.264/AVC standard or the HEVC standard when they create SEI messages, and decoders conforming to the H.264/AVC standard or the HEVC standard, respectively, are not required to process SEI messages for output order conformance. One of the reasons to include the syntax and semantics of SEI messages in H.264/AVC and HEVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

Both H.264/AVC and H.265/HEVC standards leave a range of NAL unit type values as unspecified. It is intended that these unspecified NAL unit type values may be taken into use by other specifications. NAL units with these unspecified NAL unit type values may be used to multiplex data, such as data required for a communication protocol, within the video bitstream. If the NAL units with these unspecified NAL unit type values are not passed to the decoder, the start code emulation prevention for bitstream start code emulations of the video bitstream need not be performed in the when these NAL units are created and included in the video bitstream and the start code emulation prevention removal needs not be done, as these NAL units are removed from the video bitstream before passing them to the decoder. When it is possible that NAL units with unspecified NAL unit type values contain start code emulations, the NAL units may be referred to as NAL-unit-like structures Unlike actual NAL units, the NAL-unit-like structures may contain start code emulations.

In HEVC, the unspecified NAL unit types have a nal_unit_type value in the range of 48 to 63, inclusive, and may be specified in a table format as follows:

| | Name of | Content of NAL unit and | NAL unit |
|---|---|---|---|
| nal_unit_type | nal_unit_type | RBSP syntax structure | type class |
| 48 . . . 63 | UNSPEC48 . . . | Unspecified | non-VCL |
| | UNSPEC63 | | |

In HEVC, it is specified that NAL units UNSPEC48 to UNSPEC55, inclusive (i.e., with nal_unit_type value in the range of 48 to 55, inclusive), are such that may start an access unit, while NAL units UNSPEC56 to UNSPEC63 (i.e., with nal_unit_type value in the range of 56 to 63, inclusive), are such that may be at the end of an access unit.

A coded picture is a coded representation of a picture. A coded picture in H.264/AVC comprises the VCL NAL units that are required for the decoding of the picture. In H.264/AVC, a coded picture can be a primary coded picture or a redundant coded picture. A primary coded picture is used in the decoding process of valid bitstreams, whereas a redundant coded picture is a redundant representation that should only be decoded when the primary coded picture cannot be successfully decoded.

In H.264/AVC, an access unit comprises a primary coded picture and those NAL units that are associated with it. In HEVC, an access unit is defined as a set of NAL units that are associated with each other according to a specified classification rule, are consecutive in decoding order, and contain exactly one coded picture. In H.264/AVC, the appearance order of NAL units within an access unit is constrained as follows. An optional access unit delimiter NAL unit may indicate the start of an access unit. It is followed by zero or more SEI NAL units. The coded slices of the primary coded picture appear next. In H.264/AVC, the coded slice of the primary coded picture may be followed by coded slices for zero or more redundant coded pictures. A redundant coded picture is a coded representation of a picture or a part of a picture. A redundant coded picture may be decoded if the primary coded picture is not received by the decoder for example due to a loss in transmission or a corruption in physical storage medium.

In H.264/AVC, an access unit may also include an auxiliary coded picture, which is a picture that supplements the primary coded picture and may be used for example in the display process. An auxiliary coded picture may for example be used as an alpha channel or alpha plane specifying the transparency level of the samples in the decoded pictures. An alpha channel or plane may be used in a layered composition or rendering system, where the output picture is formed by overlaying pictures being at least partly transparent on top of each other. An auxiliary coded picture has the same syntactic and semantic restrictions as a monochrome redundant coded picture. In H.264/AVC, an auxiliary coded picture contains the same number of macroblocks as the primary coded picture.

In HEVC, a coded picture may be defined as a coded representation of a picture containing all coding tree units of the picture. In HEVC, an access unit may be defined as a set of NAL units that are associated with each other according to a specified classification rule, are consecutive in decoding order, and contain one or more coded pictures with different values of nuh_layer_id. In addition to containing the VCL NAL units of the coded picture, an access unit may also contain non-VCL NAL units.

In H.264/AVC, a coded video sequence is defined to be a sequence of consecutive access units in decoding order from an IDR access unit, inclusive, to the next IDR access unit, exclusive, or to the end of the bitstream, whichever appears earlier.

In HEVC, a coded video sequence (CVS) may be defined, for example, as a sequence of access units that consists, in decoding order, of an IRAP access unit with NoRaslOutputFlag equal to 1, followed by zero or more access units that are not IRAP access units with NoRaslOutputFlag equal to 1, including all subsequent access units up to but not including any subsequent access unit that is an IRAP access unit with NoRaslOutputFlag equal to 1. An IRAP access unit may be an IDR access unit, a BLA access unit, or a CRA access unit. The value of NoRaslOutputFlag is equal to 1 for each IDR access unit, each BLA access unit, and each CRA access unit that is the first access unit in the bitstream in decoding order, is the first access unit that follows an end of sequence NAL unit in decoding order, or has HandleCraAsBlaFlag equal to 1. NoRaslOutputFlag equal to 1 has an impact that the RASL pictures associated with the IRAP picture for which the NoRaslOutputFlag is set are not output by the decoder. HandleCraAsBlaFlag may be set to 1 for example by a player that seeks to a new position in a bitstream or tunes into a broadcast and starts decoding and then starts decoding from a CRA picture.

A group of pictures (GOP) and its characteristics may be defined as follows. A GOP can be decoded regardless of whether any previous pictures were decoded. An open GOP is such a group of pictures in which pictures preceding the initial intra picture in output order might not be correctly decodable when the decoding starts from the initial intra picture of the open GOP. In other words, pictures of an open GOP may refer (in inter prediction) to pictures belonging to a previous GOP. An H.264/AVC decoder can recognize an intra picture starting an open GOP from the recovery point SEI message in an H.264/AVC bitstream. An HEVC decoder can recognize an intra picture starting an open GOP, because a specific NAL unit type, CRA NAL unit type, is used for its coded slices. A closed GOP is such a group of pictures in which all pictures can be correctly decoded when the decoding starts from the initial intra picture of the closed GOP. In other words, no picture in a closed GOP refers to any pictures in previous GOPs. In H.264/AVC and HEVC, a closed GOP starts from an IDR access unit. In HEVC a closed GOP may also start from a BLA_W_RADL or a BLA_N_LP picture. As a result, closed GOP structure has more error resilience potential in comparison to the open GOP structure, however at the cost of possible reduction in the compression efficiency. Open GOP coding structure is potentially more efficient in the compression, due to a larger flexibility in selection of reference pictures.

A Structure of Pictures (SOP) may be defined as one or more coded pictures consecutive in decoding order, in which the first coded picture in decoding order is a reference picture at the lowest temporal sub-layer and no coded picture except potentially the first coded picture in decoding order is a RAP picture. The relative decoding order of the pictures is illustrated by the numerals inside the pictures. Any picture in the previous SOP has a smaller decoding order than any picture in the current SOP and any picture in the next SOP has a larger decoding order than any picture in the current SOP. The term group of pictures (GOP) may sometimes be used interchangeably with the term SOP and having the same semantics as the semantics of SOP rather than the semantics of closed or open GOP as described above.

Picture-adaptive frame-field coding (PAFF) refers to an ability of an encoder or a coding scheme to determine on picture-basis whether coded field(s) or a coded frame is coded. Sequence-adaptive frame-field coding (SAFF) refers to an ability of an encoder or a coding scheme to determine for a sequence of pictures, such as a coded video sequence, a group of pictures (GOP) or a structure of pictures (SOP), whether coded fields or coded frames are coded.

HEVC includes various ways related to indicating fields (versus frames) and source scan type, which may be summarized as follows. In HEVC, the profile_tier_level( ) syntax structure is included in the SPS with nuh_layer_id equal to 0 and in VPS. When the profile_tier_level( ) syntax structure is included in a VPS, but not in a vps_extension( ) syntax structure, the applicable layer set to which the profile_tier_level( ) syntax structure applies is the layer set specified by the index 0, i.e. contains the base layer only. When the profile_tier_level( ) syntax structure is included in an SPS, the layer set to which the profile_tier_level( ) syntax structure applies is the layer set specified by the index 0, i.e. contains the base layer only. The profile_tier_level( ) syntax structure includes general_progressive_source_flag and general_interlaced_source_flag syntax elements. general_progressive_source_flag and general_interlaced_source_flag may be interpreted as follows:
If general_progressive_source_flag is equal to 1 and general interlaced_source_flag is equal to 0, the source scan type of the pictures in the CVS should be interpreted as progressive only.
Otherwise, if general_progressive_source_flag is equal to 0 and general_interlaced_source_flag is equal to 1, the source scan type of the pictures in the CVS should be interpreted as interlaced only.
Otherwise, if general_progressive_source_flag is equal to 0 and general_interlaced_source_flag is equal to 0, the source scan type of the pictures in the CVS should be interpreted as unknown or unspecified.
Otherwise (general_progressive_source_flag is equal to 1 and general_interlaced_source_flag is equal to 1), the source scan type of each picture in the CVS is indicated at the picture level using the syntax element source_scan_type in a picture timing SEI message.

According to HEVC, an SPS may (but needs not) contain VUI (in the vui_parameters syntax structure). VUI may include the syntax element field_seq_flag, which, when equal to 1, may indicate that the CVS conveys pictures that represent fields, and may specify that a picture timing SEI message is present in every access unit of the current CVS. field_seq_flag equal to 0 may indicate that the CVS conveys pictures that represent frames and that a picture timing SEI message may or may not be present in any access unit of the current CVS. When field_seq_flag is not present, it may be inferred to be equal to 0. The profile_tier_level( ) syntax structure may include the syntax element general_frame_only_constraint_flag, which, when equal to 1, may specify that field_seq_flag is equal to 0. general_frame_only_constraint_flag equal to 0 may indicate that field_seq_flag may or may not be equal to 0.

According to HEVC, VUI may also include the syntax element frame_field_info_present_flag, which, when equal to 1, may specify that picture timing SEI messages are present for every picture and include the pic_struct, source_scan_type, and duplicate_flag syntax elements. frame_field_info_present_flag equal to 0 may specify that the pic_struct syntax element is not present in picture timing SEI messages. When frame_field_info_present_flag is not present, its value may be inferred as follows: If general_progressive_source_flag is equal to 1 and general_interlaced_source_flag is equal to 1, frame_field_info_present_flag is inferred to be equal to 1. Otherwise, frame_field_info_present_flag is inferred to be equal to 0.

The pic_struct syntax element of the picture timing SEI message of HEVC may be summarized as follows. pic_struct indicates whether a picture should be displayed as a frame or as one or more fields and, for the display of frames when fixed_pic_rate_within_cvs_flag (which may be included in SPS VUI) is equal to 1, may indicate a frame doubling or tripling repetition period for displays that use a fixed frame refresh interval. The interpretation of pic_struct may be specified with the following table:

| Value | Indicated display of picture | Restrictions |
|---|---|---|
| 0 | (progressive) frame | field_seq_flag shall be 0 |
| 1 | top field | field_seq_flag shall be 1 |
| 2 | bottom field | field_seq_flag shall be 1 |
| 3 | top field, bottom field, in that | field_seq_flag shall be 0 |
| | order | |
| 4 | bottom field, top field, in that | field_seq_flag shall be 0 |
| | order | |
| 5 | top field, bottom field, | field_seq_flag shall be 0 |
| | top field | |
| | repeated, in that order | |
| 6 | bottom field, top field, | field_seq_flag shall be 0 |
| | bottom field | |
| | repeated, in that order | |
| 7 | frame doubling | field_seq_flag shall be 0 |
| | | fixed_pic_rate_within_cvs_flag |
| | | shall be 1 |
| 8 | frame tripling | field_seq_flag shall be 0 |
| | | fixed_pic_rate_within_cvs_flag |
| | | shall be 1 |
| 9 | top field paired with previous | field_seq_flag shall be 1 |
| | bottom field in output order | |
| 10 | bottom field paired | field_seq_flag shall be 1 |
| | with previous | |
| | top field in output order | |
| 11 | top field paired | field_seq_flag shall be 1 |
| | with next bottom | |
| | field in output order | |
| 12 | bottom field paired | field_seq_flag shall be 1 |
| | with next top | |
| | field in output order | |

The source_scan_type syntax element of the picture timing SEI message of HEVC may be summarized as follows. source_scan_type equal to 1 may indicate that the source scan type of the associated picture should be interpreted as progressive. source_scan_type equal to 0 may indicate that the source scan type of the associated picture should be interpreted as interlaced. source_scan_type equal to 2 may indicate that the source scan type of the associated picture is unknown or unspecified.

The duplicate_flag syntax element of the picture timing SEI message of HEVC may be summarized as follows. duplicate_flag equal to 1 may indicate that the current picture is indicated to be a duplicate of a previous picture in output order. duplicate_flag equal to 0 may indicate that the current picture is not indicated to be a duplicate of a previous picture in output order. The duplicate_flag may be used to mark coded pictures known to have originated from a repetition process such as 3:2 pull-down or other such duplication and picture rate interpolation methods. When field_seq_flag is equal to 1 and duplicate_flag is equal to 1, this may be interpreted as an indication that the access unit contains a duplicated field of the previous field in output order with the same parity as the current field unless a pairing is otherwise indicated by the use of a pic_struct value in the range of 9 to 12, inclusive.

Many hybrid video codecs, including H.264/AVC and HEVC, encode video information in two phases. In the first phase, predictive coding is applied for example as so-called sample prediction and/or as so-called syntax prediction. In the sample prediction pixel or sample values in a certain picture area or “block” are predicted. These pixel or sample values can be predicted, for example, using one or more of the following ways:
Motion compensation mechanisms (which may also be referred to as temporal prediction or motion-compensated temporal prediction or motion-compensated prediction or MCP), which involve finding and indicating an area in one of the previously encoded video frames that corresponds closely to the block being coded.
Inter-view prediction, which involves finding and indicating an area in one of the previously encoded view components that corresponds closely to the block being coded.
View synthesis prediction, which involves synthesizing a prediction block or image area where a prediction block is derived on the basis of reconstructed/decoded ranging information.
Inter-layer prediction using reconstructed/decoded samples, such as the so-called IntraBL (base layer) mode of SVC.
Inter-layer residual prediction, in which for example the coded residual of a reference layer or a derived residual from a difference of a reconstructed/decoded reference layer picture and a corresponding reconstructed/decoded enhancement layer picture may be used for predicting a residual block of the current enhancement layer block. A residual block may be added for example to a motion-compensated prediction block to obtain a final prediction block for the current enhancement layer block.
Intra prediction, where. pixel or sample values can be predicted by spatial mechanisms which involve finding and indicating a spatial region relationship.

In the syntax prediction, which may also be referred to as parameter prediction, syntax elements and/or syntax element values and/or variables derived from syntax elements are predicted from syntax elements (de)coded earlier and/or variables derived earlier. Non-limiting examples of syntax prediction are provided below:
In motion vector prediction, motion vectors e.g. for inter and/or inter-view prediction may be coded differentially with respect to a block-specific predicted motion vector. In many video codecs, the predicted motion vectors are created in a predefined way, for example by calculating the median of the encoded or decoded motion vectors of the adjacent blocks. Another way to create motion vector predictions, sometimes referred to as advanced motion vector prediction (AMVP), is to generate a list of candidate predictions from adjacent blocks and/or co-located blocks in temporal reference pictures and signalling the chosen candidate as the motion vector predictor. In addition to predicting the motion vector values, the reference index of a previously coded/decoded picture can be predicted. The reference index may be predicted from adjacent blocks and/or co-located blocks in temporal reference picture. Differential coding of motion vectors may be disabled across slice boundaries.
The block partitioning, e.g. from CTU to CUs and down to PUs, may be predicted.
In filter parameter prediction, the filtering parameters e.g. for sample adaptive offset may be predicted.

Prediction approaches using image information from a previously coded image can also be called as inter prediction methods which may also be referred to as temporal prediction and motion compensation. Prediction approaches using image information within the same image can also be called as intra prediction methods.

The second phase is one of coding the error between the predicted block of pixels or samples and the original block of pixels or samples. This may be accomplished by transforming the difference in pixel or sample values using a specified transform. This transform may be a Discrete Cosine Transform (DCT) or a variant thereof. After transforming the difference, the transformed difference is quantized and entropy encoded.

By varying the fidelity of the quantization process, the encoder can control the balance between the accuracy of the pixel or sample representation (i.e. the visual quality of the picture) and the size of the resulting encoded video representation (i.e. the file size or transmission bit rate).

The decoder reconstructs the output video by applying a prediction mechanism similar to that used by the encoder in order to form a predicted representation of the pixel or sample blocks (using the motion or spatial information created by the encoder and stored in the compressed representation of the image) and prediction error decoding (the inverse operation of the prediction error coding to recover the quantized prediction error signal in the spatial domain).

After applying pixel or sample prediction and error decoding processes the decoder may combine the prediction and the prediction error signals (the pixel or sample values) to form the output video frame.

The decoder (and encoder) may also apply additional filtering processes in order to improve the quality of the output video before passing it for display and/or storing as a prediction reference for the forthcoming pictures in the video sequence.

Filtering may be used to reduce various artifacts such as blocking, ringing etc. from the reference images. After motion compensation followed by adding inverse transformed residual, a reconstructed picture is obtained. This picture may have various artifacts such as blocking, ringing etc. In order to eliminate the artifacts, various post-processing operations may be applied. If the post-processed pictures are used as a reference in the motion compensation loop, then the post-processing operations/filters are usually called loop filters. By employing loop filters, the quality of the reference pictures increases. As a result, better coding efficiency can be achieved.

Filtering may comprise e.g. a deblocking filter, a Sample Adaptive Offset (SAO) filter and/or an Adaptive Loop Filter (ALF).

A deblocking filter may be used as one of the loop filters. A deblocking filter is available in both H.264/AVC and HEVC standards. An aim of the deblocking filter is to remove the blocking artifacts occurring in the boundaries of the blocks. This may be achieved by filtering along the block boundaries.

In SAO, a picture is divided into regions where a separate SAO decision is made for each region. The SAO information in a region is encapsulated in a SAO parameters adaptation unit (SAO unit) and in HEVC, the basic unit for adapting SAO parameters is CTU (therefore an SAO region is the block covered by the corresponding CTU).

In the SAO algorithm, samples in a CTU are classified according to a set of rules and each classified set of samples are enhanced by adding offset values. The offset values are signalled in the bitstream. There are two types of offsets: 1) Band offset 2) Edge offset. For a CTU, either no SAO or band offset or edge offset is employed. Choice of whether no SAO or band or edge offset to be used may be decided by the encoder with e.g. rate distortion optimization (RDO) and signaled to the decoder.

In the band offset, the whole range of sample values is in some embodiments divided into 32 equal-width bands. For example, for 8-bit samples, width of a band is 8 (=256/32). Out of 32 bands, 4 of them are selected and different offsets are signalled for each of the selected bands. The selection decision is made by the encoder and may be signalled as follows: The index of the first band is signalled and then it is inferred that the following four bands are the chosen ones. The band offset may be useful in correcting errors in smooth regions.

In the edge offset type, the edge offset (EO) type may be chosen out of four possible types (or edge classifications) where each type is associated with a direction: 1) vertical, 2) horizontal, 3) 135 degrees diagonal, and 4) 45 degrees diagonal. The choice of the direction is given by the encoder and signalled to the decoder. Each type defines the location of two neighbour samples for a given sample based on the angle. Then each sample in the CTU is classified into one of five categories based on comparison of the sample value against the values of the two neighbour samples. The five categories are described as follows:

1. Current sample value is smaller than the two neighbour samples

2. Current sample value is smaller than one of the neighbors and equal to the other neighbor

3. Current sample value is greater than one of the neighbors and equal to the other neighbor

4. Current sample value is greater than two neighbour samples

5. None of the above

These five categories are not required to be signalled to the decoder because the classification is based on only reconstructed samples, which may be available and identical in both the encoder and decoder. After each sample in an edge offset type CTU is classified as one of the five categories, an offset value for each of the first four categories is determined and signalled to the decoder. The offset for each category is added to the sample values associated with the corresponding category. Edge offsets may be effective in correcting ringing artifacts.

The SAO parameters may be signalled as interleaved in CTU data. Above CTU, slice header contains a syntax element specifying whether SAO is used in the slice. If SAO is used, then two additional syntax elements specify whether SAO is applied to Cb and Cr components. For each CTU, there are three options: 1) copying SAO parameters from the left CTU, 2) copying SAO parameters from the above CTU, or 3) signalling new SAO parameters.

While a specific implementation of SAO is described above, it should be understood that other implementations of SAO, which are similar to the above-described implementation, may also be possible. For example, rather than signaling SAO parameters as interleaved in CTU data, a picture-based signaling using a quad-tree segmentation may be used. The merging of SAO parameters (i.e. using the same parameters than in the CTU left or above) or the quad-tree structure may be determined by the encoder for example through a rate-distortion optimization process.

The adaptive loop filter (ALF) is another method to enhance quality of the reconstructed samples. This may be achieved by filtering the sample values in the loop. ALF is a finite impulse response (FIR) filter for which the filter coefficients are determined by the encoder and encoded into the bitstream. The encoder may choose filter coefficients that attempt to minimize distortion relative to the original uncompressed picture e.g. with a least-squares method or Wiener filter optimization. The filter coefficients may for example reside in an Adaptation Parameter Set or slice header or they may appear in the slice data for CUs in an interleaved manner with other CU-specific data.

In many video codecs, including H.264/AVC and HEVC, motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or pictures). H.264/AVC and HEVC, as many other video compression standards, divide a picture into a mesh of rectangles, for each of which a similar block in one of the reference pictures is indicated for inter prediction. The location of the prediction block is coded as a motion vector that indicates the position of the prediction block relative to the block being coded.

Inter prediction process may be characterized for example using one or more of the following factors.

The Accuracy of Motion Vector Representation.

For example, motion vectors may be of quarter-pixel accuracy, half-pixel accuracy or full-pixel accuracy and sample values in fractional-pixel positions may be obtained using a finite impulse response (FIR) filter.

Block Partitioning for Inter Prediction.

Many coding standards, including H.264/AVC and HEVC, allow selection of the size and shape of the block for which a motion vector is applied for motion-compensated prediction in the encoder, and indicating the selected size and shape in the bitstream so that decoders can reproduce the motion-compensated prediction done in the encoder. This block may also be referred to as a motion partition.

Number of Reference Pictures for Inter Prediction.

The sources of inter prediction are previously decoded pictures. Many coding standards, including H.264/AVC and HEVC, enable storage of multiple reference pictures for inter prediction and selection of the used reference picture on a block basis. For example, reference pictures may be selected on macroblock or macroblock partition basis in H.264/AVC and on PU or CU basis in HEVC. Many coding standards, such as H.264/AVC and HEVC, include syntax structures in the bitstream that enable decoders to create one or more reference picture lists. A reference picture index to a reference picture list may be used to indicate which one of the multiple reference pictures is used for inter prediction for a particular block. A reference picture index may be coded by an encoder into the bitstream in some inter coding modes or it may be derived (by an encoder and a decoder) for example using neighboring blocks in some other inter coding modes.

Motion Vector Prediction.

In order to represent motion vectors efficiently in bitstreams, motion vectors may be coded differentially with respect to a block-specific predicted motion vector. In many video codecs, the predicted motion vectors are created in a predefined way, for example by calculating the median of the encoded or decoded motion vectors of the adjacent blocks. Another way to create motion vector predictions, sometimes referred to as advanced motion vector prediction (AMVP), is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index may be predicted from adjacent blocks and/or co-located blocks in temporal reference picture. Differential coding of motion vectors may be disabled across slice boundaries.

Multi-Hypothesis Motion-Compensated Prediction.

H.264/AVC and HEVC enable the use of a single prediction block in P slices (herein referred to as uni-predictive slices) or a linear combination of two motion-compensated prediction blocks for bi-predictive slices, which are also referred to as B slices. Individual blocks in B slices may be bi-predicted, uni-predicted, or intra-predicted, and individual blocks in P slices may be uni-predicted or intra-predicted. The reference pictures for a bi-predictive picture may not be limited to be the subsequent picture and the previous picture in output order, but rather any reference pictures may be used. In many coding standards, such as H.264/AVC and HEVC, one reference picture list, referred to as reference picture list 0, is constructed for P slices, and two reference picture lists, list 0 and list 1, are constructed for B slices. For B slices, when prediction in forward direction may refer to prediction from a reference picture in reference picture list 0, and prediction in backward direction may refer to prediction from a reference picture in reference picture list 1, even though the reference pictures for prediction may have any decoding or output order relation to each other or to the current picture.

Weighted Prediction.

Many coding standards use a prediction weight of 1 for prediction blocks of inter (P) pictures and 0.5 for each prediction block of a B picture (resulting into averaging). H.264/AVC allows weighted prediction for both P and B slices. In implicit weighted prediction, the weights are proportional to picture order counts, while in explicit weighted prediction, prediction weights are explicitly indicated. The weights for explicit weighted prediction may be indicated for example in one or more of the following syntax structure: a slice header, a picture header, a picture parameter set, an adaptation parameter set or any similar syntax structure.

In many video codecs, the prediction residual after motion compensation is first transformed with a transform kernel (like DCT) and then coded. The reason for this is that often there still exists some correlation among the residual and transform can in many cases help reduce this correlation and provide more efficient coding.

In a draft HEVC, each PU has prediction information associated with it defining what kind of a prediction is to be applied for the pixels within that PU (e.g. motion vector information for inter predicted PUs and intra prediction directionality information for intra predicted PUs). Similarly each TU is associated with information describing the prediction error decoding process for the samples within the TU (including e.g. DCT coefficient information). It may be signalled at CU level whether prediction error coding is applied or not for each CU. In the case there is no prediction error residual associated with the CU, it can be considered there are no TUs for the CU.

In some coding formats and codecs, a distinction is made between so-called short-term and long-term reference pictures. This distinction may affect some decoding processes such as motion vector scaling in the temporal direct mode or implicit weighted prediction. If both of the reference pictures used for the temporal direct mode are short-term reference pictures, the motion vector used in the prediction may be scaled according to the picture order count (POC) difference between the current picture and each of the reference pictures. However, if at least one reference picture for the temporal direct mode is a long-term reference picture, default scaling of the motion vector may be used, for example scaling the motion to half may be used. Similarly, if a short-term reference picture is used for implicit weighted prediction, the prediction weight may be scaled according to the POC difference between the POC of the current picture and the POC of the reference picture. However, if a long-term reference picture is used for implicit weighted prediction, a default prediction weight may be used, such as 0.5 in implicit weighted prediction for bi-predicted blocks.

Some video coding formats, such as H.264/AVC, include the frame_num syntax element, which is used for various decoding processes related to multiple reference pictures. In H.264/AVC, the value of frame_num for IDR pictures is 0. The value of frame_num for non-IDR pictures is equal to the frame_num of the previous reference picture in decoding order incremented by 1 (in modulo arithmetic, i.e., the value of frame_num wrap over to 0 after a maximum value of frame_num).

H.264/AVC and HEVC include a concept of picture order count (POC). A value of POC is derived for each picture and is non-decreasing with increasing picture position in output order. POC therefore indicates the output order of pictures. POC may be used in the decoding process for example for implicit scaling of motion vectors in the temporal direct mode of bi-predictive slices, for implicitly derived weights in weighted prediction, and for reference picture list initialization. Furthermore, POC may be used in the verification of output order conformance. In H.264/AVC, POC is specified relative to the previous IDR picture or a picture containing a memory management control operation marking all pictures as “unused for reference”.

A syntax structure for decoded reference picture marking may exist in a video coding system. For example, when the decoding of the picture has been completed, the decoded reference picture marking syntax structure, if present, may be used to adaptively mark pictures as “unused for reference” or “used for long-term reference”. If the decoded reference picture marking syntax structure is not present and the number of pictures marked as “used for reference” can no longer increase, a sliding window reference picture marking may be used, which basically marks the earliest (in decoding order) decoded reference picture as unused for reference.

H.264/AVC specifies the process for decoded reference picture marking in order to control the memory consumption in the decoder. The maximum number of reference pictures used for inter prediction, referred to as M, is determined in the sequence parameter set. When a reference picture is decoded, it is marked as “used for reference”. If the decoding of the reference picture caused more than M pictures marked as “used for reference”, at least one picture is marked as “unused for reference”. There are two types of operation for decoded reference picture marking: adaptive memory control and sliding window. The operation mode for decoded reference picture marking is selected on picture basis. The adaptive memory control enables explicit signaling which pictures are marked as “unused for reference” and may also assign long-term indices to short-term reference pictures. The adaptive memory control may require the presence of memory management control operation (MMCO) parameters in the bitstream. MMCO parameters may be included in a decoded reference picture marking syntax structure. If the sliding window operation mode is in use and there are M pictures marked as “used for reference”, the short-term reference picture that was the first decoded picture among those short-term reference pictures that are marked as “used for reference” is marked as “unused for reference”. In other words, the sliding window operation mode results into first-in-first-out buffering operation among short-term reference pictures.

One of the memory management control operations in H.264/AVC causes all reference pictures except for the current picture to be marked as “unused for reference”. An instantaneous decoding refresh (IDR) picture contains only intra-coded slices and causes a similar “reset” of reference pictures.

In a draft HEVC standard, reference picture marking syntax structures and related decoding processes are not used, but instead a reference picture set (RPS) syntax structure and decoding process are used instead for a similar purpose. A reference picture set valid or active for a picture includes all the reference pictures used as a reference for the picture and all the reference pictures that are kept marked as “used for reference” for any subsequent pictures in decoding order. There are six subsets of the reference picture set, which are referred to as namely RefPicSetStCurr0 (which may also or alternatively referred to as RefPicSetStCurrBefore), RefPicSetStCur1 (which may also or alternatively referred to as RefPicSetStCurrAfter), RefPicSetStFoll0, RefPicSetStFoll1, RefPicSetLtCurr, and RefPicSetLtFoll. In some HEVC draft specifications, RefPicSetStFoll0 and RefPicSetStFoll1 are regarded as one subset, which may be referred to as RefPicSetStFoll. The notation of the six subsets is as follows. “Curr” refers to reference pictures that are included in the reference picture lists of the current picture and hence may be used as inter prediction reference for the current picture. “Foll” refers to reference pictures that are not included in the reference picture lists of the current picture but may be used in subsequent pictures in decoding order as reference pictures. “St” refers to short-term reference pictures, which may generally be identified through a certain number of least significant bits of their POC value. “Lt” refers to long-term reference pictures, which are specifically identified and generally have a greater difference of POC values relative to the current picture than what can be represented by the mentioned certain number of least significant bits. “0” refers to those reference pictures that have a smaller POC value than that of the current picture. “1” refers to those reference pictures that have a greater POC value than that of the current picture. RefPicSetStCurr0, RefPicSetStCurr1, RefPicSetStFoll0 and RefPicSetStFoll1 are collectively referred to as the short-term subset of the reference picture set. RefPicSetLtCurr and RefPicSetLtFoll are collectively referred to as the long-term subset of the reference picture set.

In a draft HEVC standard, a reference picture set may be specified in a sequence parameter set and taken into use in the slice header through an index to the reference picture set. A reference picture set may also be specified in a slice header. A long-term subset of a reference picture set is generally specified only in a slice header, while the short-term subsets of the same reference picture set may be specified in the picture parameter set or slice header. A reference picture set may be coded independently or may be predicted from another reference picture set (known as inter-RPS prediction). When a reference picture set is independently coded, the syntax structure includes up to three loops iterating over different types of reference pictures; short-term reference pictures with lower POC value than the current picture, short-term reference pictures with higher POC value than the current picture and long-term reference pictures. Each loop entry specifies a picture to be marked as “used for reference”. In general, the picture is specified with a differential POC value. The inter-RPS prediction exploits the fact that the reference picture set of the current picture can be predicted from the reference picture set of a previously decoded picture. This is because all the reference pictures of the current picture are either reference pictures of the previous picture or the previously decoded picture itself. It is only necessary to indicate which of these pictures should be reference pictures and be used for the prediction of the current picture. In both types of reference picture set coding, a flag (used_by_curr_pic_X_flag) is additionally sent for each reference picture indicating whether the reference picture is used for reference by the current picture (included in a *Curr list) or not (included in a *Foll list). The reference picture set may be decoded once per picture, and it may be decoded after decoding the first slice header but prior to decoding any coding unit and prior to constructing reference picture lists. Pictures that are included in the reference picture set used by the current slice are marked as “used for reference”, and pictures that are not in the reference picture set used by the current slice are marked as “unused for reference”. If the current picture is an IDR picture, RefPicSetStCurr0, RefPicSetStCurr1, RefPicSetStFoll0, RefPicSetStFoll1, RefPicSetLtCurr, and RefPicSetLtFoll are all set to empty.

A Decoded Picture Buffer (DPB) may be used in the encoder and/or in the decoder. There are two reasons to buffer decoded pictures, for references in inter prediction and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

In many coding modes of H.264/AVC and HEVC, the reference picture for inter prediction is indicated with an index to a reference picture list. The index may be coded with variable length coding, which usually causes a smaller index to have a shorter value for the corresponding syntax element. In H.264/AVC and HEVC, two reference picture lists (reference picture list 0 and reference picture list 1) are generated for each bi-predictive (B) slice, and one reference picture list (reference picture list 0) is formed for each inter-coded (P) slice.

A reference picture list, such as reference picture list 0 and reference picture list 1, may be constructed in two steps: First, an initial reference picture list is generated. The initial reference picture list may be generated for example on the basis of frame_num, POC, temporal_id, or information on the prediction hierarchy such as GOP structure, or any combination thereof. Second, the initial reference picture list may be reordered by reference picture list reordering (RPLR) commands, also known as reference picture list modification syntax structure, which may be contained in slice headers. The RPLR commands indicate the pictures that are ordered to the beginning of the respective reference picture list. This second step may also be referred to as the reference picture list modification process, and the RPLR commands may be included in a reference picture list modification syntax structure. If reference picture sets are used, the reference picture list 0 may be initialized to contain RefPicSetStCurr0 first, followed by RefPicSetStCurr1, followed by RefPicSetLtCurr. Reference picture list 1 may be initialized to contain RefPicSetStCurr1 first, followed by RefPicSetStCurr0. The initial reference picture lists may be modified through the reference picture list modification syntax structure, where pictures in the initial reference picture lists may be identified through an entry index to the list.

Many high efficiency video codecs such as a draft HEVC codec employ an additional motion information coding/decoding mechanism, often called merging/merge mode/process/mechanism, where all the motion information of a block/PU is predicted and used without any modification/correction. The aforementioned motion information for a PU may comprise one or more of the following: 1) The information whether ‘the PU is uni-predicted using only reference picture list0’ or ‘the PU is uni-predicted using only reference picture list1’ or ‘the PU is bi-predicted using both reference picture list0 and list1’; 2) Motion vector value corresponding to the reference picture list0, which may comprise a horizontal and vertical motion vector component; 3) Reference picture index in the reference picture list0 and/or an identifier of a reference picture pointed to by the Motion vector corresponding to reference picture list 0, where the identifier of a reference picture may be for example a picture order count value, a layer identifier value (for inter-layer prediction), or a pair of a picture order count value and a layer identifier value; 4) Information of the reference picture marking of the reference picture, e.g. information whether the reference picture was marked as “used for short-term reference” or “used for long-term reference”; 5)-7) The same as 2)-4), respectively, but for reference picture list1.

Similarly, predicting the motion information is carried out using the motion information of adjacent blocks and/or co-located blocks in temporal reference pictures. A list, often called as a merge list, may be constructed by including motion prediction candidates associated with available adjacent/co-located blocks and the index of selected motion prediction candidate in the list is signalled and the motion information of the selected candidate is copied to the motion information of the current PU. When the merge mechanism is employed for a whole CU and the prediction signal for the CU is used as the reconstruction signal, i.e. prediction residual is not processed, this type of coding/decoding the CU is typically named as skip mode or merge based skip mode. In addition to the skip mode, the merge mechanism may also be employed for individual PUs (not necessarily the whole CU as in skip mode) and in this case, prediction residual may be utilized to improve prediction quality. This type of prediction mode is typically named as an inter-merge mode.

One of the candidates in the merge list may be a TMVP candidate, which may be derived from the collocated block within an indicated or inferred reference picture, such as the reference picture indicated for example in the slice header for example using the collocated_ref_idx syntax element or alike.

In HEVC the so-called target reference index for temporal motion vector prediction in the merge list is set as 0 when the motion coding mode is the merge mode. When the motion coding mode in HEVC utilizing the temporal motion vector prediction is the advanced motion vector prediction mode, the target reference index values are explicitly indicated (e.g. per each PU).

When the target reference index value has been determined, the motion vector value of the temporal motion vector prediction may be derived as follows: Motion vector at the block that is co-located with the bottom-right neighbor of the current prediction unit is calculated. The picture where the co-located block resides may be e.g. determined according to the signalled reference index in the slice header as described above. The determined motion vector at the co-located block is scaled with respect to the ratio of a first picture order count difference and a second picture order count difference. The first picture order count difference is derived between the picture containing the co-located block and the reference picture of the motion vector of the co-located block. The second picture order count difference is derived between the current picture and the target reference picture. If one but not both of the target reference picture and the reference picture of the motion vector of the co-located block is a long-term reference picture (while the other is a short-term reference picture), the TMVP candidate may be considered unavailable. If both of the target reference picture and the reference picture of the motion vector of the co-located block are long-term reference pictures, no POC-based motion vector scaling may be applied.

Motion parameter types or motion information may include but are not limited to one or more of the following types:
an indication of a prediction type (e.g. intra prediction, uni-prediction, bi-prediction) and/or a number of reference pictures;
an indication of a prediction direction, such as inter (a.k.a. temporal) prediction, inter-layer prediction, inter-view prediction, view synthesis prediction (VSP), and inter-component prediction (which may be indicated per reference picture and/or per prediction type and where in some embodiments inter-view and view-synthesis prediction may be jointly considered as one prediction direction) and/or
an indication of a reference picture type, such as a short-term reference picture and/or a long-term reference picture and/or an inter-layer reference picture (which may be indicated e.g. per reference picture)
a reference index to a reference picture list and/or any other identifier of a reference picture (which may be indicated e.g. per reference picture and the type of which may depend on the prediction direction and/or the reference picture type and which may be accompanied by other relevant pieces of information, such as the reference picture list or alike to which reference index applies);
a horizontal motion vector component (which may be indicated e.g. per prediction block or per reference index or alike);
a vertical motion vector component (which may be indicated e.g. per prediction block or per reference index or alike);
one or more parameters, such as picture order count difference and/or a relative camera separation between the picture containing or associated with the motion parameters and its reference picture, which may be used for scaling of the horizontal motion vector component and/or the vertical motion vector component in one or more motion vector prediction processes (where said one or more parameters may be indicated e.g. per each reference picture or each reference index or alike);
coordinates of a block to which the motion parameters and/or motion information applies, e.g. coordinates of the top-left sample of the block in luma sample units;
extents (e.g. a width and a height) of a block to which the motion parameters and/or motion information applies.

A motion field associated with a picture may be considered to comprise of a set of motion information produced for every coded block of the picture. A motion field may be accessible by coordinates of a block, for example. A motion field may be used for example in TMVP or any other motion prediction mechanism where a source or a reference for prediction other than the current (de)coded picture is used.

Different spatial granularity or units may be applied to represent and/or store a motion field. For example, a regular grid of spatial units may be used. For example, a picture may be divided into rectangular blocks of certain size (with the possible exception of blocks at the edges of the picture, such as on the right edge and the bottom edge). For example, the size of the spatial unit may be equal to the smallest size for which a distinct motion can be indicated by the encoder in the bitstream, such as a 4×4 block in luma sample units. For example, a so-called compressed motion field may be used, where the spatial unit may be equal to a pre-defined or indicated size, such as a 16×16 block in luma sample units, which size may be greater than the smallest size for indicating distinct motion. For example, an HEVC encoder and/or decoder may be implemented in a manner that a motion data storage reduction (MDSR) is performed for each decoded motion field (prior to using the motion field for any prediction between pictures). In an HEVC implementation, MDSR may reduce the granularity of motion data to 16×16 blocks in luma sample units by keeping the motion applicable to the top-left sample of the 16×16 block in the compressed motion field. The encoder may encode indication(s) related to the spatial unit of the compressed motion field as one or more syntax elements and/or syntax element values for example in a sequence-level syntax structure, such as a video parameter set or a sequence parameter set. In some (de)coding methods and/or devices, a motion field may be represented and/or stored according to the block partitioning of the motion prediction (e.g. according to prediction units of the HEVC standard). In some (de)coding methods and/or devices, a combination of a regular grid and block partitioning may be applied so that motion associated with partitions greater than a pre-defined or indicated spatial unit size is represented and/or stored associated with those partitions, whereas motion associated with partitions smaller than or unaligned with a pre-defined or indicated spatial unit size or grid is represented and/or stored for the pre-defined or indicated units.

Scalable video coding may refer to a coding structure where one bitstream can contain multiple representations of the content at different bitrates, resolutions and/or frame rates. In these cases the receiver can extract the desired representation depending on its characteristics (e.g. resolution that matches best with the resolution of the display of the device). Alternatively, a server or a network element can extract the portions of the bitstream to be transmitted to the receiver depending on e.g. the network characteristics or processing capabilities of the receiver.

A scalable bitstream may consist of a base layer providing the lowest quality video available and one or more enhancement layers that enhance the video quality when received and decoded together with the lower layers. An enhancement layer may enhance for example the temporal resolution (i.e., the frame rate), the spatial resolution, or simply the quality of the video content represented by another layer or part thereof. In order to improve coding efficiency for the enhancement layers, the coded representation of that layer may depend on the lower layers. For example, the motion and mode information of the enhancement layer can be predicted from lower layers. Similarly the pixel data of the lower layers can be used to create prediction for the enhancement layer(s).

Scalability modes or scalability dimensions may include but are not limited to the following:
Quality scalability: Base layer pictures are coded at a lower quality than enhancement layer pictures, which may be achieved for example using a greater quantization parameter value (i.e., a greater quantization step size for transform coefficient quantization) in the base layer than in the enhancement layer. Quality scalability may be further categorized into fine-grain or fine-granularity scalability (FGS), medium-grain or medium-granularity scalability (MGS), and/or coarse-grain or coarse-granularity scalability (CGS), as described below.
Spatial scalability: Base layer pictures are coded at a lower resolution (i.e. have fewer samples) than enhancement layer pictures. Spatial scalability and quality scalability, particularly its coarse-grain scalability type, may sometimes be considered the same type of scalability.
Bit-depth scalability: Base layer pictures are coded at lower bit-depth (e.g. 8 bits) than enhancement layer pictures (e.g. 10 or 12 bits).
Chroma format scalability: Base layer pictures provide lower spatial resolution in chroma sample arrays (e.g. coded in 4:2:0 chroma format) than enhancement layer pictures (e.g. 4:4:4 format).
Color gamut scalability: enhancement layer pictures have a richer/broader color representation range than that of the base layer pictures—for example the enhancement layer may have UHDTV (ITU-R BT.2020) color gamut and the base layer may have the ITU-R BT.709 color gamut.
View scalability, which may also be referred to as multiview coding. The base layer represents a first view, whereas an enhancement layer represents a second view.
Depth scalability, which may also be referred to as depth-enhanced coding. A layer or some layers of a bitstream may represent texture view(s), while other layer or layers may represent depth view(s).
Region-of-interest scalability (as described below).
Interlaced-to-progressive scalability (as described subsequently).
Hybrid codec scalability: Base layer pictures are coded according to a different coding standard or format than enhancement layer pictures. For example, the base layer may be coded with H.264/AVC and an enhancement layer may be coded with an HEVC extension.

It should be understood that many of the scalability types may be combined and applied together. For example color gamut scalability and bit-depth scalability may be combined.

In all of the above scalability cases, base layer information may be used to code enhancement layer to minimize the additional bitrate overhead.

The term layer may be used in context of any type of scalability, including view scalability and depth enhancements. An enhancement layer may refer to any type of an enhancement, such as SNR, spatial, multiview, depth, bit-depth, chroma format, and/or color gamut enhancement. A base layer may refer to any type of a base video sequence, such as a base view, a base layer for SNR/spatial scalability, or a texture base view for depth-enhanced video coding.

Region of Interest (ROI) coding may be defined to refer to coding a particular region within a video at a higher fidelity. There exists several methods for encoders and/or other entities to determine ROIs from input pictures to be encoded. For example, face detection may be used and faces may be determined to be ROIs. Additionally or alternatively, in another example, objects that are in focus may be detected and determined to be ROIs, while objects out of focus are determined to be outside ROIs. Additionally or alternatively, in another example, the distance to objects may be estimated or known, e.g. on the basis of a depth sensor, and ROIs may be determined to be those objects that are relatively close to the camera rather than in the background.

ROI scalability may be defined as a type of scalability wherein an enhancement layer enhances only part of a reference-layer picture e.g. spatially, quality-wise, in bit-depth, and/or along other scalability dimensions. As ROI scalability may be used together with other types of scalabilities, it may be considered to form a different categorization of scalability types. There exists several different applications for ROI coding with different requirements, which may be realized by using ROI scalability. For example, an enhancement layer can be transmitted to enhance the quality and/or a resolution of a region in the base layer. A decoder receiving both enhancement and base layer bitstream might decode both layers and overlay the decoded pictures on top of each other and display the final picture.

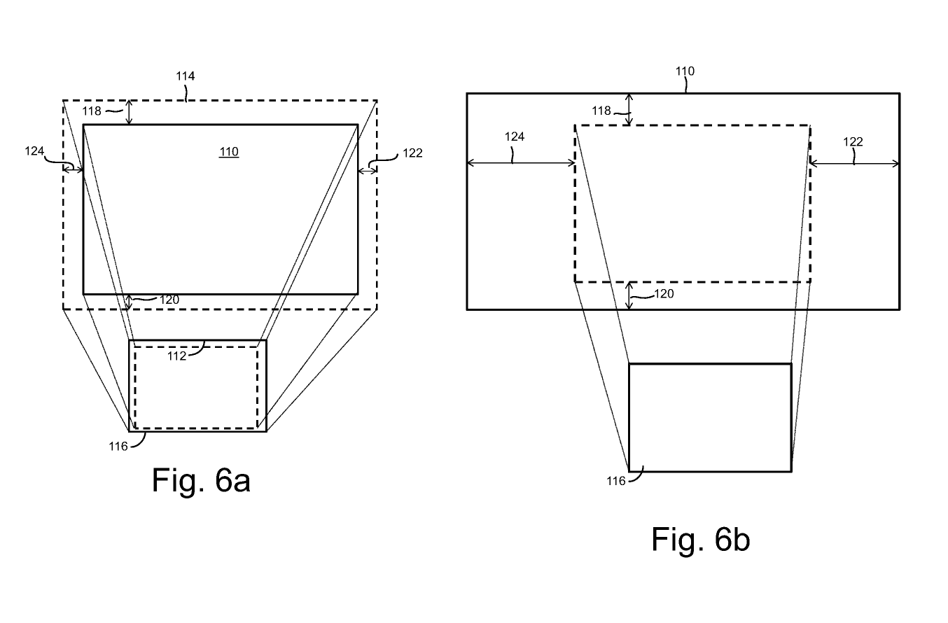

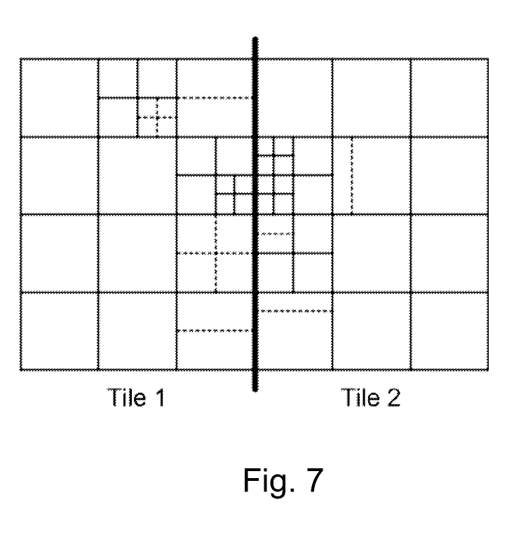

The spatial correspondence between the enhancement layer picture and the reference layer region, or similarly the enhancement layer region and the base layer picture may be indicated by the encoder and/or decoded by the decoder using for example so-called scaled reference layer offsets. Scaled reference layer offsets may be considered to specify the positions of the corner samples of the upsampled reference layer picture relative to the respective corner samples of the enhancement layer picture. The offset values may be signed, which enables the use of the offset values to be used in both types of extended spatial scalability, as illustrated in FIG. 6a and FIG. 6b. In case of region-of-interest scalability (FIG. 6a), the enhancement layer picture 110 corresponds to a region 112 of the reference layer picture 116 and the scaled reference layer offsets indicate the corners of the upsampled reference layer picture that extend the area of the enhance layer picture. Scaled reference layer offsets may be indicated by four syntax elements (e.g. per a pair of an enhancement layer and its reference layer), which may be referred to as scaled_ref_layer_top_offset 118, scaled_ref_layer_bottom_offset 120, scaled_ref_layer_right_offset 122 and scaled_ref_layer_left_offset 124. The reference layer region that is upsampled may be concluded by the encoder and/or the decoder by downscaling the scaled reference layer offsets according to the ratio between the enhancement layer picture height or width and the upsampled reference layer picture height or width, respectively. The downscaled scaled reference layer offset may be then be used to obtain the reference layer region that is upsampled and/or to determine which samples of the reference layer picture collocate to certain samples of the enhancement layer picture. In case the reference layer picture corresponds to a region of the enhancement layer picture (FIG. 6b), the scaled reference layer offsets indicate the corners of the upsampled reference layer picture that are within the area of the enhance layer picture. The scaled reference layer offset may be used to determine which samples of the upsampled reference layer picture collocate to certain samples of the enhancement layer picture. It is also possible to mix the types of extended spatial scalability, i.e apply one type horizontally and another type vertically. Scaled reference layer offsets may be indicated by the encoder in and/or decoded by the decoder from for example a sequence-level syntax structure, such as SPS and/or VPS. The accuracy of scaled reference offsets may be pre-defined for example in a coding standard and/or specified by the encoder and/or decoded by the decoder from the bitstream. For example, an accuracy of 1/16th of the luma sample size in the enhancement layer may be used. Scaled reference layer offsets may be indicated, decoded, and/or used in the encoding, decoding and/or displaying process when no inter-layer prediction takes place between two layers.

Each scalable layer together with all its dependent layers is one representation of the video signal at a certain spatial resolution, temporal resolution, quality level and/or any other scalability dimension. In this document, we refer to a scalable layer together with all of its dependent layers as a “scalable layer representation”. The portion of a scalable bitstream corresponding to a scalable layer representation can be extracted and decoded to produce a representation of the original signal at certain fidelity.

Scalability may be enabled in two basic ways. Either by introducing new coding modes for performing prediction of pixel values or syntax from lower layers of the scalable representation or by placing the lower layer pictures to a reference picture buffer (e.g. a decoded picture buffer, DPB) of the higher layer. The first approach may be more flexible and thus may provide better coding efficiency in most cases. However, the second, reference frame based scalability, approach may be implemented efficiently with minimal changes to single layer codecs while still achieving majority of the coding efficiency gains available. Essentially a reference frame based scalability codec may be implemented by utilizing the same hardware or software implementation for all the layers, just taking care of the DPB management by external means.

A scalable video encoder for quality scalability (also known as Signal-to-Noise or SNR) and/or spatial scalability may be implemented as follows. For a base layer, a conventional non-scalable video encoder and decoder may be used. The reconstructed/decoded pictures of the base layer are included in the reference picture buffer and/or reference picture lists for an enhancement layer. In case of spatial scalability, the reconstructed/decoded base-layer picture may be upsampled prior to its insertion into the reference picture lists for an enhancement-layer picture. The base layer decoded pictures may be inserted into a reference picture list(s) for coding/decoding of an enhancement layer picture similarly to the decoded reference pictures of the enhancement layer. Consequently, the encoder may choose a base-layer reference picture as an inter prediction reference and indicate its use with a reference picture index in the coded bitstream. The decoder decodes from the bitstream, for example from a reference picture index, that a base-layer picture is used as an inter prediction reference for the enhancement layer. When a decoded base-layer picture is used as the prediction reference for an enhancement layer, it is referred to as an inter-layer reference picture.

While the previous paragraph described a scalable video codec with two scalability layers with an enhancement layer and a base layer, it needs to be understood that the description can be generalized to any two layers in a scalability hierarchy with more than two layers. In this case, a second enhancement layer may depend on a first enhancement layer in encoding and/or decoding processes, and the first enhancement layer may therefore be regarded as the base layer for the encoding and/or decoding of the second enhancement layer. Furthermore, it needs to be understood that there may be inter-layer reference pictures from more than one layer in a reference picture buffer or reference picture lists of an enhancement layer, and each of these inter-layer reference pictures may be considered to reside in a base layer or a reference layer for the enhancement layer being encoded and/or decoded.

A scalable video coding and/or decoding scheme may use multi-loop coding and/or decoding, which may be characterized as follows. In the encoding/decoding, a base layer picture may be reconstructed/decoded to be used as a motion-compensation reference picture for subsequent pictures, in coding/decoding order, within the same layer or as a reference for inter-layer (or inter-view or inter-component) prediction. The reconstructed/decoded base layer picture may be stored in the DPB. An enhancement layer picture may likewise be reconstructed/decoded to be used as a motion-compensation reference picture for subsequent pictures, in coding/decoding order, within the same layer or as reference for inter-layer (or inter-view or inter-component) prediction for higher enhancement layers, if any. In addition to reconstructed/decoded sample values, syntax element values of the base/reference layer or variables derived from the syntax element values of the base/reference layer may be used in the inter-layer/inter-component/inter-view prediction.

In some cases, data in an enhancement layer can be truncated after a certain location, or even at arbitrary positions, where each truncation position may include additional data representing increasingly enhanced visual quality. Such scalability is referred to as fine-grained (granularity) scalability (FGS). FGS was included in some draft versions of the SVC standard, but it was eventually excluded from the final SVC standard. FGS is subsequently discussed in the context of some draft versions of the SVC standard. The scalability provided by those enhancement layers that cannot be truncated is referred to as coarse-grained (granularity) scalability (CGS). It collectively includes the traditional quality (SNR) scalability and spatial scalability. The SVC standard supports the so-called medium-grained scalability (MGS), where quality enhancement pictures are coded similarly to SNR scalable layer pictures but indicated by high-level syntax elements similarly to FGS layer pictures, by having the quality_id syntax element greater than 0.

SVC uses an inter-layer prediction mechanism, wherein certain information can be predicted from layers other than the currently reconstructed layer or the next lower layer. Information that could be inter-layer predicted includes intra texture, motion and residual data. Inter-layer motion prediction includes the prediction of block coding mode, header information, etc., wherein motion from the lower layer may be used for prediction of the higher layer. In case of intra coding, a prediction from surrounding macroblocks or from co-located macroblocks of lower layers is possible. These prediction techniques do not employ information from earlier coded access units and hence, are referred to as intra prediction techniques. Furthermore, residual data from lower layers can also be employed for prediction of the current layer, which may be referred to as inter-layer residual prediction.

Scalable video (de)coding may be realized with a concept known as single-loop decoding, where decoded reference pictures are reconstructed only for the highest layer being decoded while pictures at lower layers may not be fully decoded or may be discarded after using them for inter-layer prediction. In single-loop decoding, the decoder performs motion compensation and full picture reconstruction only for the scalable layer desired for playback (called the “desired layer” or the “target layer”), thereby reducing decoding complexity when compared to multi-loop decoding. All of the layers other than the desired layer do not need to be fully decoded because all or part of the coded picture data is not needed for reconstruction of the desired layer. However, lower layers (than the target layer) may be used for inter-layer syntax or parameter prediction, such as inter-layer motion prediction. Additionally or alternatively, lower layers may be used for inter-layer intra prediction and hence intra-coded blocks of lower layers may have to be decoded. Additionally or alternatively, inter-layer residual prediction may be applied, where the residual information of the lower layers may be used for decoding of the target layer and the residual information may need to be decoded or reconstructed. In some coding arrangements, a single decoding loop is needed for decoding of most pictures, while a second decoding loop may be selectively applied to reconstruct so-called base representations (i.e. decoded base layer pictures), which may be needed as prediction references but not for output or display.

SVC allows the use of single-loop decoding. It is enabled by using a constrained intra texture prediction mode, whereby the inter-layer intra texture prediction can be applied to macroblocks (MBs) for which the corresponding block of the base layer is located inside intra-MBs. At the same time, those intra-MBs in the base layer use constrained intra-prediction (e.g., having the syntax element “constrained_intra_pred_flag” equal to 1). In single-loop decoding, the decoder performs motion compensation and full picture reconstruction only for the scalable layer desired for playback (called the “desired layer” or the “target layer”), thereby greatly reducing decoding complexity. All of the layers other than the desired layer do not need to be fully decoded because all or part of the data of the MBs not used for inter-layer prediction (be it inter-layer intra texture prediction, inter-layer motion prediction or inter-layer residual prediction) is not needed for reconstruction of the desired layer. A single decoding loop is needed for decoding of most pictures, while a second decoding loop is selectively applied to reconstruct the base representations, which are needed as prediction references but not for output or display, and are reconstructed only for the so called key pictures (for which “store_ref base_pic_flag” is equal to 1).

The scalability structure in the SVC draft is characterized by three syntax elements: “temporal_id,” “dependency_id” and “quality_id.” The syntax element “temporal_id” is used to indicate the temporal scalability hierarchy or, indirectly, the frame rate. A scalable layer representation comprising pictures of a smaller maximum “temporal_id” value has a smaller frame rate than a scalable layer representation comprising pictures of a greater maximum “temporal_id”. A given temporal layer typically depends on the lower temporal layers (i.e., the temporal layers with smaller “temporal_id” values) but does not depend on any higher temporal layer. The syntax element “dependency_id” is used to indicate the CGS inter-layer coding dependency hierarchy (which, as mentioned earlier, includes both SNR and spatial scalability). At any temporal level location, a picture of a smaller “dependency_id” value may be used for inter-layer prediction for coding of a picture with a greater “dependency_id” value. The syntax element “quality_id” is used to indicate the quality level hierarchy of a FGS or MGS layer. At any temporal location, and with an identical “dependency_id” value, a picture with “quality_id” equal to QL uses the picture with “quality_id” equal to QL-1 for inter-layer prediction. A coded slice with “quality_id” larger than 0 may be coded as either a truncatable FGS slice or a non-truncatable MGS slice.

For simplicity, all the data units (e.g., Network Abstraction Layer units or NAL units in the SVC context) in one access unit having identical value of “dependency_id” are referred to as a dependency unit or a dependency representation. Within one dependency unit, all the data units having identical value of “quality_id” are referred to as a quality unit or layer representation.

A base representation, also known as a decoded base picture, is a decoded picture resulting from decoding the Video Coding Layer (VCL) NAL units of a dependency unit having “quality_id” equal to 0 and for which the “store_ref_base_pic_flag” is set equal to 1. An enhancement representation, also referred to as a decoded picture, results from the regular decoding process in which all the layer representations that are present for the highest dependency representation are decoded.

As mentioned earlier, CGS includes both spatial scalability and SNR scalability. Spatial scalability is initially designed to support representations of video with different resolutions. For each time instance, VCL NAL units are coded in the same access unit and these VCL NAL units can correspond to different resolutions. During the decoding, a low resolution VCL NAL unit provides the motion field and residual which can be optionally inherited by the final decoding and reconstruction of the high resolution picture. When compared to older video compression standards, SVC's spatial scalability has been generalized to enable the base layer to be a cropped and zoomed version of the enhancement layer.

MGS quality layers are indicated with “quality_id” similarly as FGS quality layers. For each dependency unit (with the same “dependency_id”), there is a layer with “quality_id” equal to 0 and there can be other layers with “quality_id” greater than 0. These layers with “quality_id” greater than 0 are either MGS layers or FGS layers, depending on whether the slices are coded as truncatable slices.

In the basic form of FGS enhancement layers, only inter-layer prediction is used. Therefore, FGS enhancement layers can be truncated freely without causing any error propagation in the decoded sequence. However, the basic form of FGS suffers from low compression efficiency. This issue arises because only low-quality pictures are used for inter prediction references. It has therefore been proposed that FGS-enhanced pictures be used as inter prediction references. However, this may cause encoding-decoding mismatch, also referred to as drift, when some FGS data are discarded.

One feature of a draft SVC standard is that the FGS NAL units can be freely dropped or truncated, and a feature of the SVCV standard is that MGS NAL units can be freely dropped (but cannot be truncated) without affecting the conformance of the bitstream. As discussed above, when those FGS or MGS data have been used for inter prediction reference during encoding, dropping or truncation of the data would result in a mismatch between the decoded pictures in the decoder side and in the encoder side. This mismatch is also referred to as drift.

To control drift due to the dropping or truncation of FGS or MGS data, SVC applied the following solution: In a certain dependency unit, a base representation (by decoding only the CGS picture with “quality_id” equal to 0 and all the dependent-on lower layer data) is stored in the decoded picture buffer. When encoding a subsequent dependency unit with the same value of “dependency_id,” all of the NAL units, including FGS or MGS NAL units, use the base representation for inter prediction reference. Consequently, all drift due to dropping or truncation of FGS or MGS NAL units in an earlier access unit is stopped at this access unit. For other dependency units with the same value of “dependency_id,” all of the NAL units use the decoded pictures for inter prediction reference, for high coding efficiency.

Each NAL unit includes in the NAL unit header a syntax element “use_ref_base_pic_flag.” When the value of this element is equal to 1, decoding of the NAL unit uses the base representations of the reference pictures during the inter prediction process. The syntax element “store_ref_base_pic_flag” specifies whether (when equal to 1) or not (when equal to 0) to store the base representation of the current picture for future pictures to use for inter prediction.

NAL units with “quality_id” greater than 0 do not contain syntax elements related to reference picture lists construction and weighted prediction, i.e., the syntax elements “num_ref_active_{—}1x_minus1” (x=0 or 1), the reference picture list reordering syntax table, and the weighted prediction syntax table are not present. Consequently, the MGS or FGS layers have to inherit these syntax elements from the NAL units with “quality_id” equal to 0 of the same dependency unit when needed.

In SVC, a reference picture list consists of either only base representations (when “use_ref_base_pic_flag” is equal to 1) or only decoded pictures not marked as “base representation” (when “use_ref_base_pic_flag” is equal to 0), but never both at the same time.

Several nesting SEI messages have been specified in the AVC and HEVC standards or proposed otherwise. The idea of nesting SEI messages is to contain one or more SEI messages within a nesting SEI message and provide a mechanism for associating the contained SEI messages with a subset of the bitstream and/or a subset of decoded data. It may be required that a nesting SEI message contains one or more SEI messages that are not nesting SEI messages themselves. An SEI message contained in a nesting SEI message may be referred to as a nested SEI message. An SEI message not contained in a nesting SEI message may be referred to as a non-nested SEI message. The scalable nesting SEI message of HEVC enables to identify either a bitstream subset (resulting from a sub-bitstream extraction process) or a set of layers to which the nested SEI messages apply. A bitstream subset may also be referred to as a sub-bitstream.

A scalable nesting SEI message has been specified in SVC. The scalable nesting SEI message provides a mechanism for associating SEI messages with subsets of a bitstream, such as indicated dependency representations or other scalable layers. A scalable nesting SEI message contains one or more SEI messages that are not scalable nesting SEI messages themselves. An SEI message contained in a scalable nesting SEI message is referred to as a nested SEI message. An SEI message not contained in a scalable nesting SEI message is referred to as a non-nested SEI message.

Work is ongoing to specify scalable and multiview extensions to the HEVC standard. The multiview extension of HEVC, referred to as MV-HEVC, is similar to the MVC extension of H.264/AVC. Similarly to MVC, in MV-HEVC, inter-view reference pictures can be included in the reference picture list(s) of the current picture being coded or decoded. The scalable extension of HEVC, referred to as SHVC, is planned to be specified so that it uses multi-loop decoding operation (unlike the SVC extension of H.264/AVC). SHVC is reference index based, i.e. an inter-layer reference picture can be included in a one or more reference picture lists of the current picture being coded or decoded (as described above).

It is possible to use many of the same syntax structures, semantics, and decoding processes for MV-HEVC and SHVC. Other types of scalability, such as depth-enhanced video, may also be realized with the same or similar. syntax structures, semantics, and decoding processes as in MV-HEVC and SHVC.

For the enhancement layer coding, the same concepts and coding tools of HEVC may be used in SHVC, MV-HEVC, and/or alike. However, the additional inter-layer prediction tools, which employ already coded data (including reconstructed picture samples and motion parameters a.k.a motion information) in reference layer for efficiently coding an enhancement layer, may be integrated to SHVC, MV-HEVC, and/or alike codec.

In MV-HEVC, SHVC and/or alike, VPS may for example include a mapping of the LayerId value derived from the NAL unit header to one or more scalability dimension values, for example correspond to dependency_id, quality_id, view_id, and depth_flag for the layer defined similarly to SVC and MVC.

In MV-HEVC/SHVC, it may be indicated in the VPS that a layer with layer identifier value greater than 0 has no direct reference layers, i.e. that the layer is not inter-layer predicted from any other layer. In other words, an MV-HEVC/SHVC bitstream may contain layers that are independent of each other, which may be referred to as simulcast layers.

A part of VPS, which specifies the scalability dimensions that may be present in the bitstream, the mapping of nuh_layer_id values to scalability dimension values, and the dependencies between layers may be specified with the following syntax:

Descriptor

vps_extension( ) {

| | |
|---|---|
| splitting_flag | u(1) |
| for( i = 0, NumScalabilityTypes = 0; i < 16; i++ ) { | |

| | |
|---|---|
| scalability_mask_flag[ i ] | u(1) |
| NumScalabilityTypes += scalability_mask_flag[ i ] | |

}
for( j = 0; j < ( NumScalabilityTypes − splitting_flag );
j++ )

| | |
|---|---|
| dimension_id_len_minus1[ j ] | u(3) |

| | |
|---|---|
| vps_nuh_layer_id_present_flag | u(1) |
| for( i = 1; i <= MaxLayersMinus1; i++ ) { | |

if( vps_nuh_layer_id_present_flag )

| | |
|---|---|
| layer_id_in_nuh[ i ] | u(6) |

if( !splitting_flag )

for( j = 0; j < NumScalabilityTypes; j++ )

| | |
|---|---|
| dimension_id[ i ][ j ] | u(v) |

| | |
|---|---|
| } | |
| view_id_len | u(4) |
| if( view_id_len > 0 ) | |

for( i = 0; i < NumViews; i++ )

| | |
|---|---|
| view_id_val[ i ] | u(v) |

for( i = 1; i <= MaxLayersMinus1; i++ )

for( j = 0; j < i; j++ )

| | |
|---|---|
| direct_dependency_flag[ i ][ j ] | u(1) |

...

The semantics of the above-shown part of the VPS may be specified as described in the following paragraphs.

splitting_flag equal to 1 indicates that the dimension_id[i][j] syntax elements are not present and that the binary representation of the nuh_layer_id value in the NAL unit header are split into NumScalabilityTypes segments with lengths, in bits, according to the values of dimension_id_len_minus1[j] and that the values of dimension_id[LayerIdxInVps[nuh_layer_id]][j] are inferred from the NumScalabilityTypes segments. splitting_flag equal to 0 indicates that the syntax elements dimension_id[i][j] are present. In the following example semantics, without loss of generality, it is assumed that splitting_flag is equal to 0.

scalability_mask_flag[i] equal to 1 indicates that dimension_id syntax elements corresponding to the i-th scalability dimension in the following table are present. scalability_mask_flag[i] equal to 0 indicates that dimension_id syntax elements corresponding to the i-th scalability dimension are not present.

| scalability mask | Scalability | ScalabilityId |
|---|---|---|
| index | dimension | mapping |
| 0 | Reserved | |
| 1 | Multiview | View Order Index |
| 2 | Spatial/quality | DependencyId |
| | scalability | |
| 3 | Auxiliary | AuxId |
| 4-15 | Reserved | |

In future 3D extensions of HEVC, scalability mask index 0 may be used to indicate depth maps.

dimension_id_len_minus1[j] plus1 specifies the length, in bits, of the dimension_id[i][j] syntax element.

vps_nuh_layer_id_present_flag equal to 1 specifies that layer_id_in_nuh[i] for i from 0 to MaxLayersMinus1 (which is equal to the maximum number of layers in the bitstream minus 1), inclusive, are present. vps_nuh_layer_id_present_flag equal to 0 specifies that layer_id_in_nuh[i] for i from 0 to MaxLayersMinus1, inclusive, are not present.

layer_id_in_nuh[i] specifies the value of the nuh_layer_id syntax element in VCL NAL units of the i-th layer. For i in the range of 0 to MaxLayersMinus1, inclusive, when layer_id_in_nuh[i] is not present, the value is inferred to be equal to i. When i is greater than 0, layer_id_in_nuh[i] is greater than layer_id_in_nuh[i−1]. For i from 0 to MaxLayersMinus1, inclusive, the variable LayerIdxInVps[layer_id_in_nuh[i]] is set equal to i.

dimension_id[i][j] specifies the identifier of the j-th present scalability dimension type of the i-th layer. The number of bits used for the representation of dimension_id[i][j] is dimension_id_len_minus 1 [j]+1 bits. When splitting_flag is equal to 0, for j from 0 to NumScalabilityTypes-1, inclusive, dimension_id[0][j] is inferred to be equal to 0

The variable ScalabilityId[i][smIdx] specifying the identifier of the smIdx-th scalability dimension type of the i-th layer, the variable ViewOrderIdx[layer_id_in_nuh[i]] specifying the view order index of the i-th layer, DependencyId[layer_id_in_nuh[i]] specifying the spatial/quality scalability identifier of the i-th layer, and the variable ViewScalExtLayerFlag[layer_id_in_nuh[i]] specifying whether the i-th layer is a view scalability extension layer are derived as follows:

```
NumViews = 1
for( i = 0; i <= MaxLayersMinus1; i++ ) {
  IId = layer_id_in_nuh[ i ]
  for( smIdx= 0, j = 0; smIdx < 16; smIdx++ )
    if( scalability_mask_flag[ smIdx ] )
      ScalabilityId[ i ][ smIdx ] = dimension_id[ i ][ j++ ]
  ViewOrderIdx[ IId ] = ScalabilityId[ i ][ 1 ]
  DependencyId[ IId ] = ScalabilityId[ i ][ 2 ]
  if( i > 0 && (ViewOrderIdx[ IId ] != ScalabilityId[ i − 1][ 1 ] ) )
    NumViews++
  ViewScalExtLayerFlag[ IId ] = ( ViewOrderIdx[ IId ] > 0 )
  AuxId[ IId ] = ScalabilityId[ i ][ 3 ]
}
```

Enhancement layers or layers with a layer identifier value greater than 0 may be indicated to contain auxiliary video complementing the base layer or other layers. For example, in the present draft of MV-HEVC, auxiliary pictures may be encoded in a bitstream using auxiliary picture layers. An auxiliary picture layer is associated with its own scalability dimension value, AuxId (similarly to e.g. view order index). Layers with AuxId greater than 0 contain auxiliary pictures. A layer carries only one type of auxiliary pictures, and the type of auxiliary pictures included in a layer may be indicated by its AuxId value. In other words, AuxId values may be mapped to types of auxiliary pictures. For example, AuxId equal to 1 may indicate alpha planes and AuxId equal to 2 may indicate depth pictures. An auxiliary picture may be defined as a picture that has no normative effect on the decoding process of primary pictures. In other words, primary pictures (with AuxId equal to 0) may be constrained not to predict from auxiliary pictures. An auxiliary picture may predict from a primary picture, although there may be constraints disallowing such prediction, for example based on the AuxId value. SEI messages may be used to convey more detailed characteristics of auxiliary picture layers, such as the depth range represented by a depth auxiliary layer. The present draft of MV-HEVC includes support of depth auxiliary layers.

Different types of auxiliary pictures may be used including but not limited to the following: Depth pictures; Alpha pictures; Overlay pictures; and Label pictures. In Depth pictures a sample value represents disparity between the viewpoint (or camera position) of the depth picture or depth or distance. In Alpha pictures (a.k.a. alpha planes and alpha matte pictures) a sample value represents transparency or opacity. Alpha pictures may indicate for each pixel a degree of transparency or equivalently a degree of opacity. Alpha pictures may be monochrome pictures or the chroma components of alpha pictures may be set to indicate no chromaticity (e.g. 0 when chroma samples values are considered to be signed or 128 when chroma samples values are 8-bit and considered to be unsigned). Overlay pictures may be overlaid on top of the primary pictures in displaying. Overlay pictures may contain several regions and background, where all or a subset of regions may be overlaid in displaying and the background is not overlaid. Label pictures contain different labels for different overlay regions, which can be used to identify single overlay regions.

Continuing how the semantics of the presented VPS excerpt may be specified: view_id_len specifies the length, in bits, of the view_id_val[i] syntax element. view_id_val[i] specifies the view identifier of the i-th view specified by the VPS. The length of the view_id_val[i] syntax element is view_id_len bits. When not present, the value of view_id_val[i] is inferred to be equal to 0. For each layer with nuh_layer_id equal to nuhLayerId, the value ViewId[nuhLayerId] is set equal to view_id_val[ViewOrderIdx[nuhLayerId]]. direct_dependency_flag[i][j] equal to 0 specifies that the layer with index j is not a direct reference layer for the layer with index i. direct_dependency_flag[i][j] equal to 1 specifies that the layer with index j may be a direct reference layer for the layer with index i. When direct_dependency_flag[i][j] is not present for i and j in the range of 0 to MaxLayersMinus1, it is inferred to be equal to 0.

Enhancement layers or layers with a layer identifier value greater than 0 may be indicated to contain auxiliary video complementing the base layer or other layers. For example, in the present draft of MV-HEVC, auxiliary pictures may be encoded in a bitstream using auxiliary picture layers. An auxiliary picture layer is associated with its own scalability dimension value, AuxId (similarly to e.g. view order index). Layers with AuxId greater than 0 contain auxiliary pictures. A layer carries only one type of auxiliary pictures, and the type of auxiliary pictures included in a layer may be indicated by its AuxId value. In other words, AuxId values may be mapped to types of auxiliary pictures. For example, AuxId equal to 1 may indicate alpha planes and AuxId equal to 2 may indicate depth pictures. An auxiliary picture may be defined as a picture that has no normative effect on the decoding process of primary pictures. In other words, primary pictures (with AuxId equal to 0) may be constrained not to predict from auxiliary pictures. An auxiliary picture may predict from a primary picture, although there may be constraints disallowing such prediction, for example based on the AuxId value. SEI messages may be used to convey more detailed characteristics of auxiliary picture layers, such as the depth range represented by a depth auxiliary layer. The present draft of MV-HEVC includes support of depth auxiliary layers.

Different types of auxiliary pictures may be used including but not limited to the following: Depth pictures; Alpha pictures; Overlay pictures; and Label pictures. In Depth pictures a sample value represents disparity between the viewpoint (or camera position) of the depth picture or depth or distance. In Alpha pictures (a.k.a. alpha planes and alpha matte pictures) a sample value represents transparency or opacity. Alpha pictures may indicate for each pixel a degree of transparency or equivalently a degree of opacity. Alpha pictures may be monochrome pictures or the chroma components of alpha pictures may be set to indicate no chromaticity (e.g. 0 when chroma samples values are considered to be signed or 128 when chroma samples values are 8-bit and considered to be unsigned). Overlay pictures may be overlaid on top of the primary pictures in displaying. Overlay pictures may contain several regions and background, where all or a subset of regions may be overlaid in displaying and the background is not overlaid. Label pictures contain different labels for different overlay regions, which can be used to identify single overlay regions.

In SHVC, MV-HEVC, and/or alike, the block level syntax and decoding process are not changed for supporting inter-layer texture prediction. Only the high-level syntax, generally referring to the syntax structures including slice header, PPS, SPS, and VPS, has been modified (compared to that of HEVC) so that reconstructed pictures (upsampled if necessary) from a reference layer of the same access unit can be used as the reference pictures for coding the current enhancement layer picture. The inter-layer reference pictures as well as the temporal reference pictures are included in the reference picture lists. The signalled reference picture index is used to indicate whether the current Prediction Unit (PU) is predicted from a temporal reference picture or an inter-layer reference picture. The use of this feature may be controlled by the encoder and indicated in the bitstream for example in a video parameter set, a sequence parameter set, a picture parameter, and/or a slice header. The indication(s) may be specific to an enhancement layer, a reference layer, a pair of an enhancement layer and a reference layer, specific TemporalId values, specific picture types (e.g. RAP pictures), specific slice types (e.g. P and B slices but not I slices), pictures of a specific POC value, and/or specific access units, for example. The scope and/or persistence of the indication(s) may be indicated along with the indication(s) themselves and/or may be inferred.

The reference list(s) in SHVC, MV-HEVC, and/or alike may be initialized using a specific process in which the inter-layer reference picture(s), if any, may be included in the initial reference picture list(s). For example, the temporal references may be firstly added into the reference lists (L0, L1) in the same manner as the reference list construction in HEVC. After that, the inter-layer references may be added after the temporal references. The inter-layer reference pictures may be for example concluded from the layer dependency information provided in the VPS extension. The inter-layer reference pictures may be added to the initial reference picture list L0 if the current enhancement-layer slice is a P-Slice, and may be added to both initial reference picture lists L0 and L1 if the current enhancement-layer slice is a B-Slice. The inter-layer reference pictures may be added to the reference picture lists in a specific order, which can but need not be the same for both reference picture lists. For example, an opposite order of adding inter-layer reference pictures into the initial reference picture list 1 may be used compared to that of the initial reference picture list 0. For example, inter-layer reference pictures may be inserted into the initial reference picture 0 in an ascending order of nuh_layer_id, while an opposite order may be used to initialize the initial reference picture list 1.

In the coding and/or decoding process, the inter-layer reference pictures may be treated as long term reference pictures.

A type of inter-layer prediction, which may be referred to as inter-layer motion prediction, may be realized as follows. A temporal motion vector prediction process, such as TMVP of H.265/HEVC, may be used to exploit the redundancy of motion data between different layers. This may be done as follows: when the decoded base-layer picture is upsampled, the motion data of the base-layer picture is also mapped to the resolution of an enhancement layer. If the enhancement layer picture utilizes motion vector prediction from the base layer picture e.g. with a temporal motion vector prediction mechanism such as TMVP of H.265/HEVC, the corresponding motion vector predictor is originated from the mapped base-layer motion field. This way the correlation between the motion data of different layers may be exploited to improve the coding efficiency of a scalable video coder.

In SHVC and/or alike, inter-layer motion prediction may be performed by setting the inter-layer reference picture as the collocated reference picture for TMVP derivation. A motion field mapping process between two layers may be performed for example to avoid block level decoding process modification in TMVP derivation. The use of the motion field mapping feature may be controlled by the encoder and indicated in the bitstream for example in a video parameter set, a sequence parameter set, a picture parameter, and/or a slice header. The indication(s) may be specific to an enhancement layer, a reference layer, a pair of an enhancement layer and a reference layer, specific TemporalId values, specific picture types (e.g. RAP pictures), specific slice types (e.g. P and B slices but not I slices), pictures of a specific POC value, and/or specific access units, for example. The scope and/or persistence of the indication(s) may be indicated along with the indication(s) themselves and/or may be inferred.

In a motion field mapping process for spatial scalability, the motion field of the upsampled inter-layer reference picture may be attained based on the motion field of the respective reference layer picture. The motion parameters (which may e.g. include a horizontal and/or vertical motion vector value and a reference index) and/or a prediction mode for each block of the upsampled inter-layer reference picture may be derived from the corresponding motion parameters and/or prediction mode of the collocated block in the reference layer picture. The block size used for the derivation of the motion parameters and/or prediction mode in the upsampled inter-layer reference picture may be for example 16×16. The 16×16 block size is the same as in HEVC TMVP derivation process where compressed motion field of reference picture is used.

Inter-Layer Resampling

The encoder and/or the decoder may derive a horizontal scale factor (e.g. stored in variable ScaleFactorX) and a vertical scale factor (e.g. stored in variable ScaleFactorY) for a pair of an enhancement layer and its reference layer for example based on the scaled reference layer offsets for the pair. If either or both scale factors are not equal to 1, the reference layer picture may be resampled to generate a reference picture for predicting the enhancement layer picture. The process and/or the filter used for resampling may be pre-defined for example in a coding standard and/or indicated by the encoder in the bitstream (e.g. as an index among pre-defined resampling processes or filters) and/or decoded by the decoder from the bitstream. A different resampling process may be indicated by the encoder and/or decoded by the decoder and/or inferred by the encoder and/or the decoder depending on the values of the scale factor. For example, when both scale factors are less than 1, a pre-defined downsampling process may be inferred; and when both scale factors are greater than 1, a pre-defined upsampling process may be inferred. Additionally or alternatively, a different resampling process may be indicated by the encoder and/or decoded by the decoder and/or inferred by the encoder and/or the decoder depending on which sample array is processed. For example, a first resampling process may be inferred to be used for luma sample arrays and a second resampling process may be inferred to be used for chroma sample arrays.

An example of an inter-layer resampling process for obtaining a resampled luma sample value is provided in the following. The input luma sample array, which may also be referred to as the luma reference sample array, is referred through variable rlPicSampleL. The resampled luma sample value is derived for a luma sample location (x_{P}, y_{P}) relative to the top-left luma sample of the enhancement-layer picture. As a result, the process generates a resampled luma sample, accessed through variable intLumaSample. In this example the following 8-tap filter with coefficients f_{L} [p, x] with p=0 . . . 15 and x=0 . . . 7 is used for the luma resampling process. (In the following the notation with and without subscription may be interpreted interchangeably. For example, f_{L} may be interpreted to be the same as fL.)

| | interpolation filter coefficients | | | | | | | |
|---|---|---|---|---|---|---|---|---|
| phase p | f_{L} [p, 0] | f_{L} [p, 1] | f_{L} [p, 2] | f_{L} [p, 3] | f_{L} [p, 4] | f_{L} [p, 5] | f_{L} [p, 6] | f_{L} [p, 7] |
| 0 | 0 | 0 | 0 | 64 | 0 | 0 | 0 | 0 |
| 1 | 0 | 1 | −3 | 63 | 4 | −2 | 1 | 0 |
| 2 | −1 | 2 | −5 | 62 | 8 | −3 | 1 | 0 |
| 3 | −1 | 3 | −8 | 60 | 13 | −4 | 1 | 0 |
| 4 | −1 | 4 | −10 | 58 | 17 | −5 | 1 | 0 |
| 5 | −1 | 4 | −11 | 52 | 26 | −8 | 3 | −1 |
| 6 | −1 | 3 | −9 | 47 | 31 | −10 | 4 | −1 |
| 7 | −1 | 4 | −11 | 45 | 34 | −10 | 4 | −1 |
| 8 | −1 | 4 | −11 | 40 | 40 | −11 | 4 | −1 |
| 9 | −1 | 4 | −10 | 34 | 45 | −11 | 4 | −1 |
| 10 | −1 | 4 | −10 | 31 | 47 | −9 | 3 | −1 |
| 11 | −1 | 3 | −8 | 26 | 52 | −11 | 4 | −1 |
| 12 | 0 | 1 | −5 | 17 | 58 | −10 | 4 | −1 |
| 13 | 0 | 1 | −4 | 13 | 60 | −8 | 3 | −1 |
| 14 | 0 | 1 | −3 | 8 | 62 | −5 | 2 | −1 |
| 15 | 0 | 1 | −2 | 4 | 63 | −3 | 1 | 0 |

The value of the interpolated luma sample IntLumaSample may be derived by applying the following ordered steps:

1. The reference layer sample location corresponding to or collocating with (xP, yP) may be derived for example on the basis of scaled reference layer offsets. This reference layer sample location is referred to as (xRef16, yRef16) in units of 1/16-th sample.

2. The variables xRef and xPhase are derived as follows:

xRef=(xRef16>>4)

xPhase=(xRef16)% 16

where “>>” is a bit-shift operation to the right, i.e. an arithmetic right shift of a two's complement integer representation of x by y binary digits. This function may be defined only for non-negative integer values of y. Bits shifted into the MSBs (most significant bits) as a result of the right shift have a value equal to the MSB of x prior to the shift operation. “%” is a modulus operation, i.e. the remainder of x divided by y, defined only for integers x and y with x>=0 and y>0.

3. The variables yRef and yPhase are derived as follows:

yRef=(yRef16>>4)

yPhase=(yRef16)% 16

4. The variables shift1, shift2 and offset are derived as follows:

shift1=RefLayerBitDepthY−8

shift2=20−BitDepthY

offset=1<<(shift2−1)

where RefLayerBitDepthY is the number of bits per luma sample in the reference layer. BitDepthY is the number of bits per luma sample in the enhancement layer. “<<” is a bit-shift operation to the left, i.e. an arithmetic left shift of a two's complement integer representation of x by y binary digits. This function may be defined only for non-negative integer values of y. Bits shifted into the LSBs (least significant bits) as a result of the left shift have a value equal to 0.

5. The sample value tempArray[n] with n=0 . . . 7, is derived as follows:

yPosRL=Clip3(0,RefLayerPicHeightInSamplesY−1,yRef+n−1)

refW=RefLayerPicWidthInSamplesY

tempArray[n]=(fL[xPhase,0]*rlPicSampleL[Clip3(0,refW−1,xRef−3),yPosRL]+fL[xPhase,1]*rlPicSampleL[Clip3(0,refW−1,xRef−2),yPosRL]+fL[xPhase,2]*rlPicSampleL[Clip3(0,refW−1,xRef−1),yPosRL]+fL[xPhase,3]*rlPicSampleL[Clip3(0,refW−1,xRef),yPosRL]+fL[xPhase,4]*rlPicSampleL[Clip3(0,refW−1,xRef+1),yPosRL]+fL[xPhase,5]*rlPicSampleL[Clip3(0,refW−1,xRef+2),yPosRL]+fL[xPhase,6]*rlPicSampleL[Clip3(0,refW−1,xRef+3),yPosRL]+fL[xPhase,7]*rlPicSampleL[Clip3(0,refW−1,xRef+4),yPosRL])>>shift1

where RefLayerPicHeightInSamplesY is the height of the reference layer picture in luma samples. RefLayerPicWidthInSamplesY is the width of the reference layer picture in luma samples.

6. The interpolated luma sample value intLumaS ample is derived as follows:

intLumaSample=(fL[yPhase,0]*tempArray[0]+fL[yPhase,1]*tempArray[1]+fL[yPhase,2]*tempArray[2]+fL[yPhase,3]*tempArray[3]+fL[yPhase,4]*tempArray[4]+fL[yPhase,5]*tempArray[5]+fL[yPhase,6]*tempArray[6]+fL[yPhase,7]*tempArray[7]+offset)>>shift2

intLumaSample=Clip3(0, (1<<BitDepthY)−1, intLumaSample)

An inter-layer resampling process for obtaining a resampled chroma sample value may be specified identically or similarly to the above-described process for a luma sample value. For example, a filter with a different number of taps may be used for chroma samples than for luma samples.

Resampling may be performed for example picture-wise (for the entire reference layer picture or region to be resampled), slice-wise (e.g. for a reference layer region corresponding to an enhancement layer slice) or block-wise (e.g. for a reference layer region corresponding to an enhancement layer coding tree unit). The resampling a reference layer picture for the determined region (e.g. a picture, slice, or coding tree unit in an enhancement layer picture) may for example be performed by looping over all sample positions of the determined region and performing a sample-wise resampling process for each sample position. However, it is to be understood that other possibilities for resampling a determined region exist—for example, the filtering of a certain sample location may use variable values of the previous sample location.

In a scalability type which may be referred to as interlace-to-progressive scalability or field-to-frame scalability, coded interlaced source content material of the base layer is enhanced with an enhancement layer to represent progressive source content. The coded interlaced source content in the base layer may comprise coded fields, coded frames representing field pairs, or a mixture of them. In the interlace-to-progressive scalability, the base-layer picture may be resampled so that it becomes a suitable reference picture for one or more enhancement-layer pictures.

Interlace-to-progressive scalability may also utilize resampling of the reference-layer decoded picture representing interlaced source content. An encoder may indicate an additional phase offset as determined by whether the resampling is for a top field or a bottom field. The decoder may receive and decode an additional phase offset. Alternatively, the encoder and/or the decoder may infer the additional phase offset, for example based on indications which field(s) the base-layer and enhancement-layer pictures represent. For example, phase_position_flag[RefPicLayerId[i]] may be conditionally included in a slice header of an EL slice. When phase_position_flag[RefPicLayerId[i]] is not present, it may be inferred to be equal to 0. phase_position_flag[RefPicLayerId[i]] may specify the phase position in the vertical direction between the current picture and the reference layer picture with nuh_layer_id equal to RefPicLayerId[i] used in the derivation process for reference layer sample location. The additional phase offset may be taken into account for example in the inter-layer resampling process presented earlier, specifically in the derivation of the yPhase variable. yPhase may be updated to be equal to yPhase+(phase_position_flag[RefPicLayerId[i]]<<2).

Resampling, which may be applied to a reconstructed or decoded base-layer picture to obtain a reference picture for inter-layer prediction, may exclude every other sample row from the resampling filtering. Analogously, resampling may include a decimation step where every other sample row is excluded prior to a filtering step which may be carried out for resampling. More generally, a vertical decimation factor may be indicated through one or more indication(s) or inferred by an encoder or another entity, such as a bitstream multiplexer. Said one or more indication(s) may, for example, reside in a slice header of enhancement-layer slices, in prefix NAL units for the base layer, within enhancement-layer encapsulation NAL units (or alike) within the BL bitstream, within base-layer encapsulation NAL units (or alike) within the EL bitstream, within metadata of or for a file containing or referring to the base layer and/or enhancement layer, and/or within metadata in a communication protocol, such as descriptors of MPEG-2 transport stream. Said one or more indication(s) may be picture-wise, if the base-layer may contain a mixture of coded fields and frame-coded field pairs representing interlaced source content. Alternatively or additionally, said one or more indication(s) may be specific to a time instant and/or a pair of an enhancement layer and its reference layer. Alternatively or additionally, said one or more indication(s) may be specific to a pair of an enhancement layer and its reference layer (and may be indicated for a sequence of pictures, such as for a coded video sequence). Said one or more indication(s) may be for example a flag vert_decimation_flag in a slice header, which may be specific to a reference layer. A variable, e.g. referred to as VertDecimationFactor, may be derived from the flag, e.g. VertDecimationFactor may be set equal to vert_decimation_flag+1. A decoder or another entity, such as a bitstream demultiplexer, may receive and decode said one or more indication(s) to obtain a vertical decimation factor and/or it may infer a vertical decimation factor. A vertical decimation factor may be inferred for example based on the information whether the base-layer picture is a field or a frame and whether the enhancement-layer picture is a field or a frame. When a base-layer picture is concluded to be a frame containing a field pair representing interlaced source content and the respective enhancement-layer picture is concluded to be a frame representing progressive source content, the vertical decimation factor may be inferred to be equal to 2, i.e. indicating that every other sample row of the decoded base-layer picture (e.g. of its luma sample array) is processed in the resampling. When a base-layer picture is concluded to be a field and the respective enhancement-layer picture is concluded to be a frame representing progressive source content, the vertical decimation factor may be inferred to be equal to 1, i.e. indicating that every sample row of the decoded base-layer picture (e.g. of its luma sample array) is processed in the resampling.

The use of the vertical decimation factor, represented by variable VertDecimationFactor in the following, may be included in the resampling for example as follows with reference to the inter-layer resampling process presented earlier. Only the sample row of the reference-layer picture which are VertDecimationFactor apart from each other may take part in the filtering. Step 5 of the resampling process may use VertDecimationFactor as follows or in a similar manner.

5. The sample value tempArray[n] with n=0 . . . 7, is derived as follows:

yPosRL=Clip3(0,RefLayerPicHeightInSamplesY−1,yRef+VertDecimationFactor*(n−4))

refW=RefLayerPicWidthInSamplesY

tempArray[n]=(fL[xPhase,0]*rlPicSampleL[Clip3(0,refW−1,xRef−3),yPosRL]+fL[xPhase,1]*rlPicSampleL[Clip3(0,refW−1,xRef−2),yPosRL]+fL[xPhase,2]*rlPicSampleL[Clip3(0,refW−1,xRef−1),yPosRL]+fL[xPhase,3]*rlPicSampleL[Clip3(0,refW−1,xRef),yPosRL]+fL[xPhase,4]*rlPicSampleL[Clip3(0,refW−1,xRef+1),yPosRL]+fL[xPhase,5]*rlPicSampleL[Clip3(0,refW−1,xRef+2),yPosRL]+fL[xPhase,6]*rlPicSampleL[Clip3(0,refW−1,xRef+3),yPosRL]+fL[xPhase,7]*rlPicSampleL[Clip3(0,refW−1,xRef+4),yPosRL])>>shift1

where RefLayerPicHeightInSamplesY is the height of the reference layer picture in luma samples. RefLayerPicWidthInSamplesY is the width of the reference layer picture in luma samples.

A skip picture may be defined as an enhancement-layer picture for which only inter-layer prediction is applied and no prediction error is coded. In other words, no intra prediction or inter prediction (from the same layer) is applied for a skip picture. In MV-HEVC/SHVC, the use of skip pictures may be indicated with a VPS VUI flag higher_layer_irap_skip_flag, which may be specified as follows. higher_layer_irap_skip_flag equal to 1 indicates that for every IRAP picture that refers to the VPS, for which there is another picture in the same access unit with a lower value of nuh_layer_id, the following constraints apply:

For all slices of the IRAP picture:
slice_type shall be equal to P.
slice_sao_luma_flag and slice_sao_chroma_flag shall both be equal to 0.
five_minus_max_num_merge_cand shall be equal to 4.
weighted_pred_flag shall be equal to 0 in the PPS that is refered to by the slices.

For all coding units of the IRAP picture:
cu_skip_flag[i][j] shall be equal to 1.
higher_layer_irap_skip_flag equal to 0 indicates that the above constraints may or may not apply.

Hybrid Codec Scalability

A type of scalability in scalable video coding is coding standard scalability, which may also be referred to as hybrid codec scalability. In hybrid codec scalability, the bitstream syntax, semantics and decoding process of the base layer and the enhancement layer are specified in different video coding standards. For example, the base layer may be coded according to one coding standard, such as H.264/AVC, and an enhancement layer may be coded according to another coding standard such as MV-HEVC/SHVC. In this way, the same bitstream can be decoded by both legacy H.264/AVC based systems as well as HEVC based systems.

More generally, in hybrid codec scalability one or more layers may be coded according to one coding standard or specification and other one or more layers may be coded according to another coding standard or specification. For example, there may be two layers coded according to the MVC extension of H.264/AVC (out of which one is a base layer coded according to H.264/AVC), and one or more additional layers coded according to MV-HEVC. Furthermore, the number of coding standard or specifications according to which different layers of the same bitstream are coded might not be limited to two in hybrid codec scalability.

Hybrid codec scalability may be used together with any types of scalability, such as temporal, quality, spatial, multi-view, depth-enhanced, auxiliary picture, bit-depth, color gamut, chroma format, and/or ROI scalability. As hybrid codec scalability may be used together with other types of scalabilities, it may be considered to form a different categorization of scalability types.

The use of hybrid codec scalability may be indicated for example in an enhancement layer bitstream. For example, in MV-HEVC, SHVC, and/or alike, the use of hybrid codec scalability may be indicated in the VPS. For example, the following VPS syntax may be used:

Descriptor

video_parameter_set_rbsp( ) {

| | |
|---|---|
| vps_video_parameter_set_id | u(4) |
| vps_base_layer_internal_flag | u(1) |
| ... | |

The semantics of vps_base_layer_internal_flag may be specified as follows: vps_base_layer_internal_flag equal to 0 specifies that the base layer is provided by an external means not specified in MV-HEVC, SHVC, and/or alike. vps_base_layer_internal_flag equal to 1 specifies that the base layer is provided in the bitstream.

In many video communication or transmission systems, transport mechanisms and multimedia container file formats there are mechanisms to transmit or store the base layer separately from the enhancement layer(s). It may be considered that layers are stored in or transmitted through separate logical channels. Examples are provided in the following:
ISO Base Media File Format (ISOBMFF, ISO/IEC International Standard 14496-12): Base layer can be stored as a track and each enhancement layer can be stored in another track. Similarly, in a hybrid codec scalability case, a non-HEVC-coded base layer can be stored as a track (e.g. of sample entry type ‘ave1’), while the enhancement layer(s) can be stored as another track which is linked to the base-layer track using so-called track references.
Real-time Transport Protocol (RTP): either RTP session multiplexing or synchronization source (SSRC) multiplexing can be used to logically separate different layers.
MPEG-2 transport stream (TS): Each layer can have a different packet identifier (PID) value.

Many video communication or transmission systems, transport mechanisms and multimedia container file formats provides means to associate coded data of separate logical channels, such as of different tracks or sessions, with each other. For example, there are mechanisms to associate coded data of the same access unit together. For example, decoding or output times may be provided in the container file format or transport mechanism, and coded data with the same decoding or output time may be considered to form an access unit.

Available media file format standards include ISO base media file format (ISO/IEC 14496-12, which may be abbreviated ISOBMFF), MPEG-4 file format (ISO/IEC 14496-14, also known as the MP4 format), file format for NAL unit structured video (ISO/IEC 14496-15) and 3GPP file format (3GPP TS 26.244, also known as the 3GP format). The ISO file format is the base for derivation of all the above mentioned file formats (excluding the ISO file format itself). These file formats (including the ISO file format itself) are generally called the ISO family of file formats.

Some concepts, structures, and specifications of ISOBMFF are described below as an example of a container file format, based on which the embodiments may be implemented. The aspects of the invention are not limited to ISOBMFF, but rather the description is given for one possible basis on top of which the invention may be partly or fully realized.

A basic building block in the ISO base media file format is called a box. Each box has a header and a payload. The box header indicates the type of the box and the size of the box in terms of bytes. A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

According to the ISO family of file formats, a file includes media data and metadata that are encapsulated into boxes. Each box is identified by a four character code (4CC) and starts with a header which informs about the type and size of the box.

In files conforming to the ISO base media file format, the media data may be provided in a media data ‘mdat’ box and the movie ‘moov’ box may be used to enclose the metadata. In some cases, for a file to be operable, both of the ‘mdat’ and ‘moov’ boxes may be required to be present. The movie ‘moov’ box may include one or more tracks, and each track may reside in one corresponding track ‘trak’ box. A track may be one of the many types, including a media track that refers to samples formatted according to a media compression format (and its encapsulation to the ISO base media file format). A track may be regarded as a logical channel.

Each track is associated with a handler, identified by a four-character code, specifying the track type. Video, audio, and image sequence tracks can be collectively called media tracks, and they contain an elementary media stream. Other track types comprise hint tracks and timed metadata tracks. Tracks comprise samples, such as audio or video frames. A media track refers to samples (which may also be referred to as media samples) formatted according to a media compression format (and its encapsulation to the ISO base media file format). A hint track refers to hint samples, containing cookbook instructions for constructing packets for transmission over an indicated communication protocol. The cookbook instructions may include guidance for packet header construction and may include packet payload construction. In the packet payload construction, data residing in other tracks or items may be referenced. As such, for example, data residing in other tracks or items may be indicated by a reference as to which piece of data in a particular track or item is instructed to be copied into a packet during the packet construction process. A timed metadata track may refer to samples describing referred media and/or hint samples. For the presentation of one media type, one media track may be selected.

Movie fragments may be used e.g. when recording content to ISO files e.g. in order to avoid losing data if a recording application crashes, runs out of memory space, or some other incident occurs. Without movie fragments, data loss may occur because the file format may require that all metadata, e.g., the movie box, be written in one contiguous area of the file. Furthermore, when recording a file, there may not be sufficient amount of memory space (e.g., random access memory RAM) to buffer a movie box for the size of the storage available, and re-computing the contents of a movie box when the movie is closed may be too slow. Moreover, movie fragments may enable simultaneous recording and playback of a file using a regular ISO file parser. Furthermore, a smaller duration of initial buffering may be required for progressive downloading, e.g., simultaneous reception and playback of a file when movie fragments are used and the initial movie box is smaller compared to a file with the same media content but structured without movie fragments.

The movie fragment feature may enable splitting the metadata that otherwise might reside in the movie box into multiple pieces. Each piece may correspond to a certain period of time of a track. In other words, the movie fragment feature may enable interleaving file metadata and media data. Consequently, the size of the movie box may be limited and the use cases mentioned above be realized.

In some examples, the media samples for the movie fragments may reside in an mdat box, if they are in the same file as the moov box. For the metadata of the movie fragments, however, a moof box may be provided. The moof box may include the information for a certain duration of playback time that would previously have been in the moov box. The moov box may still represent a valid movie on its own, but in addition, it may include an mvex box indicating that movie fragments will follow in the same file. The movie fragments may extend the presentation that is associated to the moov box in time.

Within the movie fragment there may be a set of track fragments, including anywhere from zero to a plurality per track. The track fragments may in turn include anywhere from zero to a plurality of track runs, each of which document is a contiguous run of samples for that track. Within these structures, many fields are optional and can be defaulted. The metadata that may be included in the moof box may be limited to a subset of the metadata that may be included in a moov box and may be coded differently in some cases. Details regarding the boxes that can be included in a moof box may be found from the ISO base media file format specification. A self-contained movie fragment may be defined to consist of a moof box and an mdat box that are consecutive in the file order and where the mdat box contains the samples of the movie fragment (for which the moof box provides the metadata) and does not contain samples of any other movie fragment (i.e. any other moof box).

The ISO Base Media File Format contains three mechanisms for timed metadata that can be associated with particular samples: sample groups, timed metadata tracks, and sample auxiliary information. Derived specification may provide similar functionality with one or more of these three mechanisms.

A sample grouping in the ISO base media file format and its derivatives, such as the AVC file format and the SVC file format, may be defined as an assignment of each sample in a track to be a member of one sample group, based on a grouping criterion. A sample group in a sample grouping is not limited to being contiguous samples and may contain non-adjacent samples. As there may be more than one sample grouping for the samples in a track, each sample grouping may have a type field to indicate the type of grouping. Sample groupings may be represented by two linked data structures: (1) a SampleToGroup box (sbgp box) represents the assignment of samples to sample groups; and (2) a SampleGroupDescription box (sgpd box) contains a sample group entry for each sample group describing the properties of the group. There may be multiple instances of the SampleToGroup and SampleGroupDescription boxes based on different grouping criteria. These may be distinguished by a type field used to indicate the type of grouping.

Sample auxiliary information may be intended for use where the information is directly related to the sample on a one-to-one basis, and may be required for the media sample processing and presentation. Per-sample sample auxiliary information may be stored anywhere in the same file as the sample data itself; for self-contained media files, this may be an ‘mdat’ box. Sample auxiliary information may be stored in multiple chunks, with the number of samples per chunk, as well as the number of chunks, matching the chunking of the primary sample data, or in a single chunk for all the samples in a movie sample table (or a movie fragment). The Sample Auxiliary Information for all samples contained within a single chunk (or track run) is stored contiguously (similarly to sample data). Sample Auxiliary Information, when present, may be stored in the same file as the samples to which it relates as they share the same data reference (‘dref’) structure. However, this data may be located anywhere within this file, using auxiliary information offsets (‘saio’) to indicate the location of the data. The sample auxiliary information is located using two boxes, Sample Auxiliary Information Sizes box and Sample Auxiliary Information Offsets (‘saio’) box. For both these boxes, the syntax elements aux_info_type and aux_info_type_parameter are given or inferred (both of which are 32-bit unsigned integers or equivalently four-character codes). While aux_info_type determines the format of the auxiliary information, several streams of auxiliary information having the same format may be used when their value of aux_info_type_parameter differs. The Sample Auxiliary Information Sizes box provides the size of the sample auxiliary information for each sample, while the Sample Auxiliary Information Offsets box provides the (starting) location(s) of chunks or track runs of sample auxiliary information.

The Matroska file format is capable of (but not limited to) storing any of video, audio, picture, or subtitle tracks in one file. Matroska may be used as a basis format for derived file formats, such as WebM. Matroska uses Extensible Binary Meta Language (EBML) as basis. EBML specifies a binary and octet (byte) aligned format inspired by the principle of XML. EBML itself is a generalized description of the technique of binary markup. A Matroska file consists of Elements that make up an EBML “document.” Elements incorporate an Element ID, a descriptor for the size of the element, and the binary data itself. Elements can be nested. A Segment Element of Matroska is a container for other top-level (level 1) elements. A Matroska file may comprise (but is not limited to be composed of) one Segment. Multimedia data in Matroska files is organized in Clusters (or Cluster Elements), each containing typically a few seconds of multimedia data. A Cluster comprises BlockGroup elements, which in turn comprise Block Elements. A Cues Element comprises metadata which may assist in random access or seeking and may include file pointers or respective timestamps for seek points.

Real-time Transport Protocol (RTP) is widely used for real-time transport of timed media such as audio and video. RTP may operate on top of the User Datagram Protocol (UDP), which in turn may operate on top of the Internet Protocol (IP). RTP is specified in Internet Engineering Task Force (IETF) Request for Comments (RFC) 3550, available from www.ietf.org/rfc/rfc3550.txt. In RTP transport, media data is encapsulated into RTP packets. Typically, each media type or media coding format has a dedicated RTP payload format.

An RTP session is an association among a group of participants communicating with RTP. It is a group communications channel which can potentially carry a number of RTP streams. An RTP stream is a stream of RTP packets comprising media data. An RTP stream is identified by an SSRC belonging to a particular RTP session. SSRC refers to either a synchronization source or a synchronization source identifier that is the 32-bit SSRC field in the RTP packet header. A synchronization source is characterized in that all packets from the synchronization source form part of the same timing and sequence number space, so a receiver may group packets by synchronization source for playback. Examples of synchronization sources include the sender of a stream of packets derived from a signal source such as a microphone or a camera, or an RTP mixer. Each RTP stream is identified by a SSRC that is unique within the RTP session. An RTP stream may be regarded as a logical channel.

An RTP packet comprises of an RTP header and RTP packet payload. The packet payload may be considered to comprise an RTP payload header and RTP payload data, which are formatted as specified in an RTP payload format being used. The draft payload format for H.265 (HEVC) specifies an RTP payload header that may be extended using a payload header extension structure (PHES). PHES may be considered to be included within a NAL-unit-like structure, which may be referred to as payload content information (PACI), that appears as the first NAL unit within the RTP payload data. When the payload header extension mechanism is in use, the RTP packet payload may be considered to comprise a payload header, a payload header extension structure (PHES), and a PACI payload. The PACI payload may comprise NAL units or NAL-unit-like structures, such as a fragmentation unit (comprising a part of a NAL unit) or an aggregation (or a set) of several NAL units. PACI is an extensible structure and can conditionally comprise different extensions, as controlled by presence flags in PACI header. The draft payload format for H.265 (HEVC) specifies one PACI extension, referred to as the Temporal Scalability Control Information. RTP payloads may enable establishing a decoding order of contained data units (e.g. NAL units) by including and/or inferring a decoding order number (DON) or alike for the data units, where the DON values are indicative of the decoding order.

It may be desirable to specify a format, which can encapsulate NAL units and/or other coded data units of two or more standards or coding systems into the same a bitstream, byte stream, NAL unit stream or alike. This approach may be referred to as encapsulated hybrid codec scalability. In the following, mechanisms to include AVC NAL units and HEVC NAL units in a same NAL unit stream are described. It needs to be understood that mechanisms might be realized similarly for coded data units other than NAL units, for bitstream or byte stream format, for any coding standards or systems. In the following, the base layer is considered to be AVC-coded and the enhancement layer is considered to be coded with an HEVC extension, such as SHVC or MV-HEVC. It needs to be understood that mechanisms could be realized similarly if more than one layer is of a first coding standard or system, such as AVC or its extensions like MVC, and/or more than one layer is a second coding standard. Likewise, it needs to be understood that mechanisms could be realized similarly when layers represent more than two coding standards. For example, the base layer may be coded with AVC, an enhancement layer may be coded with MVC and represent a non-base view, and either or both of the previous layers may be enhanced by a spatial or quality scalable layer coded with SHVC.

The options for a NAL unit stream format encapsulating both AVC and HEVC NAL units include but are not limited to the following:

AVC NAL units may be contained in an HEVC-compliant NAL unit stream. One or more NAL unit types, which may be referred to as AVC container NAL units, may be specified among the nal_unit_type values specified in the HEVC standard to indicate an AVC NAL unit. An AVC NAL unit, which may include the AVC NAL unit header, may then be included as a NAL unit payload in an AVC container NAL unit.

HEVC NAL units may be contained in an AVC-compliant NAL unit stream. One or more NAL unit types, which may be referred to as HEVC container NAL units, may be specified among the nal_unit_type values of the AVC standard to indicate an HEVC NAL unit. An HEVC NAL unit, which may include the HEVC NAL unit header, may then be included as a NAL unit payload in an HEVC container NAL unit.

Rather than containing data units of a first coding standard or system, a bitstream, byte stream, NAL unit stream or alike of a second coding standard or system may refer to data units of the first coding standard. Additionally, properties of the data units of the first coding standard may be provided within the bitstream, byte stream, NAL unit stream or alike of the second coding standard. The properties may relate to operation of the decoded reference picture marking, processing and buffering, which may be a part of decoding, encoding, and/or HRD operation. Alternatively or additionally, the properties may relate buffering delays, such as CPB and DPB buffering delays, and/or HRD timing, such as CPB removal times or alike. Alternatively or additionally, the properties may relate to picture identification or association to access units, such as picture order count. The properties may enable to handle a decoded picture of the first coding standard or system in the decoding process and/or HRD of the second coding standard as if the decoded picture were decoded according to the second coding standard. For example, the properties may enable to handle a decoded AVC base-layer picture in the decoding process and/or HRD of SHVC or MV-HEVC as if the decoded picture was an HEVC base-layer picture.

It may be desirable to specify an interface to a decoding process, which enables providing one or more decoded pictures which may be used as reference in the decoding process. This approach may be referred to as non-encapsulated hybrid codec scalability, for example. In some cases, the decoding process is an enhancement layer decoding process, according to which one or more enhancement layers may be decoded. In some cases, the decoding process is a sub-layer decoding process according to which one or more sub-layers may be decoded. The interface may be specified for example through one or more variables, which may be set by external means, such as a media player or decoder control logic, for example. In non-encapsulated hybrid codec scalability, the base layer may be referred to as an external base layer, indicating that the base layer is external from the enhancement-layer bitstream (which may also be referred to as the EL bitstream). An external base layer of an enhancement-layer bitstream according to an HEVC extension may be referred to as a non-HEVC base layer.

In the non-encapsulated hybrid codec scalability, the association of a base layer decoded picture to an access unit of an enhancement-layer decoder or bitstream is performed by means that might not be specified in the specification of the enhancement-layer decoding and/or bitstream. The association may be performed for example using but is not limited to one or more of the following means:

A decoding time and/or presentation time may be indicated using for example container file format metadata and/or transmission protocol headers. In some cases, a base-layer picture may be associated with an enhancement-layer picture when their presentation time is the same. In some cases, a base-layer picture may be associated with an enhancement-layer picture when their decoding time is the same.

A NAL-unit-like structure that is included in-band in the enhancement-layer bitstream. For example, in MV-HEVC/SHVC bitstreams, a NAL-unit-like structure with nal_unit_type in the range UNSPEC48 to UNSPEC55 inclusive, could be used. The NAL-unit-like structure may identify a base-layer picture that is associated with the enhancement-layer access unit containing the NAL-unit-like structure. For example, in a file derived from ISO base media file format, a structure, such as an extractor (a.k.a. an extractor NAL unit) specified in ISO/IEC 14496-15, may contain an enumerated track reference (to indicate the track containing the base-layer) and a decoding time difference (to indicate a file format sample in the base-layer track relative to the decoding time of the current file format sample of the enhancement-layer track). An extractor specified in ISO/IEC 14496-15 includes an indicated byte range from the referred sample of the referred track (e.g. the track containing the base layer) by reference into the track containing the extractor. In another example, a NAL unit-like-structure includes an identifier of the BL coded video sequence, such as a value of idr_pic_id of H.264/AVC, and an identifier of the picture within the BL coded video sequence, such as a frame_num or POC value of H.264/AVC.

Protocol and/or file format metadata that can be associated with a particular EL picture may be used. For example, an identifier of a base-layer picture may be included as a descriptor of MPEG-2 transport stream, where the descriptor is associated with the enhancement-layer bitstream.

Protocol and/or file format metadata may be associated with BL and EL pictures. When the metadata for a BL and EL picture match, they may be considered to belong to the same time instant or access unit. For example, a cross-layer access unit identifier may be used, where an access unit identifier value needs to differ from other cross-layer access unit identifier values within a certain range or amount of data in decoding or bitstream order.

There are at least two approaches for handling the output of decoded base-layer pictures in hybrid codec scalability. In a first approach, which may be referred to as the separate-DPB hybrid codec scalability approach, the base-layer decoder takes care of the output of the decoded base-layer pictures. An enhancement-layer decoder needs to have one picture storage buffer for a decoded base-layer picture (e.g. in the sub-DPB associated with the base layer). After the decoding of each access unit, the picture storage buffer for the base layer may be emptied. In a second approach, which may be referred to as the shared-DPB hybrid codec scalability approach, the output of decoded base-layer pictures is handled by the enhancement-layer decoder, while the base-layer decoder need not output base-layer pictures. In the shared-DPB approach, the decoded base-layer pictures may, at least conceptually, reside in the DPB of the enhancement-layer decoder. The separate-DPB approach may be applied together with encapsulated or non-encapsulated hybrid codec scalability. Likewise, the shared-DPB approach may be applied together with encapsulated or non-encapsulated hybrid codec scalability.

In order for the DPB to operate correctly in the case of shared-DPB hybrid codec scalability (i.e. the base layer being non-HEVC-coded), the base layer pictures may be at least conceptually included in the DPB operation of the scalable bitstream and be assigned one or more of the following properties or alike.

1. NoOutputOfPriorPicsFlag (for IRAP pictures)

### 2. PicOutputFlag

### 3. PicOrderCntVal

4. Reference picture set

These mentioned properties may enable the base-layer pictures to be treated similarly to pictures of any other layers in the DPB operation. For example, when the base-layer is AVC-coded, and the enhancement-layer is HEVC-coded, these mentioned properties enable controlling functionality related to AVC base layer with syntax elements of HEVC, such as:
In some output layer sets, the base layer may be among the output layers, in some other output layer sets the base layer might not be among output layers.
The output of an AVC base layer picture may be synchronized with the output of the pictures of other layers in the same access.
The base layer pictures may be assigned information that is specific to the output operation, such as no_output_of_prior_pics_flag and pic_output_flag.

The interface for non-encapsulated hybrid codec scalability may be capable of but is not limited conveying one or more of the following pieces of information:
An indication if there is a base-layer picture that may be used for inter-layer prediction of a certain enhancement-layer picture.
The sample array(s) of the base layer decoded picture.
The representation format of the base layer decoded picture, including the width and height in luma samples, the colour format, the luma bit depth, and the chroma bit depth.
Picture type or NAL unit type associated with the base-layer picture. For example, an indication whether the base layer picture is an IRAP picture, and if the base-layer picture is an IRAP picture, the IRAP NAL unit type, which may for example specify an IDR picture, a CRA picture, or a BLA picture.
Indication if the picture is a frame or a field. If the picture is a field, an indication of the field parity (a top field or a bottom field). If the picture if a frame, an indication whether frame represents a complementary field pair.
One or more of NoOutputOfPriorPicsFlag, PicOutputFlag, PicOrderCntVal and reference picture set, which may be needed for shared-DPB hybrid codec scalability.

In some cases, non-HEVC-coded base layer pictures are associated with one or more of the above-mentioned properties. The association may be made through external means (outside the bitstream format) or through indicating the properties in specific NAL units or SEI messages in the HEVC bitstream or through indicating the properties in specific NAL units or SEI messages in the AVC bitstream. Such specific NAL units in the HEVC bitstream may be referred to as BL-encapsulation NAL units, and likewise such specific SEI messages in the HEVC bitstream may be referred to as BL-encapsulation SEI messages. Such specific NAL units in the AVC bitstream may be referred to as EL-encapsulation NAL units, and likewise such specific SEI messages in the AVC bitstream may be referred to as EL-encapsulation SEI messages. In some cases, the BL-encapsulation NAL units included in the HEVC bitstream may additionally include base-layer coded data. In some cases, the EL-encapsulation NAL units included in the AVC bitstream may additionally include enhancement-layer coded data.

Some syntax element and/or variable values needed in the decoding process and/or HRD may be inferred for the decoded base-layer pictures when hybrid codec scalability is in use. For example, for HEVC based enhancement-layer decoding, nuh_layer_id of decoded base-layer pictures may be inferred to be equal to 0 and picture order count of decoded base-layer pictures may be set equal to the picture order count of respective enhancement layer pictures of the same time instant or access unit. Moreover, TemporalId for an external base-layer picture may be inferred to be equal to the TemporalId of the other pictures in the access unit which the external base-layer picture is associated with.

A hybrid codec scalability nesting SEI message may contain one or more HRD SEI messages, such as a buffering period SEI message (e.g. according to H.264/AVC or HEVC) or a picture timing SEI message (e.g. according to H.264/AVC or HEVC).). Alternatively or additionally, the hybrid codec scalability nesting SEI message may contain bitstream- or sequence-level HRD parameters, such as the hrd_parameters( ) syntax structure of H.264/AVC. Alternatively or additionally, the hybrid codec scalability nesting SEI message may contain syntax elements, some of which may be identical or similar to those in the bitstream- or sequence level HRD parameters (e.g. hrd_parameters( ) syntax structure of H.264/AVC) and/or in a buffering period SEI e.g. according to H.264/AVC or HEVC) or a picture timing SEI message (e.g. according to H.264/AVC or HEVC). It is to be understood that the SEI messages or other syntax structures allowed to be nested within the hybrid codec scalability nesting SEI message may not be limited to those above.

The hybrid codec scalability nesting SEI message may reside in the base-layer bitstream and/or in the enhancement-layer bitstream. The hybrid codec scalability nesting SEI message may include syntax elements that specify the layers, sub-layer, bitstream subsets, and/or bitstream partitions to which the nested SEI messages apply.

Base-layer profile and/or level (and/or alike conformance information) applicable when the base-layer HRD parameters for hybrid codec scalability are applied may be encoded into and/or decoded from a specific SEI message, which may be referred to as base-layer profile and level SEI message. According to an embodiment, base-layer profile and/or level (and/or alike conformance information) applicable when the base-layer HRD parameters for hybrid codec scalability are applied may be encoded into and/or decoded from a specific SEI message, whose syntax and semantics depend on the coding format of the base layer. For example, an AVC base-layer profile and level SEI message may be specified, in which the SEI message payload may contain profile_idc of H.264/AVC, the second byte of seq_parameter_set_data( ) syntax structure of H.264/AVC (which may include the syntax elements constraint_setX_flag, x being each value in the range of 0 to 5, inclusive, and reserverved_zero_{—}2 bits), and/or level_idc of H.264/AVC.

Base-layer HRD initialization parameters SEI message(s) (or alike), base-layer buffering period SEI message(s) (or alike), base-layer picture timing SEI message(s) (or alike), hybrid codec scalability nesting SEI message(s) (or alike) and/or base-layer profile and level SEI message(s) (or alike) may be included into and/or decoded from one or more of the following containing syntax structures and/or mechanisms:
Prefix NAL units (or alike) associated with base-layer pictures within the BL bitstream.
Enhancement-layer encapsulation NAL units (or alike) within the BL bitstream.
As “self-standing” (i.e., non-encapsulated or non-nested) SEI messages within the BL bitstream.
Scalable nesting SEI message (alike) within the BL bitstream, where the target layers may be specified to comprise the base layer and the enhancement layer.
Base-layer encapsulation NAL units (or alike) within the EL bitstream.
As “self-standing” (i.e., non-encapsulated or non-nested) SEI messages within the EL bitstream.
Scalable nesting SEI message (alike) within the EL bitstream, where the target layer may be specified to be the base layer.
Metadata according to a file format, which metadata resides or is referred to by a file that includes or refers to the BL bitstream and the EL bitstream.
Metadata within a communication protocol, such as within descriptors of MPEG-2 transport stream.

When hybrid codec scalability is in use, a first bitstream multiplexer may take as input a base-layer bitstream and an enhancement-layer bitstream and form a multiplexed bitstream, such as an MPEG-2 transport stream or a part thereof. Alternatively or additionally, a second bitstream multiplexer (which may also be combined with the first bitstream multiplexer) may encapsulate base-layer data units, such as NAL units, into enhancement-layer data units, such as NAL units, into the enhancement-layer bitstream. A second bitstream multiplexer may alternatively encapsulate enhancement-layer data units, such as NAL units, into base-layer data units, such as NAL units, into the base-layer bitstream.

An encoder or another entity, such as a file creator, may receive the intended display behavior of different layers to be encoded through an interface. The intended display behavior may be for example by the user or users creating the content through a user interface, the settings of which then affect the intended display behavior that the encoder receives through an interface.

An encoder or another entity, such as a file creator, may determine, based on the input content and/or the encoding settings, the intended display behavior. For example, if two views are provided as input to be coded as layers, the encoder may determine that the intended display behavior is to display the views separately (e.g. on a stereoscopic display). In another example, the encoder receives encoding settings that a region-of-interest enhancement layer (EL) is to be encoded. The encoder may, for example, have a heuristic rule that if the scale factor between the ROI enhancement layer and its reference layer (RL) is smaller than or equal to a certain limit, e.g. 2, the intended display behavior is to overlay an EL picture on top of the respective upsampled RL picture.

Based on the received and/or determined display behavior, an encoder or another entity, such as a file creator, may encode an indication of the intended display behavior of two or more layers into the bitstream, for example in a sequence-level syntax structure, such as VPS and/or SPS (in which the indication may reside within their VUI part), or as SEI, e.g. in a SEI message. Alternatively or in addition, an encoder or another entity, such as a file creator, may encode an indication of the intended display behavior of two or more layers into a container file that includes coded pictures. Alternatively or in addition, an encoder or another entity, such as a file creator, may encode an indication of the intended display behavior of two or more layers into a description, such as MIME media parameters, SDP, or MPD.

A decoder or another entity, such as a media player or a file parser, may decode an indication of the intended display behavior of two or more layers from the bitstream, for example from a sequence-level syntax structure, such as VPS and/or SPS (in which the indication may reside within their VUI part), or through SEI mechanism, e.g. from a SEI message. Alternatively or in addition, a decoder or another entity, such as a media player or a file parser, may decode an indication of the intended display behavior of two or more layers from a container file that includes coded pictures. Alternatively or in addition, a decoder or another entity, such as a media player or a file parser, may decode an indication of the intended display behavior of two or more layers from a description, such as MIME media parameters, SDP, or MPD. Based on the decoded display behavior, a decoder or another entity, such as a media player or a file parser, may create one or more pictures to be displayed from decoded (and possibly cropped) pictures of two or more layers. A decoder or another entity, such as a media player or a file parser, may also display the one or more pictures to be displayed.

Diagonal Inter-Layer Prediction

Another categorization of inter-layer prediction distinguishes aligned inter-layer prediction and diagonal (or directional) inter-layer prediction. Aligned inter-layer prediction may be considered to take place from pictures included in the same access unit as the picture that is being predicted. An inter-layer reference picture may be defined as a reference picture that is from a different layer than the picture being predicted (e.g. has a different nuh_layer_id value than that of the current picture in the HEVC context). An aligned inter-layer reference picture may be defined as an inter-layer reference picture included in the access unit that also contains the current picture. Diagonal inter-layer prediction may be considered to take place from a picture of a different access unit as that containing the current picture being predicted.

Diagonal prediction and/or diagonal inter-layer reference pictures may be enabled for example as follows. An additional short-term reference picture set (RPS) or alike may be included in the slice segment header. The additional short-term RPS or alike is associated with an indicated direct reference layer as indicated in the slice segment header by the encoder and decoded from the slice segment header by the decoder. The indication may be performed, for example, through indexing the possible direct reference layers according to the layer dependency information, which may, for example, be present in the VPS. The indication may, for example, be an index value among the indexed direct reference layers or the indication may be a bit mask including direct reference layers, where a position in the mask indicates the direct reference layer and a bit value in the mask indicates whether or not the layer is used as a reference for diagonal inter-layer prediction (and hence a short-term RPS or alike is included for and associated with that layer). The additional short-term RPS syntax structure or alike specifies the pictures from the direct reference layer that are included in the initial reference picture list(s) of the current picture Unlike the conventional short-term RPS included in the slice segment header, decoding of the additional short-term RPS or alike causes no change on the marking of the pictures (e.g. as “unused for reference” or “used for long-term reference”). The additional short-term RPS or alike need not use the same syntax as the conventional short-term RPS—particularly it is possible to exclude the flags to indicate that the indicated picture may be used for reference for the current picture or that the indicated picture is not used for reference for the current picture but may be used for reference subsequent pictures in decoding order. The decoding process for reference picture lists construction may be modified to include reference pictures from the additional short-term RPS syntax structure or alike for the current picture.

An Adaptive Resolution Change refers to dynamically changing the resolution within the video sequence, for example in video-conferencing use-cases. Adaptive Resolution Change may be used e.g. for better network adaptation and error resilience. For better adaptation to changing network requirements for different content, it may be desired to be able to change both the temporal/spatial resolution in addition to quality. The Adaptive Resolution Change may also enable a fast start, wherein the start-up time of a session may be able to be increased by first sending a low resolution frame and then increasing the resolution. The Adaptive Resolution Change may further be used in composing a conference. For example, when a person starts speaking, his/her corresponding resolution may be increased. Doing this with an IDR frame may cause a “blip” in the quality as IDR frames need to be coded at a relatively low quality so that the delay is not significantly increased.

In the following some details of an adaptive resolution change use-cases are described in more detail using a scalable video coding framework. As scalable video coding inherently includes mechanisms for resolution change, the adaptive resolution change could efficiently be supported. At an access unit where resolution switching takes place, two pictures may be encoded and/or decoded. The picture at the higher layer may be an IRAP picture, i.e. no inter prediction is used to encode or decode it, but inter-layer prediction may be used to encoder or decode it. The picture at the higher layer may be a skip picture, i.e. it might not enhance the lower-layer picture in terms of quality and/or other scalability dimensions, except for spatial resolution. Access units where no resolution change takes place may contain only one picture that may be inter predicted from earlier pictures in the same layer.

In VPS VUI of MV-HEVC and SHVC, the following syntax elements related to adaptive resolution change have been specified:

Descriptor

vps_vui( ){

| | |
|---|---|
| ... | |
| single_layer_for_non_irap_flag | u(1) |
| higher_layer_irap_skip_flag | u(1) |
| ... | |

The semantics of the above-described syntax elements may be specified as follows.

single_layer_for_non_irap_flag equal to 1 indicates either that all the VCL NAL units of an access unit have the same nuh_layer_id value or that two nuh_layer_id values are used by the VCL NAL units of an access unit and the picture with the greater nuh_layer_id value is an IRAP picture. single_layer_for_non_irap_flag equal to 0 indicates that the constraints implied by single_layer_for_non_irap_flag equal to 1 may or may not apply.

higher_layer_irap_skip_flag equal to 1 indicates that for every IRAP picture that refers to the VPS, for which there is another picture in the same access unit with a lower value of nuh_layer_id, the following constraints apply:

For all slices of the IRAP picture:
slice_type shall be equal to P.
slice_sao_luma_flag and slice_sao_chroma_flag shall both be equal to 0.
five_minus_max_num_merge_cand shall be equal to 4.
weighted_pred_flag shall be equal to 0 in the PPS that is referred to by the slices.

For all coding units of the IRAP picture:
cu_skip_flag[i][j] shall be equal to 1.
higher_layer_irap_skip_flag equal to 0 indicates that the above constraints may or may not apply.

An encoder may set both single_layer_for_non_irap_flag and higher_layer_irap_skip_flag equal to 1 as an indication to a decoder that whenever there are two pictures in the same access unit, the one with the higher nuh_layer_id is an IRAP picture for which the decoded samples can be derived by applying the resampling process for inter layer reference pictures with the other picture as input.

Various technologies for providing three-dimensional (3D) video content are currently investigated and developed. It may be considered that in stereoscopic or two-view video, one video sequence or view is presented for the left eye while a parallel view is presented for the right eye. More than two parallel views may be needed for applications which enable viewpoint switching or for autostereoscopic displays which may present a large number of views simultaneously and let the viewers to observe the content from different viewpoints. Intense studies have been focused on video coding for autostereoscopic displays and such multiview applications wherein a viewer is able to see only one pair of stereo video from a specific viewpoint and another pair of stereo video from a different viewpoint. One of the most feasible approaches for such multiview applications has turned out to be such wherein only a limited number of views, e.g. a mono or a stereo video plus some supplementary data, is provided to a decoder side and all required views are then rendered (i.e. synthesized) locally be the decoder to be displayed on a display.

Frame packing refers to a method where more than one frame is packed into a single frame at the encoder side as a pre-processing step for encoding and then the frame-packed frames are encoded with a conventional 2D video coding scheme. The output frames produced by the decoder therefore contain constituent frames that correspond to the input frames spatially packed into one frame in the encoder side. Frame packing may be used for stereoscopic video, where a pair of frames, one corresponding to the left eye/camera/view and the other corresponding to the right eye/camera/view, is packed into a single frame. Frame packing may also or alternatively be used for depth or disparity enhanced video, where one of the constituent frames represents depth or disparity information corresponding to another constituent frame containing the regular color information (luma and chroma information). Other uses of frame packing may also be possible. The use of frame-packing may be signaled in the video bitstream, for example using the frame packing arrangement SEI message of H.264/AVC or similar. The use of frame-packing may also or alternatively be indicated over video interfaces, such as High-Definition Multimedia Interface (HDMI). The use of frame-packing may also or alternatively be indicated and/or negotiated using various capability exchange and mode negotiation protocols, such as Session Description Protocol (SDP).

Frame packing may be utilized in frame-compatible stereoscopic video, where a spatial packing of a stereo pair into a single frame is performed at the encoder side as a pre-processing step for encoding and then the frame-packed frames are encoded with a conventional 2D video coding scheme. The output frames produced by the decoder contain constituent frames of a stereo pair. In a typical operation mode, the spatial resolution of the original frames of each view and the packaged single frame have the same resolution. In this case the encoder downsamples the two views of the stereoscopic video before the packing operation. The spatial packing may use for example a side-by-side or top-bottom format, and the downsampling should be performed accordingly.

A view may be defined as a sequence of pictures representing one camera or viewpoint. The pictures representing a view may also be called view components. In other words, a view component may be defined as a coded representation of a view in a single access unit. In multiview video coding, more than one view is coded in a bitstream. Since views are typically intended to be displayed on stereoscopic or multiview autostrereoscopic display or to be used for other 3D arrangements, they typically represent the same scene and are content-wise partly overlapping although representing different viewpoints to the content. Hence, inter-view prediction may be utilized in multiview video coding to take advantage of inter-view correlation and improve compression efficiency. One way to realize inter-view prediction is to include one or more decoded pictures of one or more other views in the reference picture list(s) of a picture being coded or decoded residing within a first view. View scalability may refer to such multiview video coding or multiview video bitstreams, which enable removal or omission of one or more coded views, while the resulting bitstream remains conforming and represents video with a smaller number of views than originally.

It has been proposed that frame-packed video may be enhanced in a manner that a separate enhancement picture is coded/decoded for each constituent frame of a frame-packed picture. For example, spatial enhancement pictures of constituent frames representing the left view may be provided within one enhancement layer and spatial enhancement pictures of a constituent frames representing the right view may be provided within another enhancement layer. For example, the Edition 9.0 of H.264/AVC specifies multi-resolution frame-compatible (MFC) enhancement for stereoscopic video coding and one profile making use of the MFC enhancement. In MFC, the base layer (a.k.a. base view) comprises frame-packed stereoscopic video, whereas each non-base view comprises a full-resolution enhancement of the one of the constituent views of the base layer.

As indicated earlier, MVC is an extension of H.264/AVC. Many of the definitions, concepts, syntax structures, semantics, and decoding processes of H.264/AVC apply also to MVC as such or with certain generalizations or constraints. Some definitions, concepts, syntax structures, semantics, and decoding processes of MVC are described in the following.

An access unit in MVC is defined to be a set of NAL units that are consecutive in decoding order and contain exactly one primary coded picture consisting of one or more view components. In addition to the primary coded picture, an access unit may also contain one or more redundant coded pictures, one auxiliary coded picture, or other NAL units not containing slices or slice data partitions of a coded picture. The decoding of an access unit results in one decoded picture consisting of one or more decoded view components, when decoding errors, bitstream errors or other errors which may affect the decoding do not occur. In other words, an access unit in MVC contains the view components of the views for one output time instance.

A view component in MVC is referred to as a coded representation of a view in a single access unit.

Inter-view prediction may be used in MVC and refers to prediction of a view component from decoded samples of different view components of the same access unit. In MVC, inter-view prediction is realized similarly to inter prediction. For example, inter-view reference pictures are placed in the same reference picture list(s) as reference pictures for inter prediction, and a reference index as well as a motion vector are coded or inferred similarly for inter-view and inter reference pictures.

An anchor picture is a coded picture in which all slices may reference only slices within the same access unit, i.e., inter-view prediction may be used, but no inter prediction is used, and all following coded pictures in output order do not use inter prediction from any picture prior to the coded picture in decoding order. Inter-view prediction may be used for IDR view components that are part of a non-base view. A base view in MVC is a view that has the minimum value of view order index in a coded video sequence. The base view can be decoded independently of other views and does not use inter-view prediction. The base view can be decoded by H.264/AVC decoders supporting only the single-view profiles, such as the Baseline Profile or the High Profile of H.264/AVC.

In the MVC standard, many of the sub-processes of the MVC decoding process use the respective sub-processes of the H.264/AVC standard by replacing term “picture”, “frame”, and “field” in the sub-process specification of the H.264/AVC standard by “view component”, “frame view component”, and “field view component”, respectively. Likewise, terms “picture”, “frame”, and “field” are often used in the following to mean “view component”, “frame view component”, and “field view component”, respectively.

As mentioned earlier, non-base views of MVC bitstreams may refer to a subset sequence parameter set NAL unit. A subset sequence parameter set for MVC includes a base SPS data structure and a sequence parameter set MVC extension data structure. In MVC, coded pictures from different views may use different sequence parameter sets. An SPS in MVC (specifically the sequence parameter set MVC extension part of the SPS in MVC) can contain the view dependency information for inter-view prediction. This may be used for example by signaling-aware media gateways to construct the view dependency tree.

In SVC and MVC, a prefix NAL unit may be defined as a NAL unit that immediately precedes in decoding order a VCL NAL unit for base layer/view coded slices. The NAL unit that immediately succeeds the prefix NAL unit in decoding order may be referred to as the associated NAL unit. The prefix NAL unit contains data associated with the associated NAL unit, which may be considered to be part of the associated NAL unit. The prefix NAL unit may be used to include syntax elements that affect the decoding of the base layer/view coded slices, when SVC or MVC decoding process is in use. An H.264/AVC base layer/view decoder may omit the prefix NAL unit in its decoding process.

In scalable multiview coding, the same bitstream may contain coded view components of multiple views and at least some coded view components may be coded using quality and/or spatial scalability.

There are ongoing standardization activities for depth-enhanced video coding where both texture views and depth views are coded.

A texture view refers to a view that represents ordinary video content, for example has been captured using an ordinary camera, and is usually suitable for rendering on a display. A texture view typically comprises pictures having three components, one luma component and two chroma components. In the following, a texture picture typically comprises all its component pictures or color components unless otherwise indicated for example with terms luma texture picture and chroma texture picture.

A depth view refers to a view that represents distance information of a texture sample from the camera sensor, disparity or parallax information between a texture sample and a respective texture sample in another view, or similar information. A depth view may comprise depth pictures (a.k.a. depth maps) having one component, similar to the luma component of texture views. A depth map is an image with per-pixel depth information or similar. For example, each sample in a depth map represents the distance of the respective texture sample or samples from the plane on which the camera lies. In other words, if the z axis is along the shooting axis of the cameras (and hence orthogonal to the plane on which the cameras lie), a sample in a depth map represents the value on the z axis. The semantics of depth map values may for example include the following:
1. Each luma sample value in a coded depth view component represents an inverse of real-world distance (Z) value, i.e. 1/Z, normalized in the dynamic range of the luma samples, such as to the range of 0 to 255, inclusive, for 8-bit luma representation. The normalization may be done in a manner where the quantization 1/Z is uniform in terms of disparity.
2. Each luma sample value in a coded depth view component represents an inverse of real-world distance (Z) value, i.e. 1/Z, which is mapped to the dynamic range of the luma samples, such as to the range of 0 to 255, inclusive, for 8-bit luma representation, using a mapping function f(1/Z) or table, such as a piece-wise linear mapping. In other words, depth map values result in applying the function f(1/Z).
3. Each luma sample value in a coded depth view component represents a real-world distance (Z) value normalized in the dynamic range of the luma samples, such as to the range of 0 to 255, inclusive, for 8-bit luma representation.
4. Each luma sample value in a coded depth view component represents a disparity or parallax value from the present depth view to another indicated or derived depth view or view position.

The semantics of depth map values may be indicated in the bitstream for example within a video parameter set syntax structure, a sequence parameter set syntax structure, a video usability information syntax structure, a picture parameter set syntax structure, a camera/depth/adaptation parameter set syntax structure, a supplemental enhancement information message, or anything alike.

While phrases such as depth view, depth view component, depth picture and depth map are used to describe various embodiments, it is to be understood that any semantics of depth map values may be used in various embodiments including but not limited to the ones described above. For example, embodiments of the invention may be applied for depth pictures where sample values indicate disparity values.

An encoding system or any other entity creating or modifying a bitstream including coded depth maps may create and include information on the semantics of depth samples and on the quantization scheme of depth samples into the bitstream. Such information on the semantics of depth samples and on the quantization scheme of depth samples may be for example included in a video parameter set structure, in a sequence parameter set structure, or in an SEI message.

Depth-enhanced video refers to texture video having one or more views associated with depth video having one or more depth views. A number of approaches may be used for representing of depth-enhanced video, including the use of video plus depth (V+D), multiview video plus depth (MVD), and layered depth video (LDV). In the video plus depth (V+D) representation, a single view of texture and the respective view of depth are represented as sequences of texture picture and depth pictures, respectively. The MVD representation contains a number of texture views and respective depth views. In the LDV representation, the texture and depth of the central view are represented conventionally, while the texture and depth of the other views are partially represented and cover only the dis-occluded areas required for correct view synthesis of intermediate views.

A texture view component may be defined as a coded representation of the texture of a view in a single access unit. A texture view component in depth-enhanced video bitstream may be coded in a manner that is compatible with a single-view texture bitstream or a multi-view texture bitstream so that a single-view or multi-view decoder can decode the texture views even if it has no capability to decode depth views. For example, an H.264/AVC decoder may decode a single texture view from a depth-enhanced H.264/AVC bitstream. A texture view component may alternatively be coded in a manner that a decoder capable of single-view or multi-view texture decoding, such H.264/AVC or MVC decoder, is not able to decode the texture view component for example because it uses depth-based coding tools. A depth view component may be defined as a coded representation of the depth of a view in a single access unit. A view component pair may be defined as a texture view component and a depth view component of the same view within the same access unit.

Depth-enhanced video may be coded in a manner where texture and depth are coded independently of each other. For example, texture views may be coded as one MVC bitstream and depth views may be coded as another MVC bitstream. Depth-enhanced video may also be coded in a manner where texture and depth are jointly coded. In a form of a joint coding of texture and depth views, some decoded samples of a texture picture or data elements for decoding of a texture picture are predicted or derived from some decoded samples of a depth picture or data elements obtained in the decoding process of a depth picture. Alternatively or in addition, some decoded samples of a depth picture or data elements for decoding of a depth picture are predicted or derived from some decoded samples of a texture picture or data elements obtained in the decoding process of a texture picture. In another option, coded video data of texture and coded video data of depth are not predicted from each other or one is not coded/decoded on the basis of the other one, but coded texture and depth view may be multiplexed into the same bitstream in the encoding and demultiplexed from the bitstream in the decoding. In yet another option, while coded video data of texture is not predicted from coded video data of depth in e.g. below slice layer, some of the high-level coding structures of texture views and depth views may be shared or predicted from each other. For example, a slice header of coded depth slice may be predicted from a slice header of a coded texture slice. Moreover, some of the parameter sets may be used by both coded texture views and coded depth views.

Depth-enhanced video formats enable generation of virtual views or pictures at camera positions that are not represented by any of the coded views. Generally, any depth-image-based rendering (DIBR) algorithm may be used for synthesizing views.

Work is also ongoing to specify depth-enhanced video coding extensions to the HEVC standard, which may be referred to as 3D-HEVC, in which texture views and depth views may be coded into a single bitstream where some of the texture views may be compatible with HEVC. In other words, an HEVC decoder may be able to decode some of the texture views of such a bitstream and can omit the remaining texture views and depth views.

In scalable and/or multiview video coding, at least the following principles for encoding pictures and/or access units with random access property may be supported.

A RAP picture within a layer may be an intra-coded picture without inter-layer/inter-view prediction. Such a picture enables random access capability to the layer/view it resides.

A RAP picture within an enhancement layer may be a picture without inter prediction (i.e. temporal prediction) but with inter-layer/inter-view prediction allowed. Such a picture enables starting the decoding of the layer/view the picture resides provided that all the reference layers/views are available. In single-loop decoding, it may be sufficient if the coded reference layers/views are available (which can be the case e.g. for IDR pictures having dependency_id greater than 0 in SVC). In multi-loop decoding, it may be needed that the reference layers/views are decoded. Such a picture may, for example, be referred to as a stepwise layer access (STLA) picture or an enhancement layer RAP picture.

An anchor access unit or a complete RAP access unit may be defined to include only intra-coded picture(s) and STLA pictures in all layers. In multi-loop decoding, such an access unit enables random access to all layers/views. An example of such an access unit is the MVC anchor access unit (among which type the IDR access unit is a special case).

A stepwise RAP access unit may be defined to include a RAP picture in the base layer but need not contain a RAP picture in all enhancement layers. A stepwise RAP access unit enables starting of base-layer decoding, while enhancement layer decoding may be started when the enhancement layer contains a RAP picture, and (in the case of multi-loop decoding) all its reference layers/views are decoded at that point.

In a scalable extension of HEVC or any scalable extension for a single-layer coding scheme similar to HEVC, IRAP pictures may be specified to have one or more of the following properties.

NAL unit type values of the IRAP pictures with nuh_layer_id greater than 0 may be used to indicate enhancement layer random access points.

An enhancement layer IRAP picture may be defined as a picture that enables starting the decoding of that enhancement layer when all its reference layers have been decoded prior to the EL IRAP picture.

Inter-layer prediction may be allowed for IRAP NAL units with nuh_layer_id greater than 0, while inter prediction is disallowed.

IRAP NAL units need not be aligned across layers. In other words, an access unit may contain both IRAP pictures and non-IRAP pictures.

After a BLA picture at the base layer, the decoding of an enhancement layer is started when the enhancement layer contains a IRAP picture and the decoding of all of its reference layers has been started. In other words, a BLA picture in the base layer starts a layer-wise start-up process.

When the decoding of an enhancement layer starts from a CRA picture, its RASL pictures are handled similarly to RASL pictures of a BLA picture (in HEVC version 1).

Scalable bitstreams with IRAP pictures or similar that are not aligned across layers may be used for example more frequent IRAP pictures can be used in the base layer, where they may have a smaller coded size due to e.g. a smaller spatial resolution. A process or mechanism for layer-wise start-up of the decoding may be included in a video decoding scheme. Decoders may hence start decoding of a bitstream when a base layer contains an IRAP picture and step-wise start decoding other layers when they contain IRAP pictures. In other words, in a layer-wise start-up of the decoding process, decoders progressively increase the number of decoded layers (where layers may represent an enhancement in spatial resolution, quality level, views, additional components such as depth, or a combination) as subsequent pictures from additional enhancement layers are decoded in the decoding process. The progressive increase of the number of decoded layers may be perceived for example as a progressive improvement of picture quality (in case of quality and spatial scalability).

A layer-wise start-up mechanism may generate unavailable pictures for the reference pictures of the first picture in decoding order in a particular enhancement layer. Alternatively, a decoder may omit the decoding of pictures preceding the IRAP picture from which the decoding of a layer can be started. These pictures that may be omitted may be specifically labeled by the encoder or another entity within the bitstream. For example, one or more specific NAL unit types may be used for them. These pictures may be referred to as cross-layer random access skip (CL-RAS) pictures.

A layer-wise start-up mechanism may start the output of enhancement layer pictures from an IRAP picture in that enhancement layer, when all reference layers of that enhancement layer have been initialized similarly with an IRAP picture in the reference layers. In other words, any pictures (within the same layer) preceding such an IRAP picture in output order might not be output from the decoder and/or might not be displayed. In some cases, decodable leading pictures associated with such an IRAP picture may be output while other pictures preceding such an IRAP picture might not be output.

Concatenation of coded video data, which may also be referred to as splicing, may occur for example coded video sequences are concatenated into a bitstream that is broadcast or streamed or stored in a mass memory. For example, coded video sequences representing commercials or advertisements may be concatenated with movies or other “primary” content.

Scalable video bitstreams might contain IRAP pictures that are not aligned across layers. It may, however, be convenient to enable concatenation of a coded video sequence that contains an IRAP picture in the base layer in its first access unit but not necessarily in all layers. A second coded video sequence that is spliced after a first coded video sequence should trigger a layer-wise decoding start-up process. That is because the first access unit of said second coded video sequence might not contain an IRAP picture in all its layers and hence some reference pictures for the non-IRAP pictures in that access unit may not be available (in the concatenated bitstream) and cannot therefore be decoded. The entity concatenating the coded video sequences, hereafter referred to as the splicer, should therefore modify the first access unit of the second coded video sequence such that it triggers a layer-wise start-up process in decoder(s).

Indication(s) may exist in the bitstream syntax to indicate triggering of a layer-wise start-up process. These indication(s) may be generated by encoders or splicers and may be obeyed by decoders. These indication(s) may be used for particular picture type(s) or NAL unit type(s) only, such as only for IDR pictures, while in other embodiments these indication(s) may be used for any picture type(s). Without loss of generality, an indication called cross_layer_bla_flag that is considered to be included in a slice segment header is referred to below. It should be understood that a similar indication with any other name or included in any other syntax structures could be additionally or alternatively used.

Independently of indication(s) triggering a layer-wise start-up process, certain NAL unit type(s) and/or picture type(s) may trigger a layer-wise start-up process. For example, a base-layer BLA picture may trigger a layer-wise start-up process.

A layer-wise start-up mechanism may be initiated in one or more of the following cases:

At the beginning of a bitstream.

At the beginning of a coded video sequence, when specifically controlled, e.g. when a decoding process is started or re-started e.g. as response to tuning into a broadcast or seeking to a position in a file or stream. The decoding process may input an variable, e.g. referred to as NoClrasOutputFlag, that may be controlled by external means, such as the video player or alike.

A base-layer BLA picture.

A base-layer IDR picture with cross_layer_bla_flag equal to 1. (Or a base-layer IRAP picture with cross_layer_bla_flag equal to 1.)

When a layer-wise start-up mechanism is initiated, all pictures in the DPB may be marked as “unused for reference”. In other words, all pictures in all layers may be marked as “unused for reference” and will not be used as a reference for prediction for the picture initiating the layer-wise start-up mechanism or any subsequent picture in decoding order.

Cross-layer random access skipped (CL-RAS) pictures may have the property that when a layer-wise start-up mechanism is invoked (e.g. when NoClrasOutputFlag is equal to 1), the CL-RAS pictures are not output and may not be correctly decodable, as the CL-RAS picture may contain references to pictures that are not present in the bitstream. It may be specified that CL-RAS pictures are not used as reference pictures for the decoding process of non-CL-RAS pictures.

CL-RAS pictures may be explicitly indicated e.g. by one or more NAL unit types or slice header flags (e.g. by re-naming cross_layer_bla_flag to cross_layer_constraint_flag and re-defining the semantics of cross_layer_bla_flag for non-IRAP pictures). A picture may be considered as a CL-RAS picture when it is a non-IRAP picture (e.g. as determined by its NAL unit type), it resides in an enhancement layer and it has cross_layer_constraint_flag (or similar) equal to 1. Otherwise, a picture may be classified of being a non-CL-RAS picture. cross_layer_bla_flag may be inferred to be equal to 1 (or a respective variable may be set to 1), if the picture is an IRAP picture (e.g. as determined by its NAL unit type), it resides in the base layer, and cross_layer_constraint_flag is equal to 1. Otherwise, cross_layer_bla_flag may inferred to be equal to 0 (or a respective variable may be set to 0). Alternatively, CL-RAS pictures may be inferred. For example, a picture with nuh_layer_id equal to layerId may be inferred to be a CL-RAS picture when the LayerInitializedFlag[layerId] is equal to 0.

A decoding process may be specified in a manner that a certain variable controls whether or not a layer-wise start-up process is used. For example, a variable NoClrasOutputFlag may be used, which, when equal to 0, indicates a normal decoding operation, and when equal to 1, indicates a layer-wise start-up operation. NoClrasOutputFlag may be set for example using one or more of the following steps:

1) If the current picture is an IRAP picture that is the first picture in the bitstream, NoClrasOutputFlag is set equal to 1.
2) Otherwise, if some external means are available to set the variable NoClrasOutputFlag equal to a value for a base-layer IRAP picture, the variable NoClrasOutputFlag is set equal to the value provided by the external means.
3) Otherwise, if the current picture is a BLA picture that is the first picture in a coded video sequence (CVS), NoClrasOutputFlag is set equal to 1.
4) Otherwise, if the current picture is an IDR picture that is the first picture in a coded video sequence (CVS) and cross_layer_bla_flag is equal to 1, NoClrasOutputFlag is set equal to 1.
5) Otherwise, NoClrasOutputFlag is set equal to 0.

Step 4 above may alternatively be phrased more generally for example as follows: “Otherwise, if the current picture is an IRAP picture that is the first picture in a CVS and an indication of layer-wise start-up process is associated with the IRAP picture, NoClrasOutputFlag is set equal to 1.” Step 3 above may be removed, and the BLA picture may be specified to initiate a layer-wise start-up process (i.e. set NoClrasOutputFlag equal to 1), when cross_layer_bla_flag for it is equal to 1. It should be understood that other ways to phrase the condition are possible and equally applicable.

A decoding process for layer-wise start-up may be for example controlled by two array variables LayerInitializedFlag[i] and FirstPicInLayerDecodedFlag[i] which may have entries for each layer (possibly excluding the base layer and possibly other independent layers too). When the layer-wise start-up process is invoked, for example as response to NoClrasOutputFlag being equal to 1, these array variables may be reset to their default values. For example, when there 64 layers are enabled (e.g. with a 6-bit nuh_layer_id), the variables may be reset as follows: the variable LayerInitializedFlag[i] is set equal to 0 for all values of i from 0 to 63, inclusive, and the variable FirstPicInLayerDecodedFlag[i] is set equal to 0 for all values of i from 1 to 63, inclusive.

The decoding process may include the following or similar to control the output of RASL pictures. When the current picture is an IRAP picture, the following applies:

If LayerInitializedFlag[nuh_layer_id] is equal to 0, the variable NoRaslOutputFlag is set equal to 1.

Otherwise, if some external means is available to set the variable HandleCraAsBlaFlag to a value for the current picture, the variable HandleCraAsBlaFlag is set equal to the value provided by the external means and the variable NoRaslOutputFlag is set equal to HandleCraAsBlaFlag.

Otherwise, the variable HandleCraAsBlaFlag is set equal to 0 and the variable NoRaslOutputFlag is set equal to 0.

The decoding process may include the following to update the LayerInitializedFlag for a layer. When the current picture is an IRAP picture and either one of the following is true, LayerInitializedFlag[nuh_layer_id] is set equal to 1.

nuh_layer_id is equal to 0.

LayerInitializedFlag[nuh_layer_id] is equal to 0 and LayerInitializedFlag[refLayerId] is equal to 1 for all values of refLayerId equal to RefLayerId[nuh_layer_id][j], where j is in the range of 0 to NumDirectRefLayers[nuh_layer_id]−1, inclusive.

When FirstPicInLayerDecodedFlag[nuh_layer_id] is equal to 0, the decoding process for generating unavailable reference pictures may be invoked prior to decoding the current picture. The decoding process for generating unavailable reference pictures may generate pictures for each picture in a reference picture set with default values. The process of generating unavailable reference pictures may be primarily specified only for the specification of syntax constraints for CL-RAS pictures, where a CL-RAS picture may be defined as a picture with nuh_layer_id equal to layerId and LayerInitializedFlag[layerId] is equal to 0. In HRD operations, CL-RAS pictures may need to be taken into consideration in derivation of CPB arrival and removal times. Decoders may ignore any CL-RAS pictures, as these pictures are not specified for output and have no effect on the decoding process of any other pictures that are specified for output.

A coding standard or system may refer to a term operation point or alike, which may indicate the scalable layers and/or sub-layers under which the decoding operates and/or may be associated with a sub-bitstream that includes the scalable layers and/or sub-layers being decoded. Some non-limiting definitions of an operation point are provided in the following.

In HEVC, an operation point is defined as bitstream created from another bitstream by operation of the sub-bitstream extraction process with the another bitstream, a target highest TemporalId, and a target layer identifier list as inputs.

The VPS of HEVC specifies layer sets and HRD parameters for these layer sets. A layer set may be used as the target layer identifier list in the sub-bitstream extraction process.

In SHVC and MV-HEVC, an operation point definition may include a consideration a target output layer set. In SHVC and MV-HEVC, an operation point may be defined as a bitstream that is created from another bitstream by operation of the sub-bitstream extraction process with the another bitstream, a target highest TemporalId, and a target layer identifier list as inputs, and that is associated with a set of target output layers.

An output layer set may be defined as a set of layers consisting of the layers of one of the specified layer sets, where one or more layers in the set of layers are indicated to be output layers. An output layer may be defined as a layer of an output layer set that is output when the decoder and/or the HRD operates using the output layer set as the target output layer set. In MV-HEVC/SHVC, the variable TargetOptLayerSetIdx may specify which output layer set is the target output layer set by setting TargetOptLayerSetIdx equal to the index of the output layer set that is the target output layer set. TargetOptLayerSetIdx may be set for example by the HRD and/or may be set by external means, for example by a player or alike through an interface provided by the decoder. In MV-HEVC/SHVC, a target output layer may be defined as a layer that is to be output and is one of the output layers of the output layer set with index olsIdx such that TargetOptLayerSetIdx is equal to olsIdx.

MV-HEVC/SHVC enable derivation of a “default” output layer set for each layer set specified in the VPS using a specific mechanism or by indicating the output layers explicitly. Two specific mechanisms have been specified: it may be specified in the VPS that each layer is an output layer or that only the highest layer is an output layer in a “default” output layer set. Auxiliary picture layers may be excluded from consideration when determining whether a layer is an output layer using the mentioned specific mechanisms. In addition, to the “default” output layer sets, the VPS extension enables to specify additional output layer sets with selected layers indicated to be output layers.

In MV-HEVC/SHVC, a profile_tier_level( ) syntax structure is associated for each output layer set. To be more exact, a list of profile_tier_level( ) syntax structures is provided in the VPS extension, and an index to the applicable profile_tier_level( ) within the list is given for each output layer set. In other words, a combination of profile, tier, and level values is indicated for each output layer set.

While a constant set of output layers suits well use cases and bitstreams where the highest layer stays unchanged in each access unit, they may not support use cases where the highest layer changes from one access unit to another. It has therefore been proposed that encoders can specify the use of alternative output layers within the bitstream and in response to the specified use of alternative output layers decoders output a decoded picture from an alternative output layer in the absence of a picture in an output layer within the same access unit. Several possibilities exist how to indicate alternative output layers. For example, each output layer in an output layer set may be associated with a minimum alternative output layer, and output-layer-wise syntax element(s) may be used for specifying alternative output layer(s) for each output layer. Alternatively, the alternative output layer set mechanism may be constrained to be used only for output layer sets containing only one output layer, and output-layer-set-wise syntax element(s) may be used for specifying alternative output layer(s) for the output layer of the output layer set. Alternatively, the alternative output layer set mechanism may be constrained to be used only for bitstreams or CVSs in which all specified output layer sets contain only one output layer, and the alternative output layer(s) may be indicated by bitstream- or CVS-wise syntax element(s). The alternative output layer(s) may be for example specified by listing e.g. within VPS the alternative output layers (e.g. using their layer identifiers or indexes of the list of direct or indirect reference layers), indicating a minimum alternative output layer (e.g. using its layer identifier or its index within the list of direct or indirect reference layers), or a flag specifying that any direct or indirect reference layer is an alternative output layer. When more than one alternative output layer is enabled to be used, it may be specified that the first direct or indirect inter-layer reference picture present in the access unit in descending layer identifier order down to the indicated minimum alternative output layer is output.

A HRD for a scalable video bitstream may operate similarly to a HRD for a single-layer bitstream. However, some changes may be required or desirable, particularly when it comes to the DPB operation in multi-loop decoding of a scalable bitstream. It is possible to specify DPB operation for multi-loop decoding of a scalable bitstream in multiple ways. In a layer-wise approach, each layer may have conceptually its own DPB, which may otherwise operate independently but some DPB parameters may be provided jointly for all the layer-wise DPBs and picture output may operate synchronously so that the pictures having the same output time are output at the same time or, in output order conformance checking, pictures from the same access unit are output next to each other. In another approach, referred to as the resolution-specific approach, layers having the same key properties share the same sub-DPB. The key properties may include one or more of the following: picture width, picture height, chroma format, bitdepth, color format/gamut.

It may be possible to support both layer-wise and resolution-specific DPB approach with the same DPB model, which may be referred to as the sub-DPB model. The DPB is partitioned into several sub-DPBs, and each sub-DPB is otherwise managed independently but some DPB parameters may be provided jointly for all the sub-DPBs and picture output may operate synchronously so that the pictures having the same output time are output at the same time or, in output order conformance checking, pictures from the same access unit are output next to each other.

The DPB may be considered to be logically partitioned into sub-DPBs and each sub-DPB contains picture storage buffers. Each sub-DPB may be associated with a layer (in a layer-specific mode) or all layers of a particular combination of resolution, chroma format and bit depth (in a so-called resolution-specific mode), and all pictures in the layer(s) may be stored in the associated sub-DPB. The operation of sub-DPBs may be independent of each other—in terms of insertion, marking, and removal of decoded pictures as well as the size of each sub-DPB, though the output of decoded pictures from different sub-DPBs may be linked through their output times or picture order count values. In the resolution-specific mode, encoders may provide the number of picture buffers per sub-DPB and/or per layer, and decoders or the HRD may use either or both types of the number of picture buffer in their buffering operation. For example, in output order conforming decoding, a bumping process may be invoked when the number of stored pictures in a layer meets or exceeds a specified per-layer number of picture buffers and/or when the number of pictures stored in a sub-DPB meets or exceeds a specified number of picture buffers for that sub-DPB.

In the present drafts of MV-HEVC and SHVC, the DPB characteristics are included in the DPB size syntax structure, which may also be referred to as dpb_size( ). The DPB size syntax structure is included in the VPS extension. The DPB size syntax structure contains for each output layer set (except the 0-th output layer set that only contains the base layer), the following pieces of information may be present for each sub-layer (up to the maximum sub-layer) or may be inferred to be equal to the respective information that applies to the lower sub-layer:
max_vps_dec_pic_buffering_minus1 [i][k][j] plus 1 specifies the maximum required size of the k-th sub-DPB for the CVS in the i-th output layer set in units of picture storage buffers for the maximum TemporalId (i.e. HighestTid) equal to j
max_vps_layer_dec_pic_buff_minus 1 [i][k][j] plus 1 specifies the maximum number of decoded pictures, of the k-th layer for the CVS in the i-th output layer set, that need to be stored in the DPB when HighestTid is equal to j.
max_vps_num_reorder_pics[i][j] specifies, when HighestTid is equal to j, the maximum allowed number of access units containing a picture with PicOutputFlag equal to 1 that can precede any access unit auA that contains a picture with PicOutputFlag equal to 1 in the i-th output layer set in the CVS in decoding order and follow the access unit auA that contains a picture with PicOutputFlag equal to 1 in output order.
max_vps_latency_increase_plus1[i][j] not equal to 0 is used to compute the value of VpsMaxLatencyPictures[i][j], which, when HighestTid is equal to j, specifies the maximum number of access units containing a picture with PicOutputFlag equal to 1 in the i-th output layer set that can precede any access unit auA that contains a picture with PicOutputFlag equal to 1 in the CVS in output order and follow the access unit auA that contains a picture with PicOutputFlag equal to 1 in decoding order.

Several approaches have been proposed for the POC value derivation for HEVC extensions, such as MV-HEVC and SHVC. In the following, an approach is described, referred to as a POC reset approach. This POC derivation approach is described as an example of POC derivation with which different embodiments can be realized. It needs to be understood that the described embodiments can be realized with any POC derivation and the description of the POC reset approach is merely a non-limiting example.

A POC reset approach is based on indicating within a slice header that POC values are to be reset so that the POC of the current picture is derived from the provided POC signaling for the current picture and the POCs of the earlier pictures, in decoding order, are decremented by a certain value.

Altogether four modes of POC resetting may be performed:
POC MSB reset in the current access unit. This can be used when an enhancement layer contains an

IRAP picture. (This mode is indicated in the syntax by poc_reset_idc equal to 1.)
Full POC reset (both MSB and LSB to 0) in the current access unit. This can be used when the base layer contains an IDR picture. (This mode is indicated in the syntax by poc_reset_idc equal to 2.)
“Delayed” POC MSB reset. This can be used for a picture of nuh_layer_id equal to nuhLayerId such that there was no picture in of nuh_layer_id equal to nuhLayerId in the earlier access unit (in decoding order) that caused a POC MSB reset. (This mode is indicated in the syntax by poc_reset_idc equal to 3 and full_poc_reset_flag equal to 0.)
“Delayed” full POC reset. This can be used for a picture of nuh_layer_id equal to nuhLayerId such that there was no picture in of nuh_layer_id equal to nuhLayerId in the earlier access unit (in decoding order) that caused a full POC reset. (This mode is indicated in the syntax by poc_reset_idc equal to 3 and full_poc_reset_flag equal to 1.)

The “delayed” POC reset signaling can also be used for error resilience purpose (to provide resilience against a loss of a previous picture in the same layer including the POC reset signaling).

A concept of POC resetting period may be specified based on the POC resetting period ID, which may be indicated for example using the syntax element poc_reset_period_id, which may be present in the slice segment header extension. Each non-IRAP picture that belongs to an access unit that contains at least one IRAP picture may be the start of a POC resetting period in the layer containing the non-IRAP picture. In that access unit, each picture would be the start of a POC resetting period in the layer containing the picture. POC resetting and update of POC values of same-layer pictures in the DPB are applied only for the first picture within each POC resetting period.

POC values of earlier pictures of all layers in the DPB may be updated at the beginning of each access unit that requires POC reset and starts a new POC resetting period (before the decoding of the first picture received for the access unit but after parsing and decoding of the slice header information of the first slice of that picture). Alternatively, POC values of earlier pictures of the layer of the present picture in the DPB may be updated at the beginning of decoding a picture that is the first picture in the layer for a POC resetting period. Alternatively, POC values of earlier pictures of the layer tree of the present picture in the DPB may be updated at the beginning of decoding a picture that is the first picture in the layer tree for a POC resetting period. Alternatively, POC values of earlier pictures of the current layer and its direct and indirect reference layer in the DPB may be updated (if not updated already) at the beginning of decoding a picture that is the first picture in the layer for a POC resetting period.

For derivation of the delta POC value used for updating the POC values of the same-layer pictures in the DPB as well as for derivation of the POC MSB of the POC value of the current picture, a POC LSB value (poc_lsb_val syntax element) is conditionally signalled in the slice segment header (for the “delayed” POC reset modes as well as for base-layer pictures with full POC reset, such as base-layer IDR pictures). When “delayed” POC reset modes are used, poc_lsb_val may be set equal to the value POC LSB (slice_pic_order_cnt_lsb) of the access unit in which the POC was reset. When a full POC reset is used in the base layer, the poc_lsb_val may be set equal to POC LSB of prevTidOPic (as specified earlier).

For the first picture, in decoding order, with a particular nuh_layer_id value and within a POC resetting period, a value DeltaPocVal is derived in subtracted from the pictures that are currently in the DPB. A basic idea is that for POC MSB reset, DeltaPocVal is equal to MSB part of the POC value of the picture triggering the resetting and for the full POC reset, DeltaPocVal is equal to the POC of the picture triggering the POC reset (while delayed POC resets are treated somewhat differently). The PicOrderCntVal values of all decoded pictures of all layers or the present layer or the present layer tree in the DPB, are decremented by the value of DeltaPocVal. Consequently, a basic idea is that after the POC MSB reset, the pictures in the DPB may have POC values up to MaxPicOrderCntLsb (exclusive), and after the full POC reset, the pictures in the DPB may have POC values up to 0 (exclusive), while again the delayed POC reset is handled a bit differently.

An access unit for scalable video coding may be defined in various ways including but not limited to the definition of an access unit for HEVC as described earlier. For example, the access unit definition of HEVC may be relaxed so that an access unit is required to include coded pictures associated with the same output time and belonging to the same layer tree. When the bitstream has multiple layer trees, an access unit may but is not required to include coded pictures associated with the same output time and belonging to different layer trees.

Many video encoders utilize the Lagrangian cost function to find rate-distortion optimal coding modes, for example the desired macroblock mode and associated motion vectors. This type of cost function uses a weighting factor or λ to tie together the exact or estimated image distortion due to lossy coding methods and the exact or estimated amount of information required to represent the pixel/sample values in an image area. The Lagrangian cost function may be represented by the equation:

C=D+λR

where C is the Lagrangian cost to be minimised, D is the image distortion (for example, the mean-squared error between the pixel/sample values in original image block and in coded image block) with the mode and motion vectors currently considered, λ is a Lagrangian coefficient and R is the number of bits needed to represent the required data to reconstruct the image block in the decoder (including the amount of data to represent the candidate motion vectors).

A coding standard may include a sub-bitstream extraction process, and such is specified for example in SVC, MVC, and HEVC. The sub-bitstream extraction process relates to converting a bitstream by removing NAL units to a sub-bitstream. The sub-bitstream still remains conforming to the standard. For example, in a draft HEVC standard, the bitstream created by excluding all VCL NAL units having a temporal_id greater than a selected value and including all other VCL NAL units remains conforming. In another version of the a draft HEVC standard, the sub-bitstream extraction process takes a TemporalId and/or a list of LayerId values as input and derives a sub-bitstream (also known as a bitstream subset) by removing from the bitstream all NAL units with TemporalId greater than the input TemporalId value or layer_id value not among the values in the input list of LayerId values.

In a draft HEVC standard, the operation point the decoder uses may be set through variables TargetDecLayerIdSet and HighestTid as follows. The list TargetDecLayerIdSet, which specifies the set of values for layer_id of VCL NAL units to be decoded, may be specified by external means, such as decoder control logic. If not specified by external means, the list TargetDecLayerIdSet contains one value for layer_id, which indicates the base layer (i.e. is equal to 0 in a draft HEVC standard). The variable HighestTid, which identifies the highest temporal sub-layer, may be specified by external means. If not specified by external means, HighestTid is set to the highest TemporalId value that may be present in the coded video sequence or bitstream, such as the value of sps_max_sub_layers_minus1 in a draft HEVC standard. The sub-bitstream extraction process may be applied with TargetDecLayerIdSet and HighestTid as inputs and the output assigned to a bitstream referred to as BitstreamToDecode. The decoding process may operate for each coded picture in BitstreamToDecode.

As described above, HEVC enables coding of interlaced source content either as fields or frames (representing complementary field pairs) and also includes sophisticated signaling related to the type of the source content and its intended presentation. Many embodiments of the present invention realize picture-adaptive frame-field coding utilizing coding/decoding algorithms which may avoid the need of intra-coding when switching between coded fields and frames.

In an example embodiment, a coded frame representing a complementary field pair resides in a different scalability layer than a pair of coded fields, and one or both fields of the pair of the coded fields may be used as reference for predicting the coded frame or vice versa. Therefore, picture-adaptive frame-field coding may be enabled without adapting low-level coding tools according to the type of the current picture and/or reference picture (coded frame or coded field) and/or according to source signal type (interlaced or progressive).

An encoder may determine to encode a complementary field pair as a coded frame or as two coded fields for example on the basis of rate-distortion optimization as described earlier. For example, if a coded frame yields a smaller cost of the Lagrangian cost function than the cost of two coded fields, the encoder may choose to encode a complementary field pair as a coded frame.

FIG. 9 illustrates an example where coded fields 102, 104 reside in the base layer (BL) and coded frames 106 containing complementary field pairs of interlaced source content reside in the enhancement layer (EL). In FIG. 9 as well as in some subsequent figures, tall rectangles may represent frames (e.g. 106), small non-filled rectangles (e.g. 102) may represent fields of a certain field parity (e.g. an odd field), and small diagonally striped rectangles (e.g. 104) may represent fields of an opposite field parity (e.g. an even field). Inter prediction of any prediction hierarchy may be used within a layer. When an encoder determines to switch from field coding to frame coding, it may code a skip picture 108 in this example. The skip picture 108 is illustrated as a black rectangle. The skip picture 108 may be used similarly to any other picture as a reference for inter prediction of later pictures, in (de)coding order, within the same layer. The skip picture 108 may be indicated not to be output or displayed by a decoder (e.g. by setting pic_output_flag of HEVC equal to 0). No base-layer pictures need to be coded into the same access units or for the same time instants as represented by the enhancement layer pictures. When the encoder determines to switch back from frame coding to field coding, it may (but does not need to) use earlier base-layer pictures as reference(s) for prediction, as exemplified by the arrows 114, 116 in the FIG. 9. The rectangles 100 illustrate the interlaced source signal, which may, for example, illustrate the signal provided for the encoder as input.

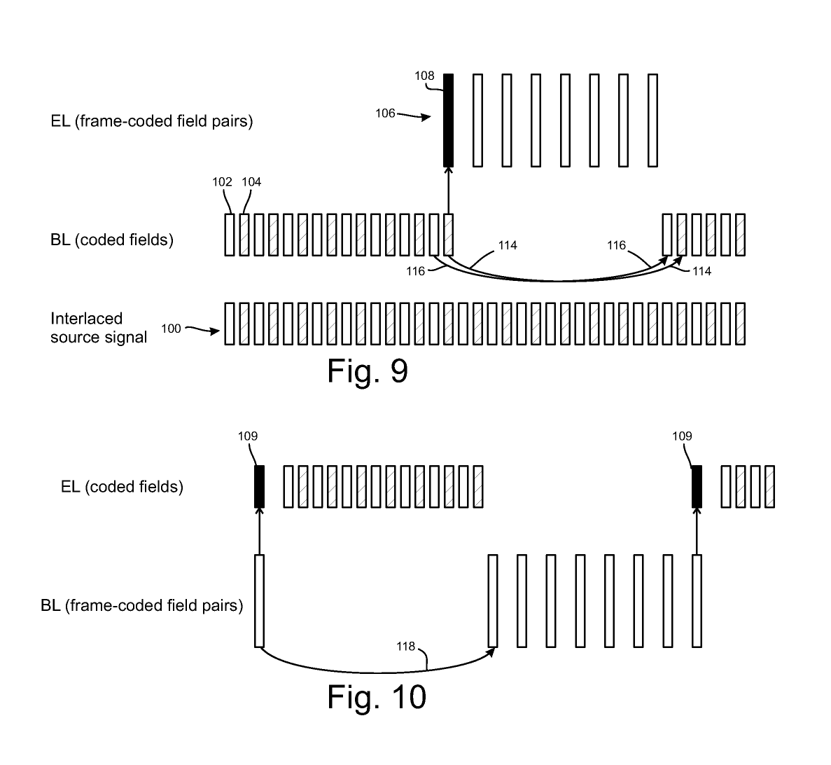

FIG. 10 illustrates an example where coded frames containing complementary field pairs of interlaced source content reside in the base layer BL and coded fields reside in the enhancement layer EL. Otherwise, the coding is similar to that in FIG. 9. In the illustration of FIG. 10 switching from frame coding to field coding occurs at the left-most frame on the base layer, wherein a skip field 109 may be provided on the higher layer, in this example on the enhancement layer EL. At a later stage switching may occur back to the frame coding wherein one or more previous frames on the base layer may, but need not, be used in predicting the next frame of the base layer. Also another switching from frame coding to field coding is illustrated in FIG. 10.

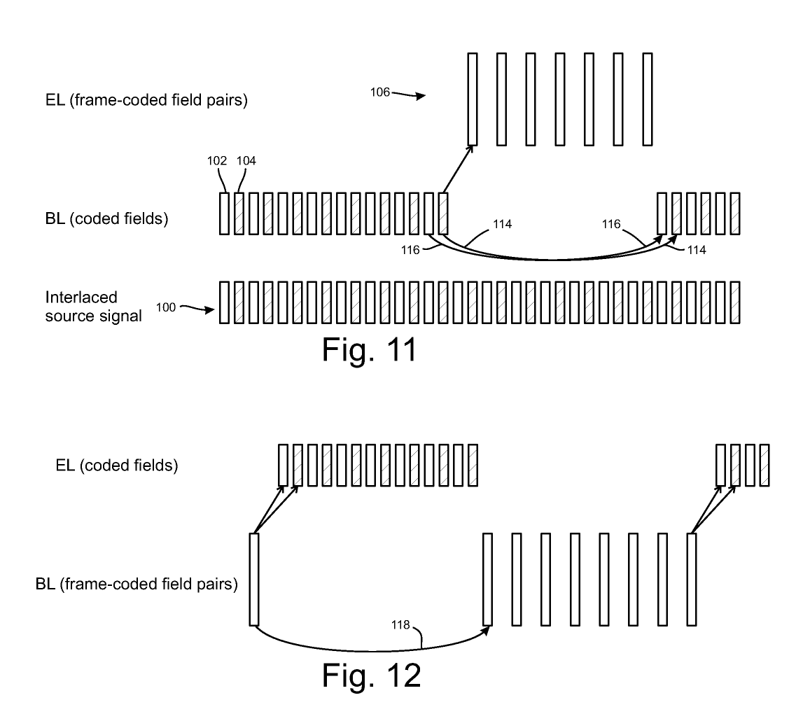

FIG. 11 and FIG. 12 present similar examples as those in FIG. 9 and FIG. 10, respectively, but diagonal inter-layer prediction is used instead of skip pictures. In the example of FIG. 11, when switching from field coding to frame coding occurs, the first frame on the enhancement layer EL is diagonally predicted from the latest field of the base layer stream. When switching back from the frame coding to field coding, the next field(s) may be predicted from the latest field(s) which were encoded/decoded before the previous switching from field coding to frame coding. This is illustrated with the arrows 114, 116 in FIG. 11. In the example of FIG. 12, when switching from frame coding to field coding occurs, the first two fields on the enhancement layer EL are diagonally predicted from the latest frame of the base layer stream. When switching back from the field coding to frame coding the next frame may be predicted from the latest frame which were encoded/decoded before the previous switching from frame coding to field coding. This is illustrated with the arrow 118 in FIG. 12.

In the following some non-limiting example embodiments for locating coded fields and coded frames into layers are shortly described. In an example embodiment there is provided a kind of a “staircase” of frame- and field-coded layers as depicted in FIG. 13. According to this example, when a switch from coded frames to coded fields or vice versa is made, a next highest layer is taken into use to enable the use of inter-layer prediction from coded frame(s) to coded field(s) or vice versa. In the example situation depicted in FIG. 13, skip pictures 108, 109 are coded at the switch-to layer, when a switch from coded frames to coded fields or vice versa is made, but a coding arrangement could be similarly realized with diagonal inter-layer prediction. In FIG. 13 the base layer contains coded fields 100 of an interlaced source signal. At the location where switching from the coded fields to coded frames is intended to occur, a skip frame 108 is provided on a higher layer, in this example on the first enhancement layer EL1, followed by frame-coded field pairs 106. The skip frame 108 may be formed by using inter-layer prediction from the lower layer (e.g. the switching from layer). At the location where switching from the coded frames to coded fields is intended to occur, another skip frame 109 is provided on a yet higher layer, in this example on the second enhancement layer EL2, followed by coded fields 112. Switching between coded frames and coded fields may be realized with inter-layer prediction until the maximum layer is reached. When an IDR or BLA picture (or alike) is coded, that picture may be coded at the lowest layer (either BL or EL1) containing coded frames or coded fields depending on whether the IDR or BLA picture is determined to be coded as a coded frame or a coded field, respectively. It is to be understood that while FIG. 13 illustrated an arrangement where the base layer contains coded fields, a similar arrangement can be realized where the base layer contains coded frames, the first enhancement layer (EL1) contains coded fields, the second enhancement layer (EL2) contains coded frames, the third enhancement layer (EL3) contains coded fields, and so on.

An encoder may indicate the use of adaptive resolution change for a bitstream encoded using a “staircase” of frame- and field-coded layers as depicted in FIG. 13. For example, the encoder may set single_layer_for_non_irap_flag equal to 1 in VPS VUI of a bitstream coded with MV-HEVC, SHVC, and/or alike. An encoder may indicate the use of skip pictures for a bitstream encoded using a “staircase” of frame- and field-coded layers as depicted in FIG. 13. For example, the encoder may set higher_layer_irap_skip_flag equal to 1 in VPS VUI of a bitstream coded with MV-HEVC, SHVC, and/or alike.

If resolution-specific sub-DPB operation is in use, as described earlier, layers that share the same key properties, such as picture width, picture height, chroma format, bit-depth, and/or color format/gamut, share the same sub-DPB. For example, with reference to FIG. 13, the BL and EL2 may share the same sub-DPB. Generally, in the example embodiment wherein a “staircase” of frame- and field-coded layers is encoded and/or decoded, as described in the previous paragraph, many layers may share the same sub-DPB. As described earlier, a reference picture set is decoded when starting to decode a picture in HEVC and its extensions. Consequently, when the decoding of a picture is finished, that picture and all its reference pictures remain to be marked as “used for reference” and hence remain to be present in the DPB. These reference pictures may be marked as “unused for reference” at the earliest when the next picture in the same layer is decoded, and the current picture may be marked as “unused for reference” either when the next picture in the same layer is decoded (if the current picture is not a sub-layer non-reference picture at the highest TemporalId being decoded) or when all pictures that may use the current picture as reference for inter-layer prediction have been decoded (when the he current picture is a sub-layer non-reference picture at the highest TemporalId being decoded). Consequently, many pictures may remain to be marked as “used for reference” and remain to occupy picture storage buffers in the DPB, even though they are not going to be used as reference for any subsequent pictures in decoding order.

In an embodiment, which may be applied independently of or together with other embodiments, particularly the embodiment described with reference to FIG. 13, an encoder or another entity may include commands or alike into the bitstream that cause reference picture marking as “unused for reference” of a picture on a certain layer sooner than when the decoding of the next picture of that layer is started. Examples of such commands include but are not limited to the following:
Include the reference picture set (RPS) to be applied after the decoding of the picture within the layer into the bitstream. Such an RPS may be referred to as a post-decoding RPS. A post-decoding RPS may be applied for example when the decoding of the picture has been finished, prior to decoding the next picture in decoding order. If the picture at the current layer may be used as reference for inter-layer prediction, a post-decoding RPS decoded when the decoding of the picture has been finished may not mark the current picture as “unused for reference”, because it may still be used as a reference for inter-layer prediction. Alternatively, a post-decoding RPS may be applied for example after the decoding of the access unit has been finished (which guarantees that no picture that is still used as a reference for inter-layer prediction becomes marked as “unused for reference”). A post-decoding RPS may be included for example in a specific NAL unit, within a suffix NAL unit or a prefix NAL unit, and/or within slice header extension. It may be required that the post-decoding RPS is identical to or causes the same pictures to be maintained in the DPB as the RPS of the next picture in the same layer. It may be required, for example in a coding standard, that the post-decoding RPS does not cause marking of pictures with a TemporalId smaller than that of the current picture as “unused for reference”.
Include an reference picture set (RPS) syntax structure, which may be referred to as a delayed post-decoding RPS, into the bitstream. A delayed post-decoding RPS may be associated with an indication that identifies for example a location in decoding order (subsequent in decoding order compared to the current picture) or a picture subsequent in decoding order (compared to the current picture). The indication may be for example a POC difference value, which when added to the POC of the current picture identifies a second POC value such that if a picture with POC equal to or greater than the second POC value is decoded, the delayed post-decoding RPS may be decoded (prior to or after decoding the picture, as pre-defined e.g. in a coding standard or indicated in the bitstream). In another example the indication may be for example a frame_num difference value (or alike), which when added to the frame_num (or alike) of the current picture identifies a second frame_num (or alike) value such that if a picture with frame_num (or alike) equal to or greater than the second frame_num (or alike) value is decoded, the delayed post-decoding RPS may be decoded (prior to or after decoding the picture, as pre-defined e.g. in a coding standard or indicated in the bitstream).
Include a flag, e.g. in the slice segment header e.g. using a bit position of the slice_reserved[i] syntax element of HEVC slice segment header, that causes marking of all pictures within the layer (including the current picture for which the flag is set to 1) as “unused for reference” after the decoding of the current picture for example when the access unit containing the current picture has been entirely decoded. The flag may include or exclude the current picture (i.e., the picture containing the slice where the flag is present) in its semantics as pre-defined e.g. in a coding standard or as indicated separately in the bitstream.
The above-mentioned flag may be specific to TemporalId, i.e. cause pictures of the same and higher

TemporalId values as that of the current picture to be marked as “unused for reference” (while the semantics of the flags are otherwise the same as above) or cause pictures of the higher TemporalId values as that of the current picture to be marked as “unused for reference” (while the semantics of the flags are otherwise the same as above).
An MMCO command or alike causing decoded reference picture marking.

A decoder and/or HRD and/or another entity, such as a media-aware network element, may decode one or more of above-mentioned commands or alike from the bitstream and consequently mark reference pictures as “unused for reference”. The marking of a picture as “unused for reference” may affect the emptying or deallocation of picture storage buffers in the DPB as described earlier.

An encoder may encode one or more of above-mentioned commands or alike into the bitstream, when a switch from coded fields to coded frames or vice versa is made. One or more of above-mentioned commands or alike may be included in the last picture of the switch-from layer (i.e. a reference layer, e.g. the base layer in FIG. 13 when switching layers at picture 108), in decoding order, prior to switching to coding pictures at another layer (i.e., a predicted layer, e.g. the enhancement layer EL1 in Figure when switching layers at picture 108). One or more of the above-mentioned commands or alike may cause pictures of the switch-from layer to be marked as “unused for reference” and consequently also emptying of DPB picture storage buffers.

In the present draft of MV-HEVC and SHVC, there is a feature sometimes referred to as early marking, where a sub-layer non-reference picture is marked “unused for reference” when its TemporalId is equal to the highest TemporalId that is being decoded (i.e., the highest TemporalId of the operation point in use) and when all pictures that may use the sub-layer non-reference picture as a reference for inter-layer prediction have been decoded. Consequently, a picture storage buffer may be emptied sooner than when the early marking is not applied, which may reduce the maximum required DPB occupancy particularly in a resolution-specific sub-DPB operation. However, there is a problem that it might not be known which are the highest nuh_layer_id value that is present in the bitstream and/or in a particular access unit to which the early marking is to be applied. Consequently, a first picture may remain marked as “used for reference” if it was expected or possible (e.g. based on sequence-level information, such as VPS) that access unit would have contained subsequent pictures (in decoding order) that may have used the first picture as reference for inter-layer prediction.

In an embodiment, which may be applied independently of or together with other embodiments, the early marking as described in the previous paragraph, is performed not only after decoding a picture within an access (e.g. after decoding each picture), but also after all pictures of the access unit have been decoded in a manner that each sub-layer non-reference picture of the access unit is marked “unused for reference” when its TemporalId is equal to the highest TemporalId that is being decoded (i.e., the highest TemporalId of the operation point in use). Thus, even if the access unit did not contain pictures in all predicted layers, the marking as “unused for reference” is performed for pictures at reference layers.

However, there is a problem that it might not be known which is the last codec picture or the last NAL unit of an access unit before receiving one or more NAL units of the next access unit. As the next access unit may not be received immediately after the decoding of the current access unit has ended, there may be a delay to conclude the last coded picture or NAL unit of an access unit and hence before being able to carry out processes that are performed after all coded pictures of an access unit have been decoded, such as the early marking performed at the end of decoding an access unit, as described in the previous paragraph.

In an embodiment, which may be applied independently of or together with other embodiments, an encoder encodes an indication in the bitstream, such as end-of-NAL-unit (EoNALU) NAL unit, that marks the last piece of data for an access unit, in decoding order. In an embodiment, which may be applied independently of or together with other embodiments, a decoder decodes an indication from the bitstream, such as end-of-NAL-unit (EoNALU) NAL unit, that marks the last piece of data for an access unit, in decoding order. As response to decoding the indication, the decoder performs such processes that are performed after all coded pictures of an access unit have been decoded, but before decoding the next access unit, in decoding order. For example, as response to decoding the indication, the decoder performs the early marking performed at the end of decoding an access unit, as described in the previous paragraph, and/or the determination of PicOutputFlag for the pictures of an access unit, as described earlier. The EoNALU NAL unit may be allowed to be absent, e.g. when there is an end-of-sequence NAL unit or an end-of-bitstream NAL unit present in the access unit.

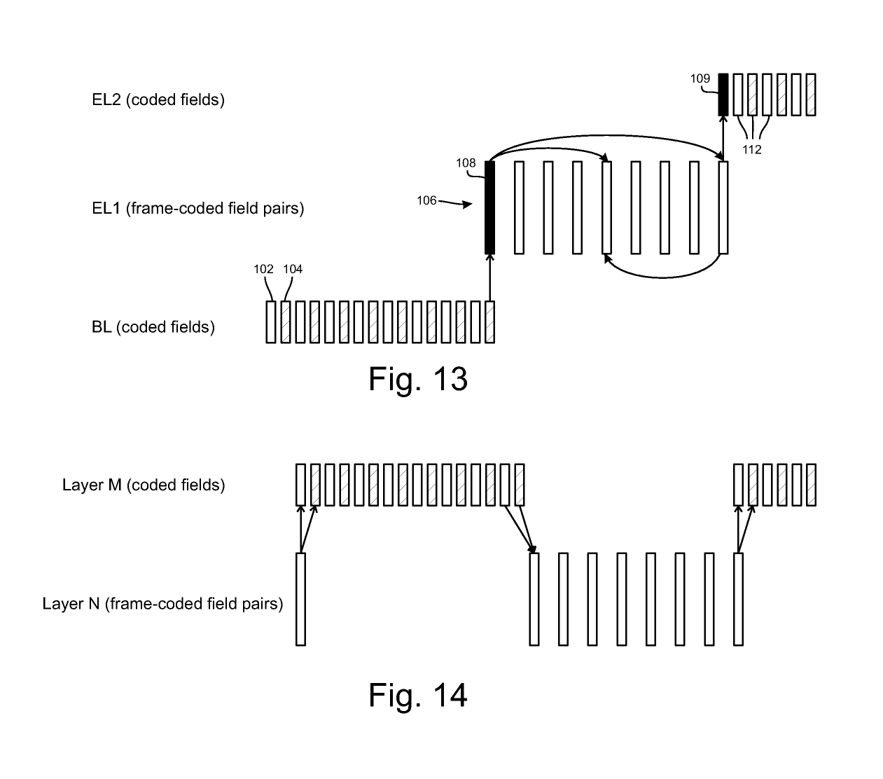

In another example embodiment locating coded fields and coded frames into layers may be realized as a coupled pair of layers with two-way inter-layer prediction. An example of this approach is depicted in FIG. 14. In this arrangement, a pair of layers is coupled so that they might not form a conventional hierarchical or one-way inter-layer prediction relation but rather form a pair or a group of layers where two-way inter-layer prediction may be performed. The coupled pair of layers may be specifically indicated, and sub-bitstream extraction may treat the coupled pair of layers as a single unit that may be extracted from or kept in the bitstream, but neither layer within the coupled pair of layers can be individually extracted from the bitstream (without the other also being extracted). As neither layer in the coupled pair of layers may conform to the base layer decoding process (due to inter-layer prediction being used), both layers may be enhancement layers. Layer dependency signaling (e.g. in VPS) may be modified to treat coupled pairs of layers specifically, e.g. as single units when indicating layer dependencies (while inter-layer prediction between the layers of a coupled pair of layers may be inferred to be enabled). In FIG. 14 diagonal inter-layer prediction has been used, which enables to specify which reference pictures of a reference layer may be used as reference for predicting a picture in the current layer. The coding arrangement could be similarly realized with conventional (aligned) inter-layer prediction provided that the (de)coding order of pictures can vary within from one access unit to another and may be used to determine whether layer N is a reference layer for layer M or vice versa.

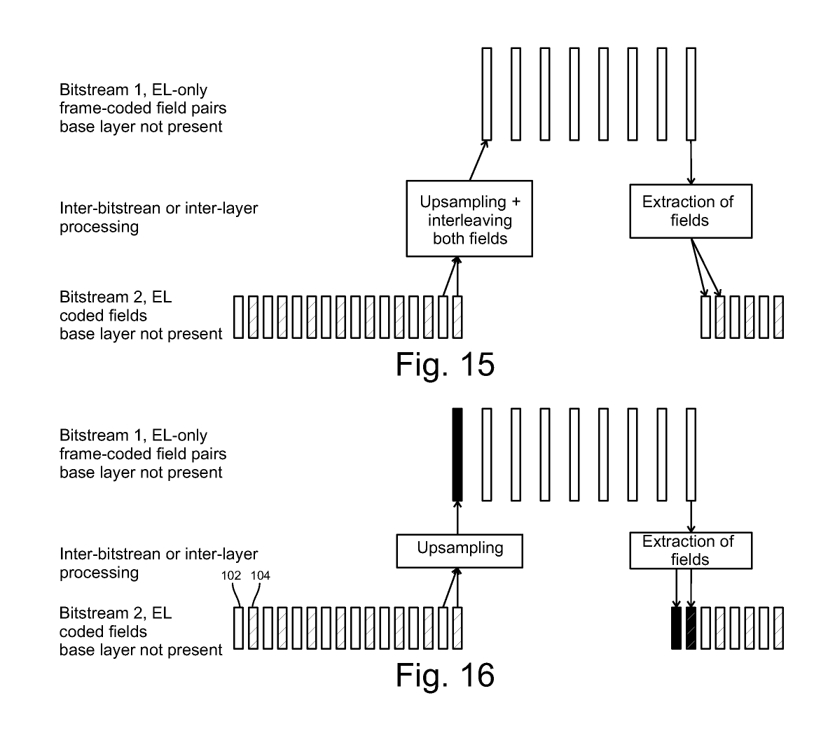

In yet another example embodiment locating coded fields and coded frames into layers may be realized as a coupled pair of enhancement layer bitstreams with external base layer. An example of such a coding arrangement referred to as a coupled pair of enhancement layer bitstreams with external base layer is presented in FIG. 15. In this arrangement, two bitstreams are coded, one comprising coded frames representing complementary field pairs of interlaced source content, and another one comprising coded fields. Both bitstreams are coded as enhancement-layer bitstreams of hybrid codec scalability. In other words, in both bitstreams, only an enhancement layer is coded and the base layer is indicated to be external. The bitstreams may be multiplexed into a multiplexed bitstream, which might not conform to the bitstream format for the enhancement-layer decoding process. Alternatively, the bitstreams may be stored and/or transmitted using separate logical channels, such as in separate tracks in a container file or using separated PIDs in MPEG-2 transport stream. The multiplexed bitstream format and/or other signaling (e.g. within file format metadata or communication protocols) may specify which pictures of bitstream 1 are used as reference for predicting pictures in bitstream 2, and/or vice versa, and/or identify the pairs or groups of pictures within bitstream 1 and 2 that have such inter-bitstream or inter-layer prediction relation. When a coded field is used for predicting a coded frame, it may be upsampled within the decoding process of bitstream 1 or as an inter-bitstream process connected with but not included the decoding process of bitstream 1. When a complementary pair of coded fields of bitstream 2 is used for predicting a coded frame, the fields may be interleaved (row-wise) within the decoding process of bitstream 1 or as an inter-bitstream process connected with but not included the decoding process of bitstream 1. When a coded frame is used for predicting a coded field, it may be downsampled or every other sample row may be extracted within the decoding process of bitstream 2 or as an inter-bitstream process connected with but not included the decoding process of bitstream 2. FIG. 15 presents an example where diagonal inter-layer prediction is used with external base layer pictures. The coding arrangement could be similarly realized when skip pictures are coded rather than using diagonal inter-layer prediction, as illustrated in FIG. 16. When a coded field is used for predicting a coded frame in FIG. 16, it may be upsampled within the decoding process of bitstream 1 or as an inter-bitstream process connected with but not included the decoding process of bitstream 1. When a complementary pair of coded fields of bitstream 2 is used for predicting a coded frame in FIG. 16, the fields may be interleaved (row-wise) within the decoding process of bitstream 1 or as an inter-bitstream process connected with but not included the decoding process of bitstream 1. The coded frame in both cases may be a skip picture. When a coded frame is used for predicting a coded field in FIG. 16, it may be downsampled or every other sample row may be extracted within the decoding process of bitstream 2 or as an inter-bitstream process connected with but not included the decoding process of bitstream 2, and the coded field may be a skip picture.

In some embodiments, an encoder may indicate in the bitstream and/or a decoder may decode from a bitstream, in relation to coding arrangements such as those in various embodiments, one or more of the following:
The bitstream (or the multiplexed bitstream in some embodiments like in the embodiment exemplified in FIG. 15) represents interlaced source content. In HEVC-based coding this may be indicated with general_progressive_source_flag equal to 0 and general_interlaced_source_flag equal to 1 in profile_tier_level syntax structures applicable for the bitstream.
A sequence of output pictures (as indicated to be output by the encoder and/or output by the decoder) represents interlaced source content.
It may be indicated whether a layer consists of coded pictures representing coded fields or coded frames. In HEVC-based coding, this may be indicated by the field_seq_flag of SPS VUI. Each layer can activate a different SPS, and hence field_seq_flag can be set individually per layer.
Any time instant or access unit in the associated sequence either contains a single picture from a single layer (which may or may not be BL picture) or contains two pictures out of which the picture at a higher layer is an IRAP picture. In HEVC-based coding (e.g. SHVC), this may be indicated with single_layer_for_non_irap_flag equal to 1. If so, it may further be indicated that when two pictures are present for the same time instant or access unit, the picture at a higher layer is a skip picture. In HEVC-based coding, this may be indicated with higher_layer_irap_skip_flag equal to 1.
Any time instant or access unit in the associated sequence contains a single picture from a single layer.

The above-mentioned indications may reside for example in one or more sequence-level syntax structures, such as VPS, SPS, VPS VUI, SPS VUI, and/or one or more SEI messages. Alternatively or in addition, the above-mentioned indications may reside for example within metadata of a container file format, such as within a decoder configuration record for ISOBMFF, and/or communication protocol headers, such as descriptor(s) of MPEG-2 transport stream.

In some embodiments, an encoder may indicate in the bitstream and/or a decoder may decode from a bitstream, in relation to coding arrangements such as those in various embodiments, one or more of the following:
For a coded field, an indication of a top or a bottom field.
For a coded field which may be used as a reference for inter-layer prediction and/or for a coded frame that is inter-layer-predicted, a vertical phase offset for the upsampling filter to be applied for the field.
For a coded field which may be used as a reference for inter-layer prediction and/or for a coded frame that is inter-layer-predicted, an indication of a vertical offset of the upsampled coded field within the coded frame. For example, signaling similar to scaled reference layer offsets of SHVC may be used, but in a picture-wise manner.
For a coded frame which may be used as a reference for inter-layer prediction and/or for a coded field that is inter-layer predicted, an initial vertical offset within the frame and/or a vertical decimation factor (e.g. VertDecimationFactor as specified above) to be applied in resampling the frame.

The above-mentioned indications may reside for example in one or more sequence-level syntax structures, such as VPS and/or SPS. The indications may be specified to apply to only a subset of access units or pictures, for example on the basis of indicated layers, sub-layers or TemporalId values, picture types, and/or NAL unit types. For example, a sequence-level syntax structure may include one or more of the above-mentioned indications for skip pictures. Alternatively or in addition, the above-mentioned indications may reside in access unit, picture, or slice level, for example in a PPS, APS, access unit header or delimiter, picture header or delimiter, and/or slice header. Alternatively or in addition, the above-mentioned indications may reside for example within metadata of a container file format, such as in sample auxiliary information of ISOBMFF, and/or communication protocol headers, such as descriptor(s) of MPEG-2 transport stream.

In the following, some complementary and/or alternative embodiments are described.

Inter-Layer Prediction with Quality Enhancement

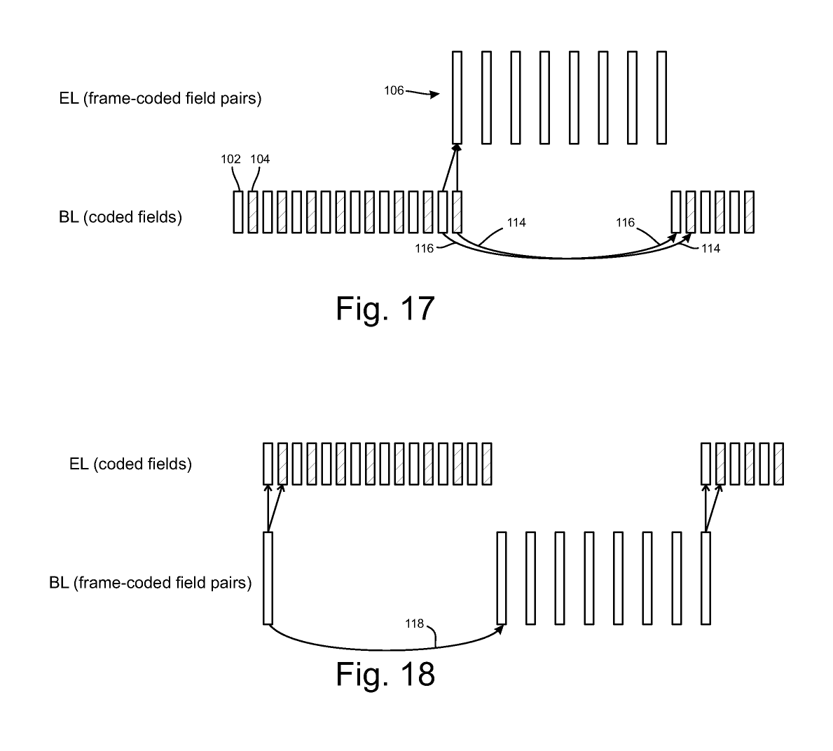

In an embodiment, the first uncompressed complementary field pair is the same as or represents the same time instance as the second uncompressed field pair. It may be considered that an enhancement layer picture representing the same time instant as a base layer picture may enhance the quality of one or both fields of the base layer picture. FIGS. 17 and 18 present similar examples as those in FIG. 9 and FIG. 10, respectively, but where instead of skip pictures in the enhancement layer EL, the enhancement layer picture(s) coinciding with a base layer frame or field pair may enhance the quality of one or both fields of the base layer frame or field pair.

Top and Bottom Fields Separated in Different Layers

HEVC version 1 includes support for indicating interlace source material e.g. through field_seq_flag of VUI and pic_struct of the picture timing SEI message. However, it is up to the display process to have the capability to display interlace source material correctly. It is asserted that players may ignore the indications such as the pic_struct syntax element of picture timing SEI messages and display fields as if they were frames—which might cause an unsatisfactory playback behavior. By separating fields of different parity to different layers, base-layer decoders would display fields of a single parity only, which may provide a stable and satisfactory displaying behavior.

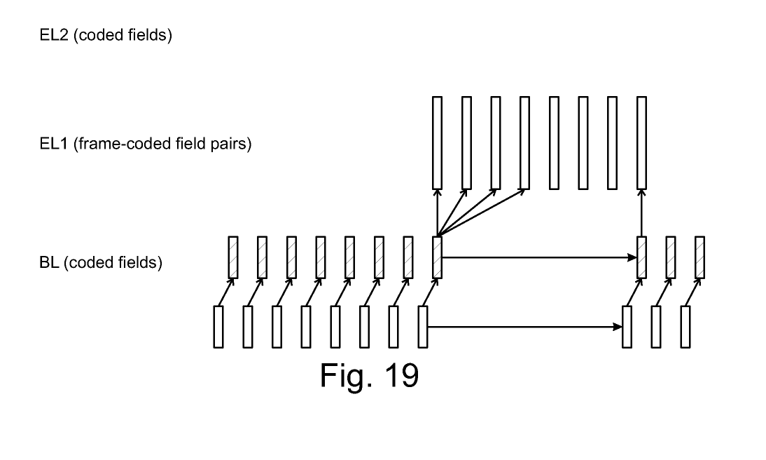

Various embodiments may be realized in a manner where top and bottom fields reside in different layers. FIG. 19 illustrates an example similar to that in FIG. 11. To enable top and bottom fields separated in different layers, resampling of a reference-layer picture may be enabled when the scale factor is 1 under certain conditions e.g. when vertical phase offset for filtering is indicated to be certain and/or when it is indicated that a reference-layer picture represents a field of a certain parity while the picture being predicted represents a field of an opposite parity.

PAFF Coding with Scalability Layers and Interlaced-to-Progressive Scalability in the Same Bitstream

In some embodiments, PAFF coding may be realized with one or more embodiments described earlier. Additionally, one or more layers representing a progressive source enhancement may also be encoded and/or decoded, e.g. as described earlier. When coding and/or decoding a layer representing progressive source content, its reference layer may be a layer containing coded frames of complementary field pairs representing interlaced source content and/or one or two layers containing coded fields.

It is asserted that the use of indications related to source scanning type (progressive or interlaced) and picture type (frame or field) in MV-HEVC/SHVC is presently unclear, because:
general_progressive_source_flag and general_interlaced_source_flag are included in the profile_tier_level( ) syntax structure. In MV-HEVC/SHVC, the profile_tier_level( ) syntax structure is associated with an output layer set. Yet, the semantics of general_progressive_source_flag and general_interlaced_source_flag refer to the CVS—which supposedly means all layers, not just the layers of the output layer set which the profile_tier_level( ) syntax structure is associated with.
In the absence of SPS VUI, general_progressive_source_flag and general_interlaced_source_flag are used to infer the value of frame_field_info_present_flag, which specifies whether the pic_struct, source_scan_type, and duplicate_flag syntax elements are present in the picture timing SEI messages. However, general_progressive_source_flag and general_interlaced_source_flag are absent in SPSs with nuh_layer_id greater than 0, so it is unclear which profile_tier_level( ) syntax structure is in the inference of general_interlaced_source_flag.

An encoder may encode one or more indication(s) into a bitstream and a decoder may decode one or more indication(s) from the bitstream e.g. into/from a sequence-level syntax structure such as a VPS, where the one or more indication(s) may indicate, e.g. for each layer, if a layer represents interlaced source content or progressive source content.

Alternatively or additionally, in HEVC extensions, the following changes may be applied in syntax and/or semantics and/or encoding and/or decoding:
The SPS syntax is modified to include layer_progressive_source_flag and layer_interlaced_source_flag syntax elements, which are present in the SPS when profile_tier_level( ) is not present in the SPS. These syntax elements specify the source scanning type similarly to how general_progressive_source_flag and general_interlaced_source_flag in the SPS with nuh_layer_id equal to 0 specify the source scanning type for the base layer.
When general_progressive_source_flag, general_interlaced_source_flag, general_non_packed_constraint_flag and general_frame_only_constraint_flag appear in an SPS, they apply to the pictures to which the SPS is an active SPS.
When general_progressive_source_flag, general_interlaced_source_flag, general_non_packed_constraint_flag and general_frame_only_constraint_flag appear in a profile_tier_level( ) syntax structure associated with an output layer set, they apply to output layers and alternative output layers, if any, of the output layer set.
The constraints on and the inference of the value of frame_field_info_present_flag (in SPS VUI) is derived on the basis of general_progressive_source_flag and general_interlaced_source_flag, if they are present in the SPS, and on the basis of layer_progressive_source_flag and layer_interlaced_source_flag, otherwise.

Alternatively or additionally, in HEVC extensions, the semantics of general_progressive_source_flag and general_interlaced_source_flag in the profile_tier_level( ) syntax structure may be appended as follows. When the profile_tier_level( ) syntax structure is included in SPS that is the active SPS for an independent layer, the general_progressive_source_flag and general_interlaced_source_flag indicate whether the layer contains interlaced or progressive source content or the source content type is unknown or the source content type is indicated picture-wise. When the profile_tier_level( ) syntax structure is included in VPS, the general_progressive_source_flag and general_interlaced_source_flag indicate whether the output pictures contain interlaced or progressive source content or the source content type is unknown or the source content type is indicated picture-wise, where the output pictures are determined according to an output layer set referring to the profile_tier_level( ) syntax structure.

Alternatively or additionally, in HEVC extensions, the semantics of general_progressive_source_flag and general_interlaced_source_flag in the profile_tier_level( ) syntax structure may be appended as follows. The general_progressive_source_flag and general_interlaced_source_flag of the profile_tier_level( ) syntax structure associated with an output layer set indicate whether the layers of an output layer contain interlaced or progressive source content or the source content type is unknown or the source content type is indicated picture-wise. If there are layers within the output layer set that represent a different scan type than that indicated in the VPS for the output layer set, an active SPS for those layers includes a profile_tier_level( ) syntax structure with general_progressive_source_flag and general_interlaced_source_flag values specifying that different scan type.

The above described embodiments enable picture-adaptive frame-field coding of interlaced source content with scalable video coding, such as SHVC, without a need for adapting low-level coding tools. The prediction between coded fields and coded frames may also be enabled, therefore a good compression efficiency may be obtained, comparable to that which could be achieved with a codec where low-level coding tools are adapted to enable prediction between coded frames and coded fields.

An embodiment, which may be applied together with or independently of other embodiments, is described in the following. An encoder or a multiplexer or alike may encode and/or include an SEI message, which may be referred to as the HEVC properties SEI message, in a base-layer bitstream for hybrid codec scalability. The HEVC properties SEI message may be nested, for example, within a hybrid codec scalability SEI message. The HEVC properties SEI message may indicate one or more of the following:
Syntax elements used to determine values for input variables for an associated external base-layer picture as required by the MV-HEVC, SHVC, and/or alike. For example, the SEI message may include an indication whether or not the picture is an IRAP picture for the EL bitstream decoding process and/or an indication of the type of the picture.
Syntax elements used to identify the picture or the access unit in the EL bitstream for which the associated base-layer picture is a reference-layer picture, which may be used as a reference for inter-layer prediction. For example, POC reset period and/or POC related syntax elements may be included.
Syntax elements used to identify the picture or the access unit in the EL bitstream which immediately succeeds or precedes, in decoding order, the associated base-layer picture is a reference-layer picture. For example, if the base-layer picture acts as a BLA picture for the enhancement layer decoding and no EL bitstream picture is considered to correspond to the same time instant as the BLA picture, it may need to be identified which picture in EL bitstream succeeds or precedes the BLA picture as the BLA picture may affect the decoding of the EL bitstream.
Syntax elements to specify the resampling to be applied to the associated picture or pictures (e.g. a complementary field pair) prior to providing the picture as a decoded external base layer picture to the EL decoding and/or as part of inter-layer processing for the decoded external base layer picture within the EL decoding process.

In an example embodiment, the following syntax or alike may be used for the HEVC properties SEI message:

Descriptor

hevc_properties( payloadSize ) {

| | |
|---|---|
| hevc_irap_flag | u(1) |
| if( irap_flag ) | |

| | |
|---|---|
| hevc_irap_type | ue(v) |

| | |
|---|---|
| hevc_poc_reset_period_id | u(6) |
| hevc_pic_order_cnt_val_sign | u(1) |
| hevc_abs_pic_order_cnt_val | u(31) |

}

The semantics of the HEVC properties SEI message may be specified as follows. hevc_irap_flag equal to 0 specifies that the associated picture is not an external base layer IRAP picture. hevc_irap_flag equal to 1 specifies that the associated picture is an external base layer IRAP picture. hevc_irap_type equal to 0, 1 and 2 specify that the nal_unit_type is equal to IDR_W_RADL, CRA_NUT, and BLA_W_LP, respectively, when the associated picture is used as an external base layer picture. hevc_poc_reset_period_id specifies the poc_reset_period_id value of the associated HEVC access unit. If hevc_pic_order_cnt_val_sign is equal to 1, hevcPoc is derived to be equal to hevc_abs_pic_order_cnt_val; otherwise, hevcPoc is derived to be equal to—hevc_abs_pic_order_cnt_val−1. hevcPoc specifies the PicOrderCntVal value of the associated HEVC access unit within the POC resetting period identified by hevc_poc_reset_period_id.

In addition to or instead of the HEVC properties SEI message, similar information as provided in the syntax elements of the SEI message may be provided elsewhere, for example in one or more of the following:
Within prefix NAL units (or alike) associated with base-layer pictures within the BL bitstream.
Within enhancement-layer encapsulation NAL units (or alike) within the BL bitstream.
Within base-layer encapsulation NAL units (or alike) within the EL bitstream.
SEI message(s) or indication(s) within SEI message(s) within the EL bitstream.
Metadata according to a file format, which metadata resides or is referred to by a file that includes or refers to the BL bitstream and the EL bitstream. For example, sample auxiliary information, sample grouping and/or timed metadata tracks of the ISO base media file format may be used for a track including the base layer.
Metadata within a communication protocol, such as within descriptors of MPEG-2 transport stream.

An example embodiment related to providing base-layer picture properties, similar to the above-described HEVC properties SEI message, with the sample auxiliary information mechanism of the ISOBMFF is given next. When a multi-layer HEVC bitstream uses an external base layer (i.e., when an active VPS of an HEVC bitstream has vps_base_layer_internal_flag equal to 0), Sample Auxiliary Information with aux_info_type equal to ‘lhvc’ (or some other chosen four-character code) and aux_info_type_parameter equal to 0 (or some other value) is provided, e.g. by a file creator, for a track that may use the external base layer as a reference for inter-layer prediction. Storage of sample auxiliary information follows the specifications of the ISOBMFF. The syntax of the sample auxiliary information with aux_info_type equal to ‘lhvc’ is the following or alike.

```
aligned(8) class LhvcSampleAuxiliaryDataFormat
{
  unsigned int(1) bl_pic_used_flag;
  unsigned int(1) bl_irap_pic_flag;
  unsigned int(6) bl_irap_nal_unit_type;
  signed  int(8) sample_offset;
}
```

The semantics of the sample auxiliary information with aux_info_type equal to ‘lhvc’ may be specified as described below or similarly. In the semantics, the term current sample refers to the sample that this sample auxiliary information is associated with and should be provided for the decoding of the sample.
bl_pic_used_flag equal to 0 specifies that no decoded base layer picture is used for the decoding of the current sample. bl_pic_used_flag equal to 1 specifies that a decoded base layer picture may be used for the decoding of the current sample.
bl_irap_pic_flag specifies, when bl_pic_used_flag is equal to 1, the value of the BlIrapPicFlag variable for the associated decoded picture, when that decoded picture is provided as a decoded base layer picture for the decoding of the current sample.
bl_irap_nal_unit_type specifies, when bl_pic_used_flag is equal to 1 and bl_irap_pic_flag is equal to 1, the value of the nal_unit_type syntax element for the associated decoded picture, when that decoded picture is provided as a decoded base layer picture for the decoding of the current sample.
sample_offset gives, when bl_pic_used_flag is equal to 1, the relative index of the associated sample in the linked track. The decoded picture resulting from the decoding of the associated sample in the linked track is the associated decoded picture that should be provided for the decoding of the current sample. sample_offset equal to 0 specifies that the associated sample has the same, or the closest preceding, decoding time compared to the decoding time of the current sample; sample_offset equal to 1 specifies that the associated sample is the next sample relative to the associated sample derived for sample_offset equal to 0; sample_offset equal to −1 specifies that the associated sample is the previous sample relative to the associated sample derived for sample_offset equal to 0, and so on.

An example embodiment related to parsing base-layer picture properties, similar to the above-described HEVC properties SEI message, conveyed using the sample auxiliary information mechanism of the ISOBMFF is provided next. When a multi-layer HEVC bitstream uses an external base layer (i.e., when an active VPS of an HEVC bitstream has vps_base_layer_internal_flag equal to 0), Sample Auxiliary Information with aux_info_type equal to ‘lhvc’ (or some other chosen four-character code) and aux_info_type_parameter equal to 0 (or some other value) is parsed, e.g. by a file parser, for a track that may use the external base layer as a reference for inter-layer prediction. The syntax and semantics of the sample auxiliary information with aux_info_type equal to ‘lhvc’ may be like those described above or alike. When bl_pic_used_flag equal to 0 is parsed for an EL track sample, no decoded base layer picture is provided for the EL decoding process of the current sample (of the EL track). When bl_pic_used_flag equal to 1 is parsed for an EL track sample, the identified BL picture is decoded (unless it has been decoded already) and the decoded BL picture is provided to the EL decoding process of the current sample. When bl_pic_used_flag equal to 1 is parsed, at least some of the syntax elements bl_irap_pic_flag, bl_irap_nal_unit_type, and sample_offset are also parsed. The BL picture is identified through the sample_offset syntax element as described above. Together or associated with the decoded BL picture, the parsed information bl_irap_pic_flag and bl_irap_nal_unit_type (or any similarly indicative information) are also provided to the EL decoding process of the current sample. The EL decoding process may operate as described earlier.

An example embodiment related to providing base-layer picture properties, similar to the above-described HEVC properties SEI message, through an external base layer extractor NAL unit structure is provided next. An external base layer extractor NAL unit is specified similarly to the ordinary extractor NAL unit specified in ISO/IEC 14496-15, but additionally provides BlIrapPicFlag and nal_unit_type for decoded base layer pictures. When a decoded base layer picture is used as a reference for decoding an EL sample, a file creator (or another entity) includes an external base layer extractor NAL unit into the EL sample, with syntax element values identifying the base layer track, the base layer sample used as input in decoding the base layer picture, and (optionally) the byte range within the base layer sample used as input in decoding the base layer picture. The file creator also obtains the values of BlIrapPicFlag and nal_unit_type for the decoded base layer picture and includes those into the external base layer extractor NAL unit.

An example embodiment related to parsing base-layer picture properties, similar to the above-described HEVC properties SEI message, conveyed using an external base layer extractor NAL unit structure is provided next. A file parser (or another entity) parses an external base layer extractor NAL unit from an EL sample and consequently concludes that a decoded base layer picture may be used as a reference for decoding the EL sample. The file parser parses from the external base layer extractor NAL unit which base layer picture is decoded in order to obtain the decoded base layer picture that may be used as a reference for decoding the EL sample. For example, the file parser may parse from the external base layer extractor NAL unit syntax elements that identify the base layer track, identify the base layer sample used as input in decoding the base layer picture (e.g. through decoding time as described with the extractor mechanism of ISO/IEC 14496-15 earlier), and (optionally) the byte range within the base layer sample used as input in decoding the base layer picture. The file parser may also obtain the values of BlIrapPicFlag and nal_unit_type for the decoded base layer picture from the external base layer extractor NAL unit. Together or associated with the decoded BL picture, the parsed information BlIrapPicFlag and nal_unit_type (or any similarly indicative information) are also provided to the EL decoding process of the current EL sample. The EL decoding process may operate as described earlier.

An example embodiment related to providing base-layer picture properties, similar to the above-described HEVC properties SEI message, within a packetization format, such as an RTP payload format is given next. The base-layer picture properties may be provided for example through one or more of the following means:
A payload header of a packet comprising a coded EL picture (either parts of or completely). For example, a payload header extension mechanism can be used. For example, a PACI extension (as specified for the RTP payload format of H.265) or alike may be used to contain a structure that comprises information indicative of BlIrapPicFlag and, at least when BlIrapPicFlag is true, nal_unit_type for the decoded base layer picture.
A payload header of a packet comprising a coded BL picture (either parts of or completely).
A NAL-unit-like structure, e.g. similar to an external base layer extractor NAL unit described above, within a packet comprising EL picture (either parts of or completely) but where the correspondence between the EL picture and the respective BL picture is established through other means than track-based means as described above. For example, the NAL-unit-like structure may comprise information indicative of BlIrapPicFlag and, at least when BlIrapPicFlag is true, nal_unit_type for the decoded base layer picture.
A NAL-unit-like structure within a packet comprising BL picture (either parts of or completely).

In the examples above the correspondence between the EL picture and the respective BL picture may be established implicitly by assuming that the BL picture and the EL picture have the same RTP timestamp. Alternatively, the correspondence between the EL picture and the respective BL picture may be established by including an identifier of the BL picture, such as a decoding order number (DON) of the first unit of the BL picture or a picture order count (POC) of the BL picture, in the NAL-unit-like structure or header extension associated with the EL picture; or vice versa, including an identifier of the EL picture in the NAL-unit-like structure or header extension associated with the BL picture.

In an embodiment, when a decoded base layer picture may be used as a reference for decoding an EL picture, a sender, a gateway or another entity indicates, e.g. in the payload header, within a NAL-unit-like structure, and/or using an SEI message, information indicative of the values of BlIrapPicFlag and, at least when BlIrapPicFlag is true, nal_unit_type for the decoded base layer picture.

In an embodiment, a receiver, a gateway or another entity parses, e.g. from the payload header, from a NAL-unit-like structure, and/or from an SEI message, information indicative of the values of BlIrapPicFlag and, at least when BlIrapPicFlag is true, nal_unit_type for the decoded base layer picture. Together or associated with the decoded BL picture, the parsed information BlIrapPicFlag and nal_unit_type (or any similarly indicative information) are also provided to the EL decoding process of the associated EL picture. The EL decoding process may operate as described earlier.

An EL bitstream encoder or an EL bitstream decoder may request an external base layer picture from a BL bitstream encoder or a BL bitstream decoder e.g. by providing the values of poc_reset_period_id and PicOrderCntVal of the EL picture being encoded or decoded. If a BL bitstream encoder or a BL bitstream decoder concludes, e.g. based on decoded HEVC properties SEI messages, that there are two BL pictures associated with the same EL picture or access unit, the two decoded BL pictures may be provided to the EL bitstream encoder or EL bitstream decoder in a pre-defined order, such as in the respective decoding order of the BL pictures or the picture acting as an IRAP picture in the EL bitstream encoding or decoding preceding a picture that is not an IRAP picture in the EL bitstream encoding or decoding. If a BL bitstream encoder or a BL bitstream decoder concludes, e.g. based on decoded HEVC properties SEI messages, that there is one BL picture associated with the EL picture or access unit, the BL bitstream encoder or the BL bitstream decoder may provide the decoded BL picture to the EL bitstream encoder or EL bitstream decoder. If a BL bitstream encoder or a BL bitstream decoder concludes, e.g. based on decoded HEVC properties SEI messages, that there is no BL picture associated with the EL picture or access unit, the BL bitstream encoder or the BL bitstream decoder may provide an indication to the EL bitstream encoder or EL bitstream decoder that there is no associated BL picture.

When diagonal prediction from an external base layer is in use, an EL bitstream encoder or an EL bitstream decoder may request an external base layer picture from a BL bitstream encoder or a BL bitstream decoder by providing the values of poc_reset_period_id and PicOrderCntVal of each picture which may be used or is used as reference for diagonal prediction. For example, in an additional short-term RPS or alike that is used to identify diagonal reference pictures, the PicOrderCntVal values indicated in or derived from the additional short-term RPS may be used by the EL bitstream encoder or the EL bitstream decoder to request the external base-layer pictures from the BL bitstream encoder or the BL bitstream decoder, and the poc_reset_period_id of the current EL picture being encoded or decoded may also be used in requesting the external base layer pictures.

An embodiment, which may be applied together with or independently of other embodiments, is described in the following. Frame-compatible (a.k.a. frame-packed) video is coded into and/or decoded from a base layer. The base layer may be indicated, by an encoder (or another entity), and/or decoded, by a decoder (or another entity), to comprise frame-packed content for example through an SEI message, such as the frame packing arrangement SEI message of HEVC, and/or through parameter sets, such as general_non_packed_constraint_flag of the profile_tier_level( ) syntax structure of HEVC, which may be included in VPS and/or SPS. general_non_packed_constraint_flag equal to 1 specifies that there are neither frame packing arrangement SEI messages nor segmented rectangular frame packing arrangement SEI messages present in the CVS, i.e. that the base layer is not indicated to comprise frame-packed content. general_non_packed_constraint_flag equal to 0 indicates that there may or may not be one or more frame packing arrangement SEI messages or segmented rectangular frame packing arrangement SEI messages present in the CVS, i.e. that the base layer may be indicated to comprise frame-packed content. It may be encoded into the bitstream and/or decoded from the bitstream, e.g. through a sequence-level syntax structure, such as VPS, that an enhancement layer represents a full-resolution enhancement of one of the views represented by the base layer. The spatial relation of the view packed within the base layer pictures and the enhancement layer may be indicated, by the encoder, into the bitstream and/or decoded, by the decoder, from the bitstream e.g. using scaled reference layer offsets and/or similar information. The spatial relation may be indicative of the upsampling of the constituent picture of the base layer, representing one view, that is to be applied in order to use the upsampled constituent picture as a reference picture for predicting an enhancement layer picture. Various other described embodiments may be used in indicating, by the encoder, or decoding, by the decoder, the association of the base-layer picture with the enhancement layer picture.

An embodiment, which may be applied together with or independently of other embodiments, is described in the following. At least one redundant picture is coded and/or decoded. The at least one redundant coded picture is located in an enhancement layer, which in the HEVC context has nuh_layer_id greater than 0. The layer containing the at least one redundant picture does not contain primary pictures. The redundant picture layer is assigned its own scalability identifier type (which may be referred to as ScalabilityId in the context of HEVC extensions) or it can be an auxiliary picture layer (and may be assigned an AuxId value in the context of HEVC extensions). An AuxId value may be specified to indicate a redundant picture layer. Alternatively, an AuxId value that is left unspecified may be used (e.g. a value in the range of 128 to 143, inclusive, in the context of HEVC extensions) and it may be indicate with an SEI message (e.g. a redundant picture properties SEI message may be specified) that the auxiliary picture layer contains redundant pictures.

An encoder may indicate in the bitstream and/or a decoder may decode from a bitstream that the redundant picture layer may use inter-layer prediction from a “primary” picture layer (which may be the base layer). For example, in the context of HEVC extensions, the direct_dependency_flag of the VPS extension may be used for such purpose.

It may be required for example in a coding standard that redundant pictures do not use inter prediction from other pictures of the same layer and that they may only use diagonal inter-layer prediction (from the primary picture layer).

It may be required for example in a coding standard that whenever there is a redundant picture in the redundant picture layer, there is a primary picture in the same access unit.

The redundant picture layer may be semantically characterized so that decoded pictures of a redundant picture layer have similar content as the pictures of the primary picture layer in the same access units. Hence, a redundant picture may be used to as reference for prediction of the pictures in the primary picture layer in the absence (i.e. accidental full picture loss) or failure of decoding (e.g. partial picture loss) of a primary picture in the same access unit than the redundant picture.

It is asserted that a consequence of the above mentioned requirements may be that redundant pictures need only be decoded when the respective primary pictures are not (successfully) decoded and that no separate sub-DPB need to be maintained for the redundant pictures.

In an embodiment the primary picture layer is an enhancement layer in a first EL bitstream (with an external base layer), and the redundant picture layer is an enhancement layer in a second EL bitstream (with an external base layer). In other words, in this arrangement, two bitstreams are coded, one comprising primary pictures and another one comprising redundant pictures. Both bitstreams are coded as enhancement-layer bitstreams of hybrid codec scalability. In other words, in both bitstreams, only an enhancement layer is coded and the base layer is indicated to be external. The bitstreams may be multiplexed into a multiplexed bitstream, which might not conform to the bitstream format for the enhancement-layer decoding process. Alternatively, the bitstreams may be stored and/or transmitted using separate logical channels, such as in separate tracks in a container file or using separated PIDs in MPEG-2 transport stream.

The encoder may encode pictures of the primary-picture EL bitstream so that they may only use intra and inter prediction (within the same layer) and not use inter-layer prediction except in special occasions described subsequently. The encoder may encode pictures of the redundant-picture EL bitstream so that they may use intra and inter prediction (within the same layer) and inter-layer prediction from the external base layer corresponding to the primary-picture EL bitstream. However, the encoder may omit using inter prediction (from pictures within the same layer) in the redundant-picture EL bitstream as described above. The encoder and/or a multiplexer may indicate in the multiplexed bitstream format and/or other signaling (e.g. within file format metadata or communication protocols) which pictures of bitstream 1 (e.g. the primary-picture EL bitstream) are used as reference for predicting pictures in bitstream 2 e.g. the redundant-picture EL bitstream), and/or vice versa, and/or identify the pairs or groups of pictures within bitstream 1 and 2 that have such inter-bitstream or inter-layer prediction relation. In a special occasion, the encoder may encode an indication in the multiplexed bitstream that a picture of the redundant-picture EL bitstream is used as a reference for prediction for a picture of the primary-picture EL bitstream. In other words, the indication indicates that a redundant picture is used as if it were a reference-layer picture of the external base layer of the primary-picture EL bitstream. The special occasion may be determined by the encoder (or alike) for example on the basis of one or more feedback messages from a far-end decoder or receiver or alike. The one or more feedback messages may indicate that one or more pictures (or parts thereof) of the primary-picture EL bitstream has been absent or have not been successfully decoded. Additionally, one or more feedback messages may indicate that a redundant picture from the redundant-picture EL bitstream has been received and successfully decoded. Hence, in order to avoid the use of non-received or unsuccessfully decoded pictures of the primary-picture EL bitstream as reference for prediction of subsequent pictures of the primary-picture EL bitstream, the encoder may determine to use and indicate the use of one or more pictures of the redundant-picture EL bitstream as reference for prediction of subsequent pictures of the primary-picture EL bitstream. The decoder or the demultiplexer or alike may decode an indication from the multiplexed bitstream that a picture of the redundant-picture EL bitstream is used as a reference for prediction for a picture of the primary-picture EL bitstream. As response, the decoder or the demultiplexer or alike may decode the indicated picture of the redundant-picture EL bitstream, and provide the decoded redundant picture as a decoded external base layer picture for the primary-picture EL bitstream decoding. The provided decoded external base layer picture may be used as a reference for inter-layer prediction in decoding of one or more pictures of the primary-picture EL bitstream.

An embodiment, which may be applied together with or independently of other embodiments, is described in the following. An encoder encodes at least two EL bitstreams with different spatial resolutions to realize adaptive resolution change functionality. When switching from a lower resolution to a higher resolution takes place, one or more decoded pictures of the lower-resolution EL bitstream are provided as external base layer picture(s) for the higher-resolution EL bitstream encoding and/or decoding, and the external base layer picture(s) may be used as reference for inter-layer prediction. When switching from a higher resolution to a lower resolution takes place, one or more decoded pictures of the higher-resolution EL bitstream are provided as external base layer picture(s) for the lower-resolution EL bitstream encoding and/or decoding, and the external base layer picture(s) may be used as reference for inter-layer prediction. In this case, downsampling of the decoded higher-resolution pictures may be performed e.g. as in inter-bitstream process or within the lower-resolution EL bitstream encoding and/or decoding. Consequently, when compared to conventional method to realize adaptive resolution change with scalable video coding, inter-layer prediction from a higher-resolution picture (conventionally at a higher layer) to a lower-resolution picture (conventionally at a lower layer) may take place.

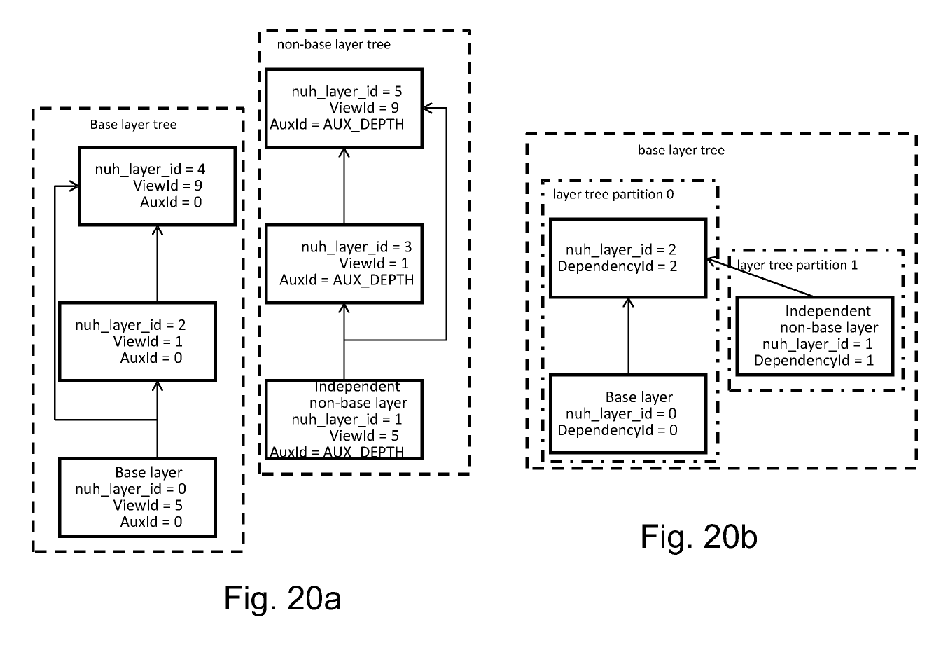

The following definitions may be used in embodiments. A layer tree may be defined a set of layers connected with inter-layer prediction dependencies. A base layer tree may be defined as a layer tree that includes the base layer. A non-base layer tree may be defined as a layer tree that does not include the base layer. An independent layer may be defined as a layer that does not have direct reference layers. An independent non-base layer may be defined as an independent layer that is not the base layer. An example of these definitions in MV-HEVC (or alike) is provided in FIG. 20a. The example presents how a 3-view multiview-video-plus-depth MV-HEVC bitstream can allocate nuh_layer_id values. As in MV-HEVC there is no prediction from texture video to depth or vice versa, there is independent non-base layer which contains the “base” depth view. There are two layer trees in the bitstream, one (the base layer tree) containing the layers for the texture video, and another one (the non-base layer tree) containing the depth layers.

Additionally, the following definitions may be used. A layer subtree may be defined as a subset of the layers of a layer tree including all the direct and indirect reference layers of the layers within the subset. A non-base layer subtree may be defined as a layer subtree that does not include the base layer. Referring to the FIG. 20a, a layer subtree can for example consist of layers with nuh_layer_id equal to 0 and 2. An example of a non-base layer subtree consists of layers with nuh_layer_id equal to 1 and 3. A layer subtree can also contain all layers of a layer tree. A layer tree may contain more than one independent layers. A layer tree partition may therefore be defined as a subset of the layers of a layer tree including exactly one independent layer and all its direct or indirect predicted layers unless they are included in a layer tree partition with a smaller index of the same layer tree. Layer tree partitions of a layer tree may be derived in ascending layer identifier order (e.g. in ascending nuh_layer_id order in MV-HEVC, SHVC and/or alike) of the independent layers of the layer tree. The FIG. 20b presents an example of a layer tree with two independent layers. The layer with nuh_layer_id equal to 1 could be e.g. a region-of-interest enhancement of the base layer, whereas the layer with nuh_layer_id equal to 2 could enhance the entire base-layer picture in terms of quality or spatially. The layer tree of the FIG. 20b is partitioned into two layer tree partitions as shown in the figure. A non-base layer subtree can therefore be a subset of the non-base layer tree or a layer tree partition of a base layer tree with partition index greater than 0. For example layer tree partition 1 in the FIG. 20b is a non-base layer subtree.

Additionally, the following definitions may be used. An additional layer set may be defined a set of layers of a bitstream with an external base layer or a set of layers of one or more non-base layer subtrees. An additional independent layer set may be defined a layer set consisting of one or more non-base layer subtrees.

In some embodiments, an output layer set nesting SEI message may be used. The output layer set nesting SEI message may be defined to provide a mechanism to associate SEI messages with one or more additional layer sets or one or more output layer sets. The syntax of output layer set SEI message may be for example as follows or anything alike.

Descriptor

output_layer_set_nesting( payloadSize ) {

| | |
|---|---|
| ols_flag | u(1) |
| num_ols_indices_minus1 | ue(v) |
| for( i = 0; i <= num_ols_indices_minus1; i++ ) | |

| | |
|---|---|
| ols_idx[ i ] | ue(v) |

while( !byte_aligned( ) )

| | |
|---|---|
| ols_nesting_zero_bit /* equal to 0 */ | u(1) |

do

sei_message( )

while( more_data_in_payload( ) )

}

The semantics of the output layer set nesting SEI message may be specified for example as follows. The output layer set nesting SEI message provides a mechanism to associate SEI messages with one or more additional layer sets or one or more output layer sets. An output layer set nesting SEI message contains one or more SEI messages. ols_flag equal to 0 specifies that the nested SEI messages are associated with additional layer sets identified through ols_idx[i]. ols_flag equal to 1 specifies that the nested SEI messages are associated with output layer sets identified through ols_idx[i]. When NumAddLayerSets is equal to 0, ols_flag shall be equal to 1. num_ols_indices_minus1 plus 1 specifies the number of indices of additional layer sets or output layer sets the nested SEI messages are associated with. ols_idx[i] specifies an index of the additional layer set or the output layer set specified in the active VPS to which the nested SEI messages are associated with. ols_nesting_zero_bit may be required, for example by a coding standard, to be equal to 0.

An embodiment, which may be applied together with or independently of other embodiments, is described in the following. The encoder may indicate in the bitstream and/or the decoder may decode from the bitstream indications related to additional layer sets. For example, additional layer sets can be specified in VPS extension in either or both of the following value ranges of layer set indices: a first range of indices for additional layer sets when an external base layer is in use, and a second range of indices for additional independent layer sets (which may be converted to a conforming standalone bitstream). It may be specified for example in a coding standard that the indicated additional layer sets are not required to generate conforming bitstreams with a conventional sub-bitstream extraction process.

The syntax for specifying additional layer sets may take advantage of layer dependency information indicated in a sequence-level structures, such as VPS. In an example embodiment, the highest layer within each layer tree partition is indicated by the encoder to specify an additional layer set and decoded by the decoder to derive an additional layer set. For example, an additional layer set may be indicated with a 1-based index for each layer tree partition of each layer tree (in a pre-defined order, such as an ascending layer identifier order of the independent layers for each layer tree partition), and index 0 may be used to indicate that no picture from the respective layer tree partition is included in the layer tree. For additional independent layer sets, an encoder may additionally indicate which independent layer becomes the base layer after when applying the non-base layer subtree extraction process. If a layer set contains only one independent non-base layer, the information may be inferred by the encoder and/or the decoder rather than explicitly indicated e.g. in the VPS extension by the encoder and/or decoded e.g. from the VPS extension by the decoder.

Some properties, such as the VPS for the rewritten bitstream and/or HRD parameters (e.g. buffering period, picture timing and/or decoding unit information SEI messages of HEVC), may be included in a specific nesting SEI message that is indicated to apply only in the rewriting process so that nested information is decapsulated. In an embodiment, a nesting SEI message applies to a specified layer set, which may be identified for example by a layer set index. When the layer set index points to a layer set of one or more non-base layer subtrees, it may be concluded to be applied in a rewriting process for that one or more non-base layer subtrees. In an embodiment, an output layer set SEI message, identical or similar to that described above, may be used to indicate an additional layer set to which the nested SEI messages apply.

An encoder may generate one or more VPSs that apply to additional independent layer sets after they have been rewritten as conforming standalone bitstream and include those VPSs e.g. in a VPS rewriting SEI message. The VPS rewriting SEI message or alike may be included in an appropriate nesting SEI message, such as an output layer set nesting SEI message (e.g. as described above). Additionally, an encoder or an HRD verifier or alike may generate HRD parameters that apply to additional independent layer sets after they have been rewritten as conforming standalone bitstream and include those in an appropriate nesting SEI message, such as an output layer set nesting SEI message (e.g. as described above).

An embodiment, which may be applied together with or independently of other embodiments, is described in the following. A non-base layer subtree extraction process may convert one or more non-base layer subtrees to a standalone conforming bitstream. The non-base layer subtree extraction process may get the layer set index lsIdx of an additional independent layer set as input. The non-base layer subtree extraction process may include one or more of the following steps:
It removes NAL units with nuh_layer_id not in the layer set.
It rewrites nuh_layer_id equal to the indicated new base layer associated with lsIdx to 0.
It extracts the VPS from the VPS rewriting SEI message.
It extracts buffering period, picture timing and decoding unit information SEI messages from the output layer set nesting SEI messages.
It removes SEI NAL units with nesting SEI messages that may not apply to the rewritten bitstream.

In an embodiment, which may be applied independently of or together with other embodiments, the encoder or another entity, such as an HRD verifier, may indicate buffering parameters for one or both of the following types of bitstreams: bitstreams where CL-RAS pictures of IRAP pictures for which NoClrasOutputFlag is equal to 1 are present and bitstreams where CL-RAS picture of IRAP pictures for which NoClrasOutputFlag is equal to 1 are not present. For example, CPB buffer size(s) and bitrate(s) may be indicated separately e.g. in VUI for either or both mentioned types of bitstreams. Additionally or alternatively, the encoder or another entity may indicate initial CPB and/or DPB buffering delay and/or other buffering and/or timing parameters for either or both mentioned types of bitstreams. The encoder or another entity may, for example, include a buffering period SEI message into an output layer set nesting SEI message (e.g. with a syntax and semantics the same as or similar to as described above), which may indicate the sub-bitstream, the layer set or the output layer set to which the contained buffering period SEI message applies. The buffering period SEI message of HEVC supports indicating two sets of parameters, one for the case where the leading pictures associated with the IRAP picture (for which the buffering period SEI message is also associated with) are present and another for the case where the leading pictures are not present. In the case when a buffering period SEI message is contained within a scalable nesting SEI message, the latter (alternative) set of parameters may be considered to concern a bitstream where CL-RAS pictures associated with the IRAP picture (for which the buffering period SEI message is also associated with) are not present. Generally, the latter set of buffering parameters may concern a bitstream where CL-RAS pictures associated with an IRAP picture for which NoClrasOutputFlag is equal to 1 are not present. It is to be understood that while specific terms and variable names are used in the description of this embodiment, it can be similarly realized with other terminology and need not use the same or similar variables as long as the decoder operation is similar.

Buffering operation based on bitstream partitions has been proposed and is described in the following mainly in the context of MV-HEVC/SHVC. However, the concept of the presented bitstream partition buffering is generic to any scalable coding. The buffering operation as described below or alike may be used as part of HRD.

A bitstream partition may be defined as a sequence of bits, in the form of a NAL unit stream or a byte stream, that is a subset of a bitstream according to a partitioning. A bitstream partitioning may be for example formed on the basis of layers and/or sub-layers. The bitstream can be partitioned into one or more bitstream partitions. The decoding of bitstream partition 0 (a.k.a. the base bitstream partition) is independent of other bitstream partitions. For example, the base layer (and the NAL units associated with the base layer) may be the base bitstream partition, while bitstream partition 1 may consist of the remaining bitstream excluding the base bitstream partition. A base bitstream partition may be defined as a bitstream partition that is also a conforming bitstream itself. Different bitstream partitionings may for example be used in different output layer sets, and bitstream partitions may therefore be indicated on output layer set basis.

HRD parameters may be given for bitstream partitions. When the HRD parameters are provided for bitstream partitions, the conformance of the bitstream may be tested for bitstream partition based HRD operation in which the hypothetical scheduling and coded picture buffering operate for each bitstream partition.

When bitstream partitions are used by decoder and/or HRD, more than one coded picture buffer, referred to as bitstream partition buffer (BPB0, BPB1, . . . ), is maintained. The bitstream can be partitioned into one or more bitstream partitions. The decoding of bitstream partition 0 (a.k.a. the base bitstream partition) is independent of other bitstream partitions. For example, the base layer (and the NAL units associated with the base layer) may be the base bitstream partition, while bitstream partition 1 may consist of the remaining bitstream excluding the base bitstream partition. In the CPB operation as described herein, the decoding unit (DU) processing periods (from the CPB initial arrival until the CPB removal) can be overlapping in different BPBs. Hence, the HRD model inherently supports parallel processing with an assumption that the decoding process for each bitstream partition is able to decode in real-time the incoming bitstream partition with its scheduled rate.

In an embodiment, which may be applied independently of or together with other embodiments, encoding the buffering parameters may comprise encoding a nesting data structure indicating a bitstream partition and encoding the buffering parameters within the nesting data structure. The buffering period and picture timing information for bitstream partitions may, for example, be conveyed using the buffering period, picture timing and decoding unit information SEI messages included in nesting SEI messages. For example, a bitstream partition nesting SEI message may be used to indicate the bitstream partition to which the nested SEI messages apply. The syntax of the bitstream partition nesting SEI message includes one or more indications which bitstream partitioning and/or which bitstream partition (within the indicated bitstream partitioning) it applies to. The indications may for example be indices that refer to the syntax-level syntax structure where the bitstream partitionings and/or bitstream partitions are specified and where either a partitioning and/or partition is implicitly indexed according to the order it is specified or explicitly indexed with a syntax element, for example. An output layer set nesting SEI message may specify an output layer set to which the contained SEI message applies and may include a bitstream partition nesting SEI message specifying which bitstream partition of the output layer set the SEI message applies to. The bitstream partition nesting SEI message may in turn include one or more buffering period, picture timing and decoding unit information SEI messages for the specified layer set and bitstream partition.

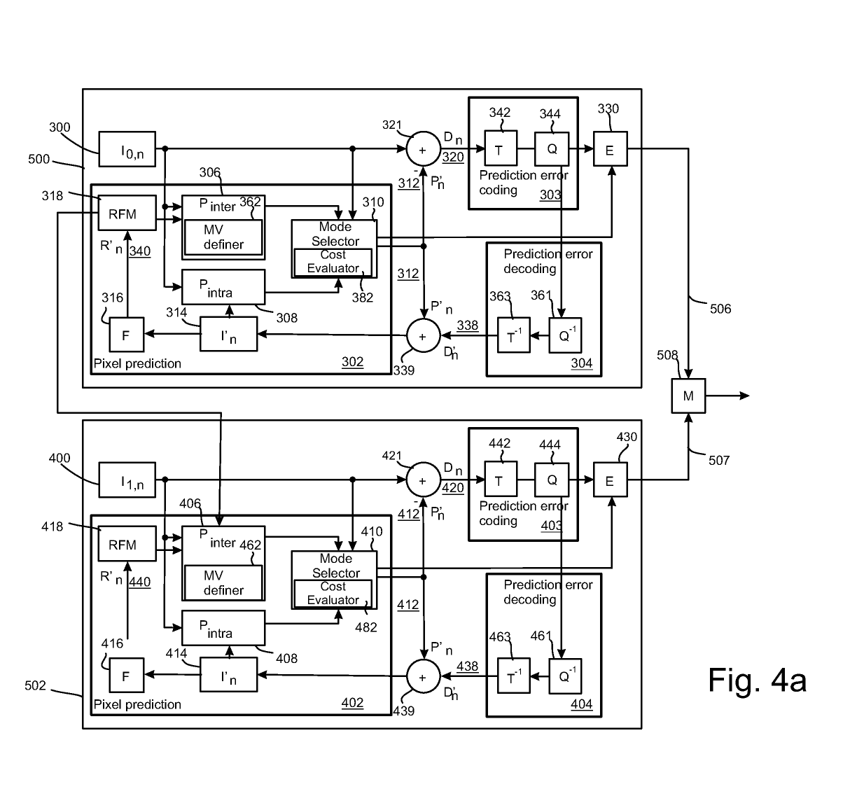

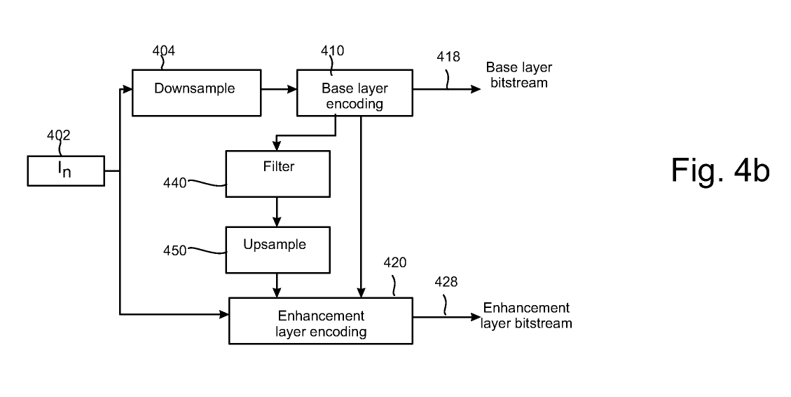

FIG. 4a shows a block diagram of a video encoder suitable for employing embodiments of the invention. FIG. 4a presents an encoder for two layers, but it would be appreciated that presented encoder could be similarly extended to encode more than two layers. FIG. 4a illustrates an embodiment of a video encoder comprising a first encoder section 500 for a base layer and a second encoder section 502 for an enhancement layer. Each of the first encoder section 500 and the second encoder section 502 may comprise similar elements for encoding incoming pictures. The encoder sections 500, 502 may comprise a pixel predictor 302, 402, prediction error encoder 303, 403 and prediction error decoder 304, 404. FIG. 4a also shows an embodiment of the pixel predictor 302, 402 as comprising an inter-predictor 306, 406, an intra-predictor 308, 408, a mode selector 310, 410, a filter 316, 416, and a reference frame memory 318, 418. The pixel predictor 302 of the first encoder section 500 receives 300 base layer images of a video stream to be encoded at both the inter-predictor 306 (which determines the difference between the image and a motion compensated reference frame 318) and the intra-predictor 308 (which determines a prediction for an image block based only on the already processed parts of current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the base layer picture 300. Correspondingly, the pixel predictor 402 of the second encoder section 502 receives 400 enhancement layer images of a video stream to be encoded at both the inter-predictor 406 (which determines the difference between the image and a motion compensated reference frame 418) and the intra-predictor 408 (which determines a prediction for an image block based only on the already processed parts of current frame or picture). The output of both the inter-predictor and the intra-predictor are passed to the mode selector 410. The intra-predictor 408 may have more than one intra-prediction modes. Hence, each mode may perform the intra-prediction and provide the predicted signal to the mode selector 410. The mode selector 410 also receives a copy of the enhancement layer picture 400.

In an embodiment, which may be applied together with or independently of other embodiments, the encoder or alike (such as a HRD verifier) may indicate in the bitstream, e.g. in a VPS or in an SEI message, a second sub-DPB size or alike for a layer or a set of layers containing skip pictures, where the second sub-DPB size excludes the skip pictures. The second sub-DPB size may be indicated in addition to indicating the conventional sub-DPB size or sizes, such as max_vps_dec_pic_buffering_minus 1 [i][k][j] and/or max_vps_layer_dec_pic_buff_minus1[i][k][j] of the present MV-HEVC and SHVC draft specifications. It is to be understood that layer-wise sub-DPB size without the presence of skip pictures and/or sub-DPB size for resolution-specific DPB operation may be indicated.

In an embodiment, which may be applied together with or independently of other embodiments, the decoder or alike (such as HRD) may decode from the bitstream, e.g. from a VPS or from an SEI message, a second sub-DPB size or alike for a layer or a set of layers containing skip pictures, where the second sub-DPB size excludes the skip pictures. The second sub-DPB size may be decoded in addition to decoding the conventional sub-DPB size or sizes, such as max_vps_dec_pic_buffering_minus 1 [i][k][j] and/or max_vps_layer_dec_pic_buff_minus1[i][k][j] of the present MV-HEVC and SHVC draft specifications. It is to be understood that layer-wise sub-DPB size without the presence of skip pictures and/or sub-DPB size for resolution-specific DPB operation may be decoded. The decoder or alike may use the second sub-DPB size or alike to allocate a buffer for decoded pictures. The decoder or alike may omit storage of decoded skip pictures into the DPB. Instead, when a skip picture is used as reference for prediction, the decoder or alike may use the reference-layer picture corresponding to the skip picture as the reference picture for prediction. If the reference-layer picture requires inter-layer processing, such as resampling, before it can be used as reference, the decoder may process, e.g. resample, the reference-layer picture corresponding to the skip picture and use the processed reference-layer picture as reference for prediction.

In an embodiment, which may be applied together with or independently of other embodiments, the encoder or alike (such as a HRD verifier) may indicate in the bitstream, e.g. using a bit position of the slice_reserved[i] syntax element of HEVC slice segment header and/or in an SEI message, that a picture is a skip picture. In an embodiment, which may be applied together with or independently of other embodiments, the encoder or alike (such as a HRD verifier) may decode from the bitstream, e.g. from a bit position of the slice_reserved[i] syntax element of HEVC slice segment header and/or from an SEI message, that a picture is a skip picture.

The mode selector 310 may use, in the cost evaluator block 382, for example Lagrangian cost functions to choose between coding modes and their parameter values, such as motion vectors, reference indexes, and intra prediction direction, typically on block basis. This kind of cost function may use a weighting factor lambda to tie together the (exact or estimated) image distortion due to lossy coding methods and the (exact or estimated) amount of information that is required to represent the pixel values in an image area: C=D+lambda×R, where C is the Lagrangian cost to be minimized, D is the image distortion (e.g. Mean Squared Error) with the mode and their parameters, and R the number of bits needed to represent the required data to reconstruct the image block in the decoder (e.g. including the amount of data to represent the candidate motion vectors).

Depending on which encoding mode is selected to encode the current block, the output of the inter-predictor 306, 406 or the output of one of the optional intra-predictor modes or the output of a surface encoder within the mode selector is passed to the output of the mode selector 310, 410. The output of the mode selector is passed to a first summing device 321, 421. The first summing device may subtract the output of the pixel predictor 302, 402 from the base layer picture 300/enhancement layer picture 400 to produce a first prediction error signal 320, 420 which is input to the prediction error encoder 303, 403.

The pixel predictor 302, 402 further receives from a preliminary reconstructor 339, 439 the combination of the prediction representation of the image block 312, 412 and the output 338, 438 of the prediction error decoder 304, 404. The preliminary reconstructed image 314, 414 may be passed to the intra-predictor 308, 408 and to a filter 316, 416. The filter 316, 416 receiving the preliminary representation may filter the preliminary representation and output a final reconstructed image 340, 440 which may be saved in a reference frame memory 318, 418. The reference frame memory 318 may be connected to the inter-predictor 306 to be used as the reference image against which a future base layer pictures 300 is compared in inter-prediction operations. Subject to the base layer being selected and indicated to be source for inter-layer sample prediction and/or inter-layer motion information prediction of the enhancement layer according to some embodiments, the reference frame memory 318 may also be connected to the inter-predictor 406 to be used as the reference image against which a future enhancement layer pictures 400 is compared in inter-prediction operations. Moreover, the reference frame memory 418 may be connected to the inter-predictor 406 to be used as the reference image against which a future enhancement layer pictures 400 is compared in inter-prediction operations.

Filtering parameters from the filter 316 of the first encoder section 500 may be provided to the second encoder section 502 subject to the base layer being selected and indicated to be source for predicting the filtering parameters of the enhancement layer according to some embodiments.

The prediction error encoder 303, 403 comprises a transform unit 342, 442 and a quantizer 344, 444. The transform unit 342, 442 transforms the first prediction error signal 320, 420 to a transform domain. The transform is, for example, the DCT transform. The quantizer 344, 444 quantizes the transform domain signal, e.g. the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder may be considered to comprise a dequantizer 361, 461, which dequantizes the quantized coefficient values, e.g. DCT coefficients, to reconstruct the transform signal and an inverse transformation unit 363, 463, which performs the inverse transformation to the reconstructed transform signal wherein the output of the inverse transformation unit 363, 463 contains reconstructed block(s). The prediction error decoder may also comprise a block filter which may filter the reconstructed block(s) according to further decoded information and filter parameters.

The entropy encoder 330, 430 receives the output of the prediction error encoder 303, 403 and may perform a suitable entropy encoding/variable length encoding on the signal to provide error detection and correction capability. The outputs of the entropy encoders 330, 430 may be inserted into a bitstream e.g. by a multiplexer 508.

FIG. 4b depicts a higher level block diagram of an embodiment of a spatial scalability encoding apparatus 400 comprising the base layer encoding element 500 and the enhancement layer encoding element 502. The base layer encoding element 500 encodes the input video signal 300 to a base layer bitstream 506 and, respectively, the enhancement layer encoding element 502 encodes the input video signal 300 to an enhancement layer bitstream 507. The spatial scalability encoding apparatus 400 may also comprise a downsampler 404 for downsampling the input video signal if the resolution of the base layer representation and the enhancement layer representation differ from each other. For example, the scaling factor between the base layer and an enhancement layer may be 1:2 wherein the resolution of the enhancement layer is twice the resolution of the base layer (in both horizontal and vertical direction).

The base layer encoding element 500 and the enhancement layer encoding element 502 may comprise similar elements with the encoder depicted in FIG. 4a or they may be different from each other.

In many embodiments the reference frame memories 318, 418 may be capable of storing decoded pictures of different layers or there may be different reference frame memories for storing decoded pictures of different layers.

The operation of the pixel predictors 302, 402 may be configured to carry out any pixel prediction algorithm.

The filter 316 may be used to reduce various artifacts such as blocking, ringing etc. from the reference images.

The filter 316 may comprise e.g. a deblocking filter, a Sample Adaptive Offset (SAO) filter and/or an Adaptive Loop Filter (ALF). In some embodiments the encoder determines which region of the pictures are to be filtered and the filter coefficients based on e.g. RDO and this information is signalled to the decoder.

If the enhancement layer encoding element 502 has selected the SAO filter, it may utilize the SAO algorithm presented above.

The prediction error encoder 303, 403 may comprise a transform unit 342, 442 and a quantizer 344, 444. The transform unit 342, 442 transforms the first prediction error signal 320, 420 to a transform domain. The transform is, for example, the DCT transform. The quantizer 344, 444 quantizes the transform domain signal, e.g. the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder may be considered to comprise a dequantizer 361, 461, which dequantizes the quantized coefficient values, e.g. DCT coefficients, to reconstruct the transform signal and an inverse transformation unit 363, 463, which performs the inverse transformation to the reconstructed transform signal wherein the output of the inverse transformation unit 363, 463 contains reconstructed block(s). The prediction error decoder may also comprise a macroblock filter which may filter the reconstructed macroblock according to further decoded information and filter parameters.

The entropy encoder 330, 430 receives the output of the prediction error encoder 303, 403 and may perform a suitable entropy encoding/variable length encoding on the signal to provide error detection and correction capability. The outputs of the entropy encoders 330, 430 may be inserted into a bitstream e.g. by a multiplexer 508.

In some embodiments the filter 440 comprises the sample adaptive filter, in some other embodiments the filter 440 comprises the adaptive loop filter and in yet some other embodiments the filter 440 comprises both the sample adaptive filter and the adaptive loop filter.

If the resolution of the base layer and the enhancement layer differ from each other, the filtered base layer sample values may need to be upsampled by the upsampler 450. The output of the upsampler 450 i.e. upsampled filtered base layer sample values are then provided to the enhancement layer encoding element 502 as a reference for prediction of pixel values for the current block on the enhancement layer.

For completeness a suitable decoder is hereafter described. However, some decoders may not be able to process enhancement layer data wherein they may not be able to decode all received images. The decoder may examine the received bit stream to determine the values of the two flags such as the inter_layer_pred_for_el_rap_only_flag and the single_layer_for_non_rap_flag. If the value of the first flag indicates that only random access pictures in the enhancement layer may utilize inter-layer prediction and that non-RAP pictures in the enhancement layer never utilize inter-layer prediction, the decoder may deduce that inter-layer prediction is only used with RAP pictures.

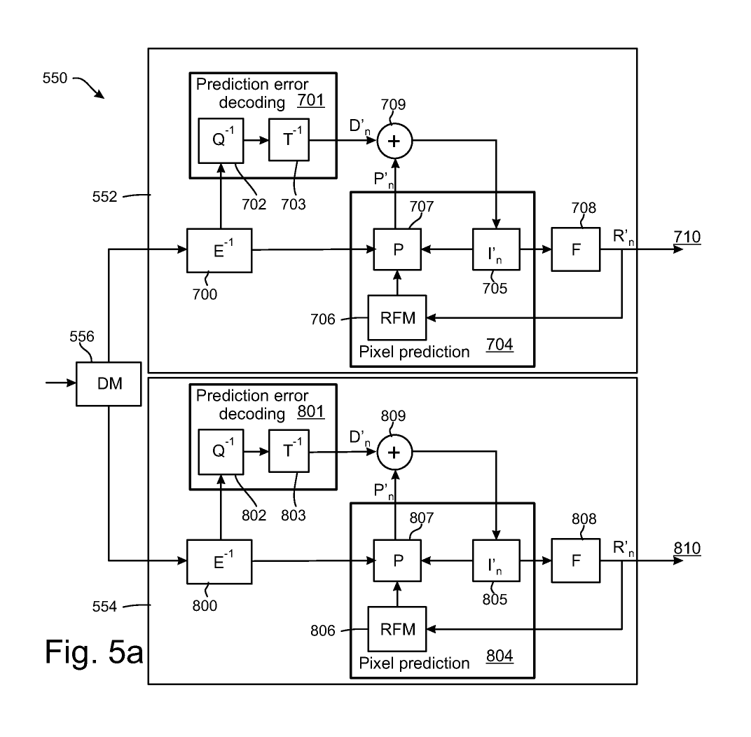

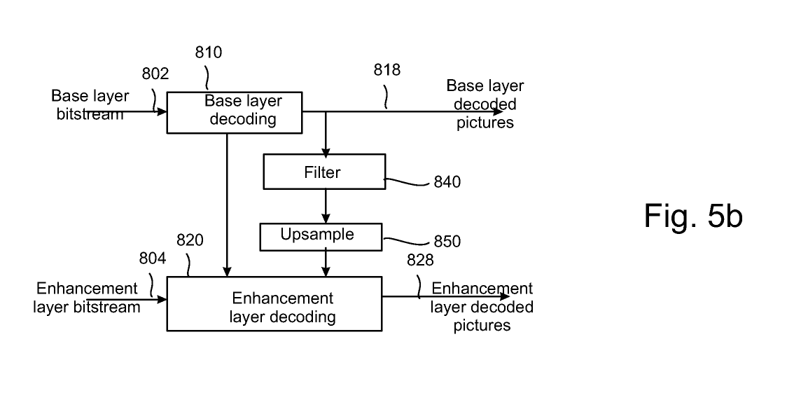

At the decoder side similar operations are performed to reconstruct the image blocks. FIG. 5a shows a block diagram of a video decoder suitable for employing embodiments of the invention. In this embodiment the video decoder 550 comprises a first decoder section 552 for base view components and a second decoder section 554 for non-base view components. Block 556 illustrates a demultiplexer for delivering information regarding base view components to the first decoder section 552 and for delivering information regarding non-base view components to the second decoder section 554. The decoder shows an entropy decoder 700, 800 which performs an entropy decoding (E⁻¹) on the received signal. The entropy decoder thus performs the inverse operation to the entropy encoder 330, 430 of the encoder described above. The entropy decoder 700, 800 outputs the results of the entropy decoding to a prediction error decoder 701, 801 and pixel predictor 704, 804. Reference P′ₙ stands for a predicted representation of an image block. Reference D′ₙ stands for a reconstructed prediction error signal. Blocks 705, 805 illustrate preliminary reconstructed images or image blocks (I′ₙ). Reference R′ₙ stands for a final reconstructed image or image block. Blocks 703, 803 illustrate inverse transform (T⁻¹). Blocks 702, 802 illustrate inverse quantization (Q⁻¹). Blocks 706, 806 illustrate a reference frame memory (RFM). Blocks 707, 807 illustrate prediction (P) (either inter prediction or intra prediction). Blocks 708, 808 illustrate filtering (F). Blocks 709, 809 may be used to combine decoded prediction error information with predicted base view/non-base view components to obtain the preliminary reconstructed images (I′ₙ). Preliminary reconstructed and filtered base view images may be output 710 from the first decoder section 552 and preliminary reconstructed and filtered base view images may be output 810 from the second decoder section 554.

The pixel predictor 704, 804 receives the output of the entropy decoder 700, 800. The output of the entropy decoder 700, 800 may include an indication on the prediction mode used in encoding the current block. A predictor selector 707, 807 within the pixel predictor 704, 804 may determine that the current block to be decoded is an enhancement layer block. Hence, the predictor selector 707, 807 may select to use information from a corresponding block on another layer such as the base layer to filter the base layer prediction block while decoding the current enhancement layer block. An indication that the base layer prediction block has been filtered before using in the enhancement layer prediction by the encoder may have been received by the decoder wherein the pixel predictor 704, 804 may use the indication to provide the reconstructed base layer block values to the filter 708, 808 and to determine which kind of filter has been used, e.g. the SAO filter and/or the adaptive loop filter, or there may be other ways to determine whether or not the modified decoding mode should be used.

The predictor selector may output a predicted representation of an image block P′ₙ to a first combiner 709. The predicted representation of the image block is used in conjunction with the reconstructed prediction error signal D′ₙ to generate a preliminary reconstructed image I′ₙ. The preliminary reconstructed image may be used in the predictor 704, 804 or may be passed to a filter 708, 808. The filter applies a filtering which outputs a final reconstructed signal R′ₙ. The final reconstructed signal R′ₙ may be stored in a reference frame memory 706, 806, the reference frame memory 706, 806 further being connected to the predictor 707, 807 for prediction operations.

The prediction error decoder 702, 802 receives the output of the entropy decoder 700, 800. A dequantizer 702, 802 of the prediction error decoder 702, 802 may dequantize the output of the entropy decoder 700, 800 and the inverse transform block 703, 803 may perform an inverse transform operation to the dequantized signal output by the dequantizer 702, 802. The output of the entropy decoder 700, 800 may also indicate that prediction error signal is not to be applied and in this case the prediction error decoder produces an all zero output signal.

It should be understood that for various blocks in FIG. 5a inter-layer prediction may be applied, even if it is not illustrated in FIG. 5a. Inter-layer prediction may include sample prediction and/or syntax/parameter prediction. For example, a reference picture from one decoder section (e.g. RFM 706) may be used for sample prediction of the other decoder section (e.g. block 807). In another example, syntax elements or parameters from one decoder section (e.g. filter parameters from block 708) may be used for syntax/parameter prediction of the other decoder section (e.g. block 808).

In some embodiments the views may be coded with another standard other than H.264/AVC or HEVC.

FIG. 5b shows a block diagram of a spatial scalability decoding apparatus 800 comprising a base layer decoding element 810 and an enhancement layer decoding element 820. The base layer decoding element 810 decodes the encoded base layer bitstream 802 to a base layer decoded video signal 818 and, respectively, the enhancement layer decoding element 820 decodes the encoded enhancement layer bitstream 804 to an enhancement layer decoded video signal 828. The spatial scalability decoding apparatus 800 may also comprise a filter 840 for filtering reconstructed base layer pixel values and an upsampler 850 for upsampling filtered reconstructed base layer pixel values.

The base layer decoding element 810 and the enhancement layer decoding element 820 may comprise similar elements with the encoder depicted in FIG. 4a or they may be different from each other. In other words, both the base layer decoding element 810 and the enhancement layer decoding element 820 may comprise all or some of the elements of the decoder shown in FIG. 5a. In some embodiments the same decoder circuitry may be used for implementing the operations of the base layer decoding element 810 and the enhancement layer decoding element 820 wherein the decoder is aware the layer it is currently decoding.

It may also be possible to use any enhancement layer post-processing modules used as the preprocessors for the base layer data, including the HEVC SAO and HEVC ALF post-filters. The enhancement layer post-processing modules could be modified when operating on base layer data. For example, certain modes could be disabled or certain new modes could be added.

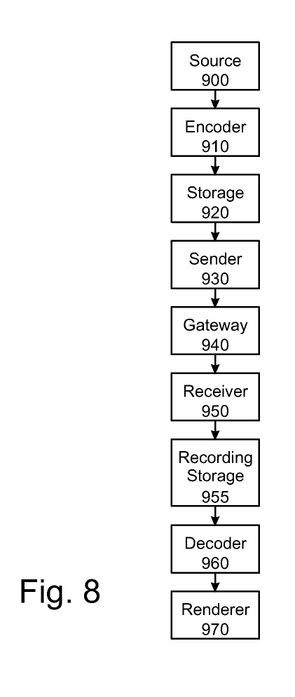

FIG. 8 is a graphical representation of a generic multimedia communication system within which various embodiments may be implemented. As shown in FIG. 8, a data source 900 provides a source signal in an analog, uncompressed digital, or compressed digital format, or any combination of these formats. An encoder 910 encodes the source signal into a coded media bitstream. It should be noted that a bitstream to be decoded can be received directly or indirectly from a remote device located within virtually any type of network. Additionally, the bitstream can be received from local hardware or software. The encoder 910 may be capable of encoding more than one media type, such as audio and video, or more than one encoder 910 may be required to code different media types of the source signal. The encoder 910 may also get synthetically produced input, such as graphics and text, or it may be capable of producing coded bitstreams of synthetic media. In the following, only processing of one coded media bitstream of one media type is considered to simplify the description. It should be noted, however, that typically multimedia services comprise several streams (typically at least one audio and video stream). It should also be noted that the system may include many encoders, but in FIG. 8 only one encoder 910 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream is transferred to a storage 920. The storage 920 may comprise any type of mass memory to store the coded media bitstream. The format of the coded media bitstream in the storage 920 may be an elementary self-contained bitstream format, or one or more coded media bitstreams may be encapsulated into a container file. If one or more media bitstreams are encapsulated in a container file, a file generator (not shown in the figure) may used to store the one more media bitstreams in the file and create file format metadata, which is also stored in the file. The encoder 910 or the storage 920 may comprise the file generator, or the file generator is operationally attached to either the encoder 910 or the storage 920. Some systems operate “live”, i.e. omit storage and transfer coded media bitstream from the encoder 910 directly to the sender 930. The coded media bitstream is then transferred to the sender 930, also referred to as the server, on a need basis. The format used in the transmission may be an elementary self-contained bitstream format, a packet stream format, or one or more coded media bitstreams may be encapsulated into a container file. The encoder 910, the storage 920, and the server 930 may reside in the same physical device or they may be included in separate devices. The encoder 910 and server 930 may operate with live real-time content, in which case the coded media bitstream is typically not stored permanently, but rather buffered for small periods of time in the content encoder 910 and/or in the server 930 to smooth out variations in processing delay, transfer delay, and coded media bitrate.

The server 930 sends the coded media bitstream using a communication protocol stack. The stack may include but is not limited to Real-Time Transport Protocol (RTP), User Datagram Protocol (UDP), and Internet Protocol (IP). When the communication protocol stack is packet-oriented, the server 930 encapsulates the coded media bitstream into packets. For example, when RTP is used, the server 930 encapsulates the coded media bitstream into RTP packets according to an RTP payload format. Typically, each media type has a dedicated RTP payload format. It should be again noted that a system may contain more than one server 930, but for the sake of simplicity, the following description only considers one server 930.

If the media content is encapsulated in a container file for the storage 920 or for inputting the data to the sender 930, the sender 930 may comprise or be operationally attached to a “sending file parser” (not shown in the figure). In particular, if the container file is not transmitted as such but at least one of the contained coded media bitstream is encapsulated for transport over a communication protocol, a sending file parser locates appropriate parts of the coded media bitstream to be conveyed over the communication protocol. The sending file parser may also help in creating the correct format for the communication protocol, such as packet headers and payloads. The multimedia container file may contain encapsulation instructions, such as hint tracks in the ISO Base Media File Format, for encapsulation of the at least one of the contained media bitstream on the communication protocol.

The server 930 may or may not be connected to a gateway 940 through a communication network. The gateway 940, which may also or alternatively be referred to as a middle box or a media-aware network element (MANE), may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 940 include multipoint conference control units (MCUs), gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 940 may be called an RTP mixer or an RTP translator and may act as an endpoint of an RTP connection. There may be zero to any number of gateways in the connection between the sender 930 and the receiver 950.

The system includes one or more receivers 950, typically capable of receiving, de-modulating, and/or de-capsulating the transmitted signal into a coded media bitstream. The coded media bitstream is transferred to a recording storage 955. The recording storage 955 may comprise any type of mass memory to store the coded media bitstream. The recording storage 955 may alternatively or additively comprise computation memory, such as random access memory. The format of the coded media bitstream in the recording storage 955 may be an elementary self-contained bitstream format, or one or more coded media bitstreams may be encapsulated into a container file. If there are multiple coded media bitstreams, such as an audio stream and a video stream, associated with each other, a container file is typically used and the receiver 950 comprises or is attached to a container file generator producing a container file from input streams. Some systems operate “live,” i.e. omit the recording storage 955 and transfer coded media bitstream from the receiver 950 directly to the decoder 960. In some systems, only the most recent part of the recorded stream, e.g., the most recent 10-minute excerption of the recorded stream, is maintained in the recording storage 955, while any earlier recorded data is discarded from the recording storage 955.

The coded media bitstream is transferred from the recording storage 955 to the decoder 960. If there are many coded media bitstreams, such as an audio stream and a video stream, associated with each other and encapsulated into a container file or a single media bitstream is encapsulated in a container file e.g. for easier access, a file parser (not shown in the figure) is used to decapsulate each coded media bitstream from the container file. The recording storage 955 or a decoder 960 may comprise the file parser, or the file parser is attached to either recording storage 955 or the decoder 960.

The coded media bitstream may be processed further by a decoder 960, whose output is one or more uncompressed media streams. Finally, a renderer 970 may reproduce the uncompressed media streams with a loudspeaker or a display, for example. The receiver 950, recording storage 955, decoder 960, and renderer 970 may reside in the same physical device or they may be included in separate devices.

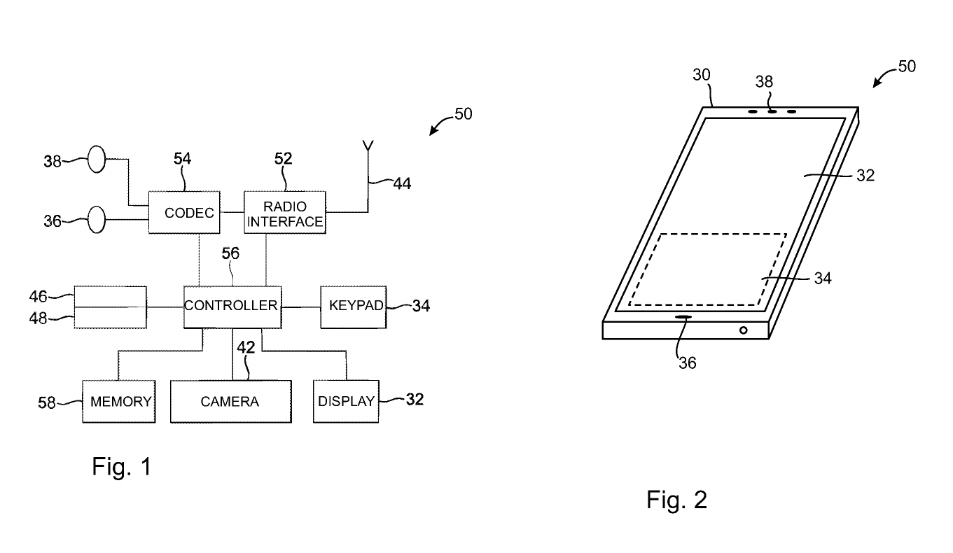

FIG. 1 shows a block diagram of a video coding system according to an example embodiment as a schematic block diagram of an exemplary apparatus or electronic device 50, which may incorporate a codec according to an embodiment of the invention. FIG. 2 shows a layout of an apparatus according to an example embodiment. The elements of FIGS. 1 and 2 will be explained next.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise a camera 42 capable of recording or capturing images and/or video. In some embodiments the apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera capable of recording or detecting individual frames which are then passed to the codec 54 or controller for processing. In some embodiments of the invention, the apparatus may receive the video image data for processing from another device prior to transmission and/or storage. In some embodiments of the invention, the apparatus 50 may receive either wirelessly or by a wired connection the image for coding/decoding.

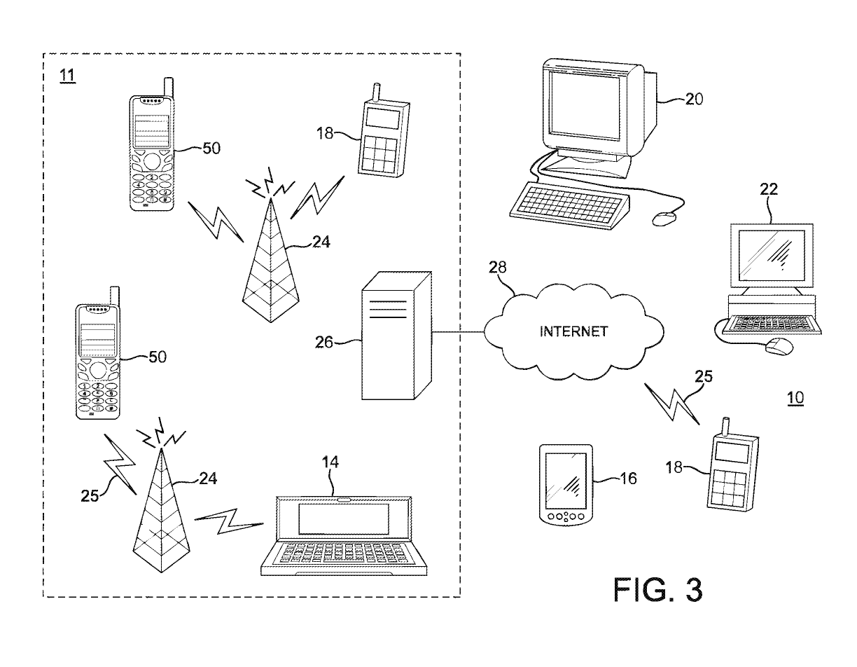

FIG. 3 shows an arrangement for video coding comprising a plurality of apparatuses, networks and network elements according to an example embodiment. With respect to FIG. 3, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention. For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatuses may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

In the above, some embodiments have been described in relation to particular types of parameter sets. It needs to be understood, however, that embodiments could be realized with any type of parameter set or other syntax structure in the bitstream.

In the above, some embodiments have been described in relation to encoding indications, syntax elements, and/or syntax structures into a bitstream or into a coded video sequence and/or decoding indications, syntax elements, and/or syntax structures from a bitstream or from a coded video sequence. It needs to be understood, however, that embodiments could be realized when encoding indications, syntax elements, and/or syntax structures into a syntax structure or a data unit that is external from a bitstream or a coded video sequence comprising video coding layer data, such as coded slices, and/or decoding indications, syntax elements, and/or syntax structures from a syntax structure or a data unit that is external from a bitstream or a coded video sequence comprising video coding layer data, such as coded slices. For example, in some embodiments, an indication according to any embodiment above may be coded into a video parameter set or a sequence parameter set, which is conveyed externally from a coded video sequence for example using a control protocol, such as SDP. Continuing the same example, a receiver may obtain the video parameter set or the sequence parameter set, for example using the control protocol, and provide the video parameter set or the sequence parameter set for decoding.

In the above, the example embodiments have been described with the help of syntax of the bitstream. It needs to be understood, however, that the corresponding structure and/or computer program may reside at the encoder for generating the bitstream and/or at the decoder for decoding the bitstream. Likewise, where the example embodiments have been described with reference to an encoder, it needs to be understood that the resulting bitstream and the decoder have corresponding elements in them. Likewise, where the example embodiments have been described with reference to a decoder, it needs to be understood that the encoder has structure and/or computer program for generating the bitstream to be decoded by the decoder.

In the above, some embodiments have been described with reference to an enhancement layer and a base layer. It needs to be understood that the base layer may as well be any other layer as long as it is a reference layer for the enhancement layer. It also needs to be understood that the encoder may generate more than two layers into a bitstream and the decoder may decode more than two layers from the bitstream. Embodiments could be realized with any pair of an enhancement layer and its reference layer. Likewise, many embodiments could be realized with consideration of more than two layers.

In the above, some embodiments have been described with reference to a single enhancement layer. It needs to be understood that the embodiments are not constrained to encoding and/or decoding only one enhancement layer, but a greater number of enhancement layers may be encoded and/or decoded. For example, an auxiliary picture layer may be encoded and/or decoded. In another example, an additional enhancement layer representing progressive source content may be encoded and/or decoded.

In the above, some embodiments have been described using skip pictures, while some other embodiments have been described using diagonal inter-layer prediction. It needs to be understood that skip pictures and diagonal inter-layer prediction are not necessarily mutually exclusive, and hence embodiments may be similarly realized by using both skip pictures and diagonal inter-layer prediction. For example, in one access unit, a skip picture may be used to realize switching from coded fields to coded frames or vice versa, and in another access unit, diagonal inter-layer prediction may be used realize switching from coded fields to coded frames or vice versa.

In the above, some embodiments have been described with reference to interlaced source content. It needs to be understood that embodiments may be applied in ignorance of the scan type of the source content. In other words, embodiments may similarly apply to progressive source content and/or to a mixture of interlaced and progressive source content.

In the above, some embodiments have been described with reference to a single encoder and/or to a single decoder. It needs to be understood that more than one encoder and/or more than one decoder may be used similarly in the embodiments. For example, one encoder and/or one decoder may be used per each coded and/or decoded layer.

Although the above examples describe embodiments of the invention operating within a codec within an electronic device, it would be appreciated that the invention as described below may be implemented as part of any video codec. Thus, for example, embodiments of the invention may be implemented in a video codec which may implement video coding over fixed or wired communication paths.

Thus, user equipment may comprise a video codec such as those described in embodiments of the invention above. It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatuses, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The various embodiments of the invention can be implemented with the help of computer program code that resides in a memory and causes the relevant apparatuses to carry out the invention. For example, a terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys Inc., of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

In the following some examples will be provided.

According to a first example there is provided a method comprising:

receiving one or more indications to determine if a switching point from decoding coded fields to decoding coded frames or from decoding coded frames to decoding coded fields exists in a bit stream, wherein if the switching point exists, the method further comprises:

as a response to determining a switching point from decoding coded fields to decoding coded frames, performing the following:

receiving a first coded frame of a first scalability layer and a second coded field of a second scalability layer;

reconstructing the first coded frame into a first reconstructed frame;

resampling the first reconstructed frame into a first reference picture; and

decoding the second coded field to a second reconstructed field, wherein the decoding comprises using the first reference picture as a reference for prediction of the second coded field;

as a response to determining a switching point from decoding coded frames to decoding coded fields, performing the following:

decoding a first pair of coded fields of a third scalability layer to a first reconstructed complementary field pair or decoding a first coded field of a third scalability layer to a first reconstructed field;

resampling one or both fields of the first reconstructed complementary field pair or the first reconstructed field into a second reference picture;

decoding a second coded frame of a fourth scalability layer to a second reconstructed frame, wherein the decoding comprises using the second reference picture as a reference for prediction of the second coded frame.

In some embodiments the method comprises one or more of the following:

receiving an indication of the first reference picture;

receiving an indication of the second reference picture.

In some embodiments the method comprises:

receiving an indication of at least one of said first scalability layer, second scalability layer, third scalability layer and fourth scalability layer, whether the scalability layer comprises coded pictures representing coded fields or coded frames.

In some embodiments the method comprises:

using one layer as the first scalability layer and the fourth scalability layer; and

using another one layer as the second scalability layer and the third scalability layer.

In some embodiments the one layer is a base layer of a scalable video coding; and the another one layer is an enhancement layer of the scalable video coding.

In some embodiments the another one layer is a base layer of a scalable video coding; and the one layer is an enhancement layer of the scalable video coding.

In some embodiments the one layer is a first enhancement layer of a scalable video coding; and the another one layer is another enhancement layer of the scalable video coding.

In some embodiments the method comprises:

providing a scalability layer hierarchy comprising a plurality of scalability layers ordered in an ascending order of video quality enhancement; and

as a response to determining a switching point from decoding coded fields to decoding coded frames, using as the second scalability layer a scalability layer which is higher than the first scalability layer in the scalability layer hierarchy.

In some embodiments the method comprises:

providing a scalability layer hierarchy comprising a plurality of scalability layers ordered in an ascending order of video quality enhancement; and

as a response to determining a switching point from decoding coded frames to decoding coded fields, using as the fourth scalability layer a scalability layer which is higher than the third scalability layer in the scalability layer hierarchy.

In some embodiments the method comprises:

diagonally predicting the second reference picture from the first pair of coded fields.

In some embodiments the method comprises:

decoding the second reference picture as a picture not to be output.

According to a second example there is provided an apparatus comprising at least one processor and at least one memory including computer program code, the at least one memory and the computer program code configured to, with the at least one processor, cause the apparatus to:

receive one or more indications to determine if a switching point from decoding coded fields to decoding coded frames or from decoding coded frames to decoding coded fields exists in a bit stream, wherein if the switching point exists, the method further comprises:

as a response to determining a switching point from decoding coded fields to decoding coded frames, to perform the following:

receive a first coded frame of a first scalability layer and a second coded field of a second scalability layer;

reconstruct the first coded frame into a first reconstructed frame;

resample the first reconstructed frame into a first reference picture; and

decode the second coded field to a second reconstructed field, wherein the decoding comprises using the first reference picture as a reference for prediction of the second coded field;

as a response to determining a switching point from decoding coded frames to decoding coded fields, to perform the following:

decode a first pair of coded fields of a third scalability layer to a first reconstructed complementary field pair or decoding a first coded field of a third scalability layer to a first reconstructed field;

resample one or both fields of the first reconstructed complementary field pair or the first reconstructed field into a second reference picture;

decode a second coded frame of a fourth scalability layer to a second reconstructed frame, wherein the decoding comprises using the second reference picture as a reference for prediction of the second coded frame.

In some embodiments of the apparatus said at least one memory stored with code thereon, which when executed by said at least one processor, causes the apparatus to perform at least the following:

receive an indication of the first reference picture;

receive an indication of the second reference picture.

In some embodiments of the apparatus said at least one memory stored with code thereon, which when executed by said at least one processor, causes the apparatus to perform at least the following:

receive an indication of at least one of said first scalability layer, second scalability layer, third scalability layer and fourth scalability layer, whether the scalability layer comprises coded pictures representing coded fields or coded frames.

In some embodiments of the apparatus said at least one memory stored with code thereon, which when executed by said at least one processor, causes the apparatus to perform at least the following:

use one layer as the first scalability layer and the fourth scalability layer; and

use another one layer as the second scalability layer and the third scalability layer.

In some embodiments the one layer is a base layer of a scalable video coding; and the another one layer is an enhancement layer of the scalable video coding.

In some embodiments the another one layer is a base layer of a scalable video coding; and the one layer is an enhancement layer of the scalable video coding.

In some embodiments the one layer is a first enhancement layer of a scalable video coding; and the another one layer is another enhancement layer of the scalable video coding.

In some embodiments of the apparatus said at least one memory stored with code thereon, which when executed by said at least one processor, causes the apparatus to perform at least the following:

provide a scalability layer hierarchy comprising a plurality of scalability layers ordered in an ascending order of video quality enhancement; and

as a response to determining a switching point from decoding coded fields to decoding coded frames, to use as the second scalability layer a scalability layer which is higher than the first scalability layer in the scalability layer hierarchy.

In some embodiments of the apparatus said at least one memory stored with code thereon, which when executed by said at least one processor, causes the apparatus to perform at least the following:

provide a scalability layer hierarchy comprising a plurality of scalability layers ordered in an ascending order of video quality enhancement; and

as a response to determining a switching point from decoding coded frames to decoding coded fields, to use as the fourth scalability layer a scalability layer which is higher than the third scalability layer in the scalability layer hierarchy.

In some embodiments of the apparatus said at least one memory stored with code thereon, which when executed by said at least one processor, causes the apparatus to perform at least the following:

diagonally predict the second reference picture from the first pair of coded fields.

In some embodiments of the apparatus said at least one memory stored with code thereon, which when executed by said at least one processor, causes the apparatus to perform at least the following:

decode the second reference picture as a picture not to be output.

According to a third example there is provided a computer program product embodied on a non-transitory computer readable medium, comprising computer program code configured to, when executed on at least one processor, cause an apparatus or a system to:

receive one or more indications to determine if a switching point from decoding coded fields to decoding coded frames or from decoding coded frames to decoding coded fields exists in a bit stream, wherein if the switching point exists, the method further comprises:

as a response to determining a switching point from decoding coded fields to decoding coded frames, to perform the following:

receive a first coded frame of a first scalability layer and a second coded field of a second scalability layer;

reconstruct the first coded frame into a first reconstructed frame;

resample the first reconstructed frame into a first reference picture; and

decode the second coded field to a second reconstructed field, wherein the decoding comprises using the first reference picture as a reference for prediction of the second coded field;

as a response to determining a switching point from decoding coded frames to decoding coded fields, to perform the following:

decode a first pair of coded fields of a third scalability layer to a first reconstructed complementary field pair or decoding a first coded field of a third scalability layer to a first reconstructed field;

resample one or both fields of the first reconstructed complementary field pair or the first reconstructed field into a second reference picture;

decode a second coded frame of a fourth scalability layer to a second reconstructed frame, wherein the decoding comprises using the second reference picture as a reference for prediction of the second coded frame.

In some embodiments the computer program product comprises computer program code configured to, when executed by said at least one processor, causes the apparatus or the system to perform at least the following:

receive an indication of the first reference picture;

receive an indication of the second reference picture.

In some embodiments the computer program product comprises computer program code configured to, when executed by said at least one processor, causes the apparatus or the system to perform at least the following:

receive an indication of at least one of said first scalability layer, second scalability layer, third scalability layer and fourth scalability layer, whether the scalability layer comprises coded pictures representing coded fields or coded frames.

In some embodiments the computer program product comprises computer program code configured to, when executed by said at least one processor, causes the apparatus or the system to perform at least the following:

use one layer as the first scalability layer and the fourth scalability layer; and

use another one layer as the second scalability layer and the third scalability layer.

In some embodiments the one layer is a base layer of a scalable video coding; and the another one layer is an enhancement layer of the scalable video coding.

In some embodiments the another one layer is a base layer of a scalable video coding; and the one layer is an enhancement layer of the scalable video coding.

In some embodiments the one layer is a first enhancement layer of a scalable video coding; and the another one layer is another enhancement layer of the scalable video coding.

In some embodiments the computer program product comprises computer program code configured to, when executed by said at least one processor, causes the apparatus or the system to perform at least the following:

provide a scalability layer hierarchy comprising a plurality of scalability layers ordered in an ascending order of video quality enhancement; and

as a response to determining a switching point from decoding coded fields to decoding coded frames, to use as the second scalability layer a scalability layer which is higher than the first scalability layer in the scalability layer hierarchy.

In some embodiments the computer program product comprises computer program code configured to, when executed by said at least one processor, causes the apparatus or the system to perform at least the following:

provide a scalability layer hierarchy comprising a plurality of scalability layers ordered in an ascending order of video quality enhancement; and

as a response to determining a switching point from decoding coded frames to decoding coded fields, to use as the fourth scalability layer a scalability layer which is higher than the third scalability layer in the scalability layer hierarchy.

In some embodiments the computer program product comprises computer program code configured to, when executed by said at least one processor, causes the apparatus or the system to perform at least the following:

diagonally predict the second reference picture from the first pair of coded fields.

In some embodiments the computer program product comprises computer program code configured to, when executed by said at least one processor, causes the apparatus or the system to perform at least the following:

decode the second reference picture as a picture not to be output.

According to a fourth example, there is provided a method comprising:

receiving a first uncompressed complementary field pair and a second uncompressed complementary field pair;

determining whether to encode the first complementary field pair as a first coded frame or a first pair of coded fields and the second uncompressed complementary field pair as a second coded frame or a second pair of coded fields;

as a response to determining the first complementary field pair to be encoded as the first coded frame and the second uncompressed complementary field pair to be encoded as the second pair of coded fields, performing the following:

encoding the first complementary field pair as the first coded frame of a first scalability layer;

reconstructing the first coded frame into a first reconstructed frame;

resampling the first reconstructed frame into a first reference picture; and

encoding the second complementary field pair as the second pair of coded fields of a second scalability layer, wherein the encoding comprises using the first reference picture as a reference for prediction of at least one field of the second pair of coded fields;

as a response to determining the first complementary field pair to be encoded as the first pair of coded fields and the second uncompressed complementary field pair to be encoded as the second coded frame, performing the following:

encoding the first complementary field pair as the first pair of coded fields of a third scalability layer;

reconstructing at least one of the first pair of coded fields into at least one of a first reconstructed field and a second reconstructed field;

resampling one or both of the first reconstructed field and the second reconstructed field into a second reference picture; and

encoding the second complementary field pair as the second coded frame of a fourth scalability layer, wherein the encoding comprises using the second reference picture as a reference for prediction of the second coded frame.

In some embodiments the method comprises one or more of the following:

providing an indication of the first reference picture;
providing an indication of the second reference picture.

In some embodiments the method comprises:

providing an indication for at least one of said first scalability layer, second scalability layer, third scalability layer and fourth scalability layer, whether the scalability layer comprises coded pictures representing coded fields or coded frames.

In some embodiments the method comprises:

using one layer as the first scalability layer and the fourth scalability layer; and
using another one layer as the second scalability layer and the third scalability layer.

In some embodiments the one layer is a base layer of a scalable video coding; and the another one layer is an enhancement layer of the scalable video coding.

In some embodiments the another one layer is a base layer of a scalable video coding; and the one layer is an enhancement layer of the scalable video coding.

In some embodiments the one layer is a first enhancement layer of a scalable video coding; and the another one layer is another enhancement layer of the scalable video coding.

In some embodiments the method comprises:

providing a scalability layer hierarchy comprising a plurality of scalability layers ordered in an ascending order of video quality enhancement; and

as a response to determining to encode the first complementary field pair as the first coded frame and the second uncompressed complementary field pair as the second pair of coded fields, using as the second scalability layer a scalability layer which is higher than the first scalability layer in the scalability layer hierarchy.

In some embodiments the method comprises:

providing a scalability layer hierarchy comprising a plurality of scalability layers ordered in an ascending order of video quality enhancement; and

as a response to determining to encode the first complementary field pair as the first pair of coded fields and the second uncompressed complementary field pair as the second coded frame, using as the fourth scalability layer a scalability layer which is higher than the third scalability layer in the scalability layer hierarchy.

In some embodiments the method comprises:

diagonally predicting the second reference picture from the first pair of coded fields.

In some embodiments the method comprises:

encoding the second reference picture as a picture not to be output from a decoding process.

According to a fifth example there is provided an apparatus comprising at least one processor and at least one memory including computer program code, the at least one memory and the computer program code configured to, with the at least one processor, cause the apparatus to:

receive a first uncompressed complementary field pair and a second uncompressed complementary field pair;

determine whether to encode the first complementary field pair as a first coded frame or a first pair of coded fields and the second uncompressed complementary field pair as a second coded frame or a second pair of coded fields;

as a response to determining the first complementary field pair to be encoded as the first coded frame and the second uncompressed complementary field pair to be encoded as the second pair of coded fields, to perform the following:

encode the first complementary field pair as the first coded frame of a first scalability layer;

reconstruct the first coded frame into a first reconstructed frame;

resample the first reconstructed frame into a first reference picture; and

encode the second complementary field pair as the second pair of coded fields of a second scalability layer by using the first reference picture as a reference for prediction of at least one field of the second pair of coded fields;

as a response to determining the first complementary field pair to be encoded as the first pair of coded fields and the second uncompressed complementary field pair to be encoded as the second coded frame, to perform the following:

encode the first complementary field pair as the first pair of coded fields of a third scalability layer;

reconstruct at least one of the first pair of coded fields into at least one of a first reconstructed field and a second reconstructed field;

resample one or both of the first reconstructed field and the second reconstructed field into a second reference picture; and

encode the second complementary field pair as the second coded frame of a fourth scalability layer by using the second reference picture as a reference for prediction of the second coded frame.

In some embodiments of the apparatus said at least one memory stored with code thereon, which when executed by said at least one processor, causes the apparatus to perform at least the following:

provide an indication of the first reference picture;

provide an indication of the second reference picture.

In some embodiments of the apparatus said at least one memory stored with code thereon, which when executed by said at least one processor, causes the apparatus to perform at least the following:

provide an indication for at least one of said first scalability layer, second scalability layer, third scalability layer and fourth scalability layer, whether the scalability layer comprises coded pictures representing coded fields or coded frames.

In some embodiments of the apparatus said at least one memory stored with code thereon, which when executed by said at least one processor, causes the apparatus to perform at least the following:

use one layer as the first scalability layer and the fourth scalability layer; and

use another one layer as the second scalability layer and the third scalability layer.

In some embodiments the one layer is a base layer of a scalable video coding; and the another one layer is an enhancement layer of the scalable video coding.

In some embodiments the another one layer is a base layer of a scalable video coding; and the one layer is an enhancement layer of the scalable video coding.

In some embodiments the one layer is a first enhancement layer of a scalable video coding; and the another one layer is another enhancement layer of the scalable video coding.

In some embodiments of the apparatus said at least one memory stored with code thereon, which when executed by said at least one processor, causes the apparatus to perform at least the following:

provide a scalability layer hierarchy comprising a plurality of scalability layers ordered in an ascending order of video quality enhancement; and

as a response to determining to encode the first complementary field pair as the first coded frame and the second uncompressed complementary field pair as the second pair of coded fields, to use as the second scalability layer a scalability layer which is higher than the first scalability layer in the scalability layer hierarchy.

In some embodiments of the apparatus said at least one memory stored with code thereon, which when executed by said at least one processor, causes the apparatus to perform at least the following:

provide a scalability layer hierarchy comprising a plurality of scalability layers ordered in an ascending order of video quality enhancement; and

as a response to determining to encode the first complementary field pair as the first pair of coded fields and the second uncompressed complementary field pair as the second coded frame, to use as the fourth scalability layer a scalability layer which is higher than the third scalability layer in the scalability layer hierarchy.

In some embodiments of the apparatus said at least one memory stored with code thereon, which when executed by said at least one processor, causes the apparatus to perform at least the following:

diagonally predict the second reference picture from the first pair of coded fields.

In some embodiments of the apparatus said at least one memory stored with code thereon, which when executed by said at least one processor, causes the apparatus to perform at least the following:

encode the second reference picture as a picture not to be output from a decoding process.

According to a sixth example there is provided a computer program product embodied on a non-transitory computer readable medium, comprising computer program code configured to, when executed on at least one processor, cause an apparatus or a system to:

receive a first uncompressed complementary field pair and a second uncompressed complementary field pair;

determine whether to encode the first complementary field pair as a first coded frame or a first pair of coded fields and the second uncompressed complementary field pair as a second coded frame or a second pair of coded fields;

as a response to determining the first complementary field pair to be encoded as the first coded frame and the second uncompressed complementary field pair to be encoded as the second pair of coded fields, to perform the following:

encode the first complementary field pair as the first coded frame of a first scalability layer;

reconstruct the first coded frame into a first reconstructed frame;

resample the first reconstructed frame into a first reference picture; and

encode the second complementary field pair as the second pair of coded fields of a second scalability layer by using the first reference picture as a reference for prediction of at least one field of the second pair of coded fields;

as a response to determining the first complementary field pair to be encoded as the first pair of coded fields and the second uncompressed complementary field pair to be encoded as the second coded frame, to perform the following:

encode the first complementary field pair as the first pair of coded fields of a third scalability layer;

reconstruct at least one of the first pair of coded fields into at least one of a first reconstructed field and a second reconstructed field;

resample one or both of the first reconstructed field and the second reconstructed field into a second reference picture;

encode the second complementary field pair as the second coded frame of a fourth scalability layer by using the second reference picture as a reference for prediction of the second coded frame.

In some embodiments the computer program product comprises computer program code configured to, when executed by said at least one processor, causes the apparatus or the system to perform at least the following:

provide an indication of the first reference picture;

provide an indication of the second reference picture.

In some embodiments the computer program product comprises computer program code configured to, when executed by said at least one processor, causes the apparatus or the system to perform at least the following:

provide an indication for at least one of said first scalability layer, second scalability layer, third scalability layer and fourth scalability layer, whether the scalability layer comprises coded pictures representing coded fields or coded frames.

In some embodiments the computer program product comprises computer program code configured to, when executed by said at least one processor, causes the apparatus or the system to perform at least the following:

use one layer as the first scalability layer and the fourth scalability layer; and

use another one layer as the second scalability layer and the third scalability layer.

In some embodiments the one layer is a base layer of a scalable video coding; and the another one layer is an enhancement layer of the scalable video coding.

In some embodiments the another one layer is a base layer of a scalable video coding; and the one layer is an enhancement layer of the scalable video coding.

In some embodiments the one layer is a first enhancement layer of a scalable video coding; and the another one layer is another enhancement layer of the scalable video coding.

In some embodiments the computer program product comprises computer program code configured to, when executed by said at least one processor, causes the apparatus or the system to perform at least the following:

provide a scalability layer hierarchy comprising a plurality of scalability layers ordered in an ascending order of video quality enhancement; and

as a response to determining to encode the first complementary field pair as the first coded frame and the second uncompressed complementary field pair as the second pair of coded fields, to use as the second scalability layer a scalability layer which is higher than the first scalability layer in the scalability layer hierarchy.

In some embodiments the computer program product comprises computer program code configured to, when executed by said at least one processor, causes the apparatus or the system to perform at least the following:

provide a scalability layer hierarchy comprising a plurality of scalability layers ordered in an ascending order of video quality enhancement; and

as a response to determining to encode the first complementary field pair as the first pair of coded fields and the second uncompressed complementary field pair as the second coded frame, to use as the fourth scalability layer a scalability layer which is higher than the third scalability layer in the scalability layer hierarchy.

In some embodiments the computer program product comprises computer program code configured to, when executed by said at least one processor, causes the apparatus or the system to perform at least the following:

diagonally predict the second reference picture from the first pair of coded fields.

In some embodiments the computer program product comprises computer program code configured to, when executed by said at least one processor, causes the apparatus or the system to perform at least the following:

encode the second reference picture as a picture not to be output from a decoding process.

According to a seventh example there is provided a video decoder configured for decoding a bitstream of picture data units, wherein said video decoder is further configured for:

receiving one or more indications to determine if a switching point from decoding coded fields to decoding coded frames or from decoding coded frames to decoding coded fields exists in a bit stream, wherein if the switching point exists, the method further comprises:

as a response to determining a switching point from decoding coded fields to decoding coded frames, performing the following:

receiving a first coded frame of a first scalability layer and a second coded field of a second scalability layer;

reconstructing the first coded frame into a first reconstructed frame;

resampling the first reconstructed frame into a first reference picture; and

decoding the second coded field to a second reconstructed field, wherein the decoding comprises using the first reference picture as a reference for prediction of the second coded field;

as a response to determining a switching point from decoding coded frames to decoding coded fields, performing the following:

decoding a first pair of coded fields of a third scalability layer to a first reconstructed complementary field pair or decoding a first coded field of a third scalability layer to a first reconstructed field;

resampling one or both fields of the first reconstructed complementary field pair or the first reconstructed field into a second reference picture;

decoding a second coded frame of a fourth scalability layer to a second reconstructed frame, wherein the decoding comprises using the second reference picture as a reference for prediction of the second coded frame.

According to an eighth example, there is provided a video encoder configured for encoding a bitstream of picture data units, wherein said video encoder is further configured for:

receiving a first uncompressed complementary field pair and a second uncompressed complementary field pair;

determining whether to encode the first complementary field pair as a first coded frame or a first pair of coded fields and the second uncompressed complementary field pair as a second coded frame or a second pair of coded fields;

as a response to determining the first complementary field pair to be encoded as the first coded frame and the second uncompressed complementary field pair to be encoded as the second pair of coded fields, performing the following:

encoding the first complementary field pair as the first coded frame of a first scalability layer;

reconstructing the first coded frame into a first reconstructed frame;

resampling the first reconstructed frame into a first reference picture; and

encoding the second complementary field pair as the second pair of coded fields of a second scalability layer, wherein the encoding comprises using the first reference picture as a reference for prediction of at least one field of the second pair of coded fields;

as a response to determining the first complementary field pair to be encoded as the first pair of coded fields and the second uncompressed complementary field pair to be encoded as the second coded frame, performing the following:

encoding the first complementary field pair as the first pair of coded fields of a third scalability layer;

reconstructing at least one of the first pair of coded fields into at least one of a first reconstructed field and a second reconstructed field;

resampling one or both of the first reconstructed field and the second reconstructed field into a second reference picture; and

encoding the second complementary field pair as the second coded frame of a fourth scalability layer, wherein the encoding comprises using the second reference picture as a reference for prediction of the second coded frame.

We claim:

1. A method comprising:
decoding a data structure that is associated with a base-layer picture and an enhancement-layer picture in a file or a stream comprising a base layer of a first video bitstream and/or an enhancement layer of a second video bitstream, wherein the enhancement layer may be predicted from the base layer;
decoding from the data structure first information that is indicative of whether the base-layer picture is regarded as an intra random access point picture for enhancement layer decoding; and
provided that the base-layer picture is regarded as an intra random access point picture for enhancement layer decoding, decoding from the data structure second information that is indicative of the type of the intra random access point picture for the decoded base-layer picture to be used in the enhancement layer decoding.

2. The method according to claim 1 further comprising:
decoding the data structure from sample auxiliary information of ISO Base Media File Format of a track comprising the enhancement layer.

3. The method according to claim 1 further comprising
decoding the data structure from a supplemental enhancement information message within the enhancement layer.

4. The method according to claim 1 further comprising:
decoding the data structure from a packet payload header of a packet comprising the enhancement-layer picture fully or partly.

5. The method according to claim 1 further comprising decoding the enhancement-layer picture by using the decoded base-layer picture and the first information decoded from the data structure and, provided that the base-layer picture is regarded as an intra random access point picture for enhancement layer decoding, the second information as inputs.

6. An apparatus comprising at least one processor and at least one memory including computer program code, the at least one memory and the computer program code configured to, with the at least one processor, cause the apparatus to:
decode a data structure that is associated with a base-layer picture and an enhancement-layer picture in a file or a stream comprising a base layer of a first video bitstream and/or an enhancement layer of a second video bitstream, wherein the enhancement layer may be predicted from the base layer;
decode from the data structure first information that is indicative of whether the base-layer picture is regarded as an intra random access point picture for enhancement layer decoding; and
provided that the base-layer picture is regarded as an intra random access point picture for enhancement layer decoding, decoding from the data structure second information that is indicative of the type of the intra random access point picture for the decoded base-layer picture to be used in the enhancement layer decoding.

7. The apparatus according to claim 6, said at least one memory stored with code thereon, which when executed by said at least one processor, causes the apparatus to perform at least the following:
decode the data structure from sample auxiliary information of ISO Base Media File Format of a track comprising the enhancement layer.

8. The apparatus according to claim 6, said at least one memory stored with code thereon, which when executed by said at least one processor, causes the apparatus to perform at least the following:
decode the data structure from a supplemental enhancement information message within the enhancement layer.

9. The apparatus according to claim 6, said at least one memory stored with code thereon, which when executed by said at least one processor, causes the apparatus to perform at least the following:
decode the data structure from a packet payload header of a packet comprising the enhancement-layer picture fully or partly.

10. The apparatus according to claim 6, said at least one memory stored with code thereon, which when executed by said at least one processor, causes the apparatus to perform at least the following:
decode the enhancement-layer picture by using the decoded base-layer picture and the first information decoded from the data structure and, provided that the base-layer picture is regarded as an intra random access point picture for enhancement layer decoding, the second information as inputs.

11. A computer program product embodied on a non-transitory computer readable medium, comprising computer program code configured to, when executed on at least one processor, cause an apparatus or a system to:
decode a data structure that is associated with a base-layer picture and an enhancement-layer picture in a file or a stream comprising a base layer of a first video bitstream and/or an enhancement layer of a second video bitstream, wherein the enhancement layer may be predicted from the base layer;
decode from the data structure first information that is indicative of whether the base-layer picture is regarded as an intra random access point picture for enhancement layer decoding; and
provided that the base-layer picture is regarded as an intra random access point picture for enhancement layer decoding, decode from the data structure second information indicative of the type of the IRAP picture for the decoded base-layer picture to be used in the enhancement layer decoding.

12. A method comprising:
encoding a data structure that is associated with a base-layer picture and an enhancement-layer picture in a file or a stream comprising a base layer of a first video bitstream and/or an enhancement layer of a second video bitstream, wherein the enhancement layer may be predicted from the base layer;
encoding into the data structure first information that is indicative of whether the base-layer picture is regarded as an intra random access point picture for enhancement layer decoding; and
provided that the base-layer picture is regarded as an intra random access point picture for enhancement layer decoding; encoding into the data structure second information that is indicative of the type of the intra random access point picture for the decoded base-layer picture to be used in the enhancement layer decoding.

13. The method according to claim 12 further comprising:
encoding the data structure as sample auxiliary information of ISO Base Media File Format for a track comprising the enhancement layer.

14. The method according to claim 12 further comprising
encoding the data structure as a supplemental enhancement information message into the enhancement layer.

15. The method according to claim 12 further comprising:
encoding the data structure into a packet payload header of a packet comprising the enhancement-layer picture fully or partly.

16. An apparatus comprising at least one processor and at least one memory including computer program code, the at least one memory and the computer program code configured to, with the at least one processor, cause the apparatus to:
encode a data structure that is associated with a base-layer picture and an enhancement-layer picture in a file or a stream comprising a base layer of a first video bitstream and/or an enhancement layer of a second video bitstream, wherein the enhancement layer may be predicted from the base layer;
encode into the data structure first information that is indicative of whether the base-layer picture is regarded as an intra random access point picture for enhancement layer decoding; and
provided that the base-layer picture is regarded as an intra random access point picture for enhancement layer decoding; encoding into the data structure second information that is further indicative of the type of the intra random access point picture for the decoded base-layer picture to be used in the enhancement layer decoding.

17. The apparatus according to claim 16, said at least one memory stored with code thereon, which when executed by said at least one processor, causes the apparatus to perform at least the following:
encode the data structure as sample auxiliary information of ISO Base Media File Format for a track comprising the enhancement layer.

18. The apparatus according to claim 16, said at least one memory stored with code thereon, which when executed by said at least one processor, causes the apparatus to perform at least the following:
encode the data structure as a supplemental enhancement information message into the enhancement layer.

19. The apparatus according to claim 16, said at least one memory stored with code thereon, which when executed by said at least one processor, causes the apparatus to perform at least the following:
encode the data structure into a packet payload header of a packet comprising the enhancement-layer picture fully or partly.

20. A computer program product embodied on a non-transitory computer readable medium, comprising computer program code configured to, when executed on at least one processor, cause an apparatus or a system to:
encode a data structure that is associated with a base-layer picture and an enhancement-layer picture in a file or a stream comprising a base layer of a first video bitstream and/or an enhancement layer of a second video bitstream, wherein the enhancement layer may be predicted from the base layer;
encode into the data structure first information that is indicative of whether the base-layer picture is regarded as an intra random access point picture for enhancement layer decoding; and
provided that the base-layer picture is regarded as an intra random access point picture for enhancement layer decoding; encoding into the data structure second information that is indicative of the type of the intra random access point picture for the decoded base-layer picture to be used in the enhancement layer decoding.
